(19) United States
(12) Patent Application Publication
(10) Pub. No.: US 2019/0104299 A1
(43) Pub. Date: Apr. 4, 2019

(54) STEREOSCOPIC IMAGE DISPLAY DEVICE

(71) Applicant: Mitsubishi Electric Corporation, Tokyo (JP)

(72) Inventors: Akimasa YUUKI, Tokyo (JP); Yohei IIDA, Tokyo (JP)

(73) Assignee: Mitsubishi Electric Corporation, Tokyo (JP)

(21) Appl. No.: 16/133,768

(22) Filed: Sep. 18, 2018

(30) Foreign Application Priority Data
Oct. 4, 2017 (JP) 2017-194012

(51) Int. Cl. H04N 13/31; H04N 13/373; H04N 13/376

(52) U.S. Cl. CPC H04N 13/31; H04N 13/376; H04N 13/373

(57) ABSTRACT

A stereoscopic image display device reduces the possibility of an observer visually recognizing emission or dark lines even while being away from a position suitable for visually recognizing stereoscopic images. A parallax barrier shutter panel includes sub-openings switchable between a light transmission state and a light shielding state. A panel controller changes the pattern of integrated openings configured by sub-openings in the light transmission state in accordance with the position of the observer. When the position of the observer is included in a designed stereoscopic region, the panel controller applies cyclic patterns connected by boundaries among which a phase shift exists, to the integrated openings in accordance with the position of the observer. When the position of the observer is no longer included in the designed stereoscopic region, the pattern of the integrated openings is adjusted to cause the boundaries to disappear while maintaining one cycle.

### BACKGROUND OF THE INVENTION

### Field of the Invention

The present invention relates to a stereoscopic image display device and in particular to a stereoscopic image display device using a parallax barrier method.

### Description of the Background Art

Naked-eye stereoscopic image display devices that can provide stereoscopic vision without requiring special glasses have conventionally been proposed.

Japanese Patent Application Laid-Open No. H03-119889 proposes a three-dimensional image display device that includes barrier generation means and image display means. The barrier generation means generates parallax barrier stripes using transmission display devices by electronic control. The image display means disposes a display screen at a predetermined distance away behind the position at which the parallax barrier stripes are generated. The image display means is capable of outputting and displaying a multi-directional image on the display screen in the case of displaying a stereoscopic image, the multi-directional image being an image in which left and right image strips are alternately aligned corresponding to the parallax barrier stripes. This three-dimensional image display device is configured to electronically generate barrier stripes and to be capable of freely performing variable control of, for example, the shape (number, width, and interval of the stripes), position (phase), and density of the generated barrier stripes. Thus, this three-dimensional image display device can also be used as a two-dimensional image display device.

The stereoscopic image display device without glasses according to Japanese Patent Application Laid-Open No. 2001-166259 includes image display means for alternately displaying striped left and right eye images, shading means configured to be capable of shifting the positions of shading parts that produce a binocular parallax effect by an amount equivalent to one fourth of the pitch of the shading parts, a sensor that detects the head position of an observer, and region-division and shift-control means for dividing the shading means into regions in the left-right direction and controlling whether to shift or not to shift the positions of the shading parts in the shading means for each divided region obtained by the region division, depending on whether the head position of the observer deviates back and forth from an appropriate viewing range. This device can supply right eye images to the right eye of the observer and supply left eye images to the left eye of the observer through the shift control of the shading parts and the display control of the image display means, even if the head of the observer has moved to a position that deviates from an appropriate viewing position. This enables the observer to recognize a stereoscopic image.

With the device as described above, if the position of the observer deviates significantly from the optimum position of visibility of the stereoscopic image display device while the shift control of the barrier shading parts and the display control of the image display means are being performed by electronic control in accordance with the head movement of the observer, there is the risk that the observer may perceive double images produced by three-dimensional (3D) crosstalk or perceive emission lines, dark lines, or a change in luminance on the screen on the screen, caused by control of the barrier shading parts. This may cause uneasiness in the observer, and this feeling of uneasiness can increase particularly when frequent switching occurs due to frequent head movements of the observer.

The stereoscopic image display device according to Japanese Patent Application Laid-Open No. 2013-24957 includes a display panel that includes sub-pixel pairs aligned in the lateral direction and each consisting of two sub-pixels that respectively display left and right parallax images, and a parallax barrier shutter panel that is disposed in front of the display panel and that includes sub-openings aligned in the lateral direction that switchable between a light transmission state and a light shielding state by electric control. In the case where a reference pitch is defined corresponding to the sub-pixel pairs in the lateral direction, integrated openings each consisting of an arbitrary number of sub-openings are formed in the parallax barrier shutter panel by setting an arbitrary number of adjacent sub-openings to the light transmission state and the remaining number of sub-openings to the light shielding state among a plurality of sub-openings belonging to the reference pitch. The pitch of the sub-openings in the parallax barrier shutter panel is less than or equal to a difference between the width of the sub-pixels in the display panel and the width of the integrated openings in the parallax barrier shutter panel. In this way, since the pitch of the sub-openings in the parallax barrier shutter panel is less than or equal to the difference between the width of the sub-pixels in the display panel and the width of the integrated openings in the parallax barrier shutter panel, a change of luminance distributions between before and after switching can be suppressed. This suppresses fluctuations in luminance, which might be perceived by the observer who is moving.

Moreover, International Publication No. WO 2015/029433 discloses a method of driving a stereoscopic image display device that includes a display panel and a parallax barrier shutter panel. The display panel includes a plurality of sub-pixel pairs arranged in the lateral direction at a predetermined pitch and each consisting of two sub-pixels that respectively display left and right eye images. The parallax barrier shutter panel is disposed between the display panel and a backlight disposed on the opposite side of the display panel to the observer, and includes a plurality of sub-openings electrically switchable between a light transmission state and a light shielding state and arranged in the lateral direction at a pitch obtained by dividing a reference parallax barrier pitch, which is determined by a predetermined designed observation distance and the pitch of the sub-pixel pairs, by N, where N is an even number greater than or equal to four. If the position of the observer is equal to the designed observation distance, N/2 adjacent sub-openings are set to the light transmission state and N/2 adjacent sub-openings are set to the light shielding state so as to form one integrated opening. If the position of the observer is smaller than the designed observation distance, at least one location where N/2+1 adjacent sub-openings are set to the light transmission state is provided in the lateral direction, and N/2 adjacent sub-openings are set to the light shielding state. If the position of the observer is greater than the designed observation distance, at least one location where N/2−1 adjacent sub-openings are set to the light transmission state is provided in the lateral direction, and N/2 adjacent sub-openings are set to the light shielding state. Accordingly, even if the observer who is located at an observation distance different from the designed observation distance has moved in the left-right direction, the observer is able to visually recognize a stereoscopic image without visually recognizing emission lines or dark lines on the screen.

The above-described technique of WO 2015/029433 reduces the possibility that the observer will visually recognize emission lines or dark lines on the screen when a stereoscopic image is displayed. However, according to examinations performed by the inventors of the present invention, if the observer is away from a position suitable for visually recognizing a stereoscopic image, the observer may visually recognize emission lines or dark lines caused by control of the parallax barrier shutter panel, even with use of the above-described technique.

### SUMMARY

The present invention has been achieved in order to solve problems as described above, and it is an object of the present invention to provide a stereoscopic image display device with which the observer is less likely to visually recognize emission lines or dark lines caused by control of a parallax barrier shutter panel even while being away from a position suitable for visually recognizing a stereoscopic image.

A stereoscopic image display device according to an aspect of the present invention displays a stereoscopic image toward an observer who is located within a designed stereoscopic region. The stereoscopic image display device includes a display panel, a parallax barrier shutter panel, a detector, a region determination part, a panel controller, and a region setting part. The display panel includes a plurality of sub-pixel pairs aligned in a lateral direction, and the plurality of sub-pixels each have two sub-pixels that respectively display images for left and right eyes. The parallax barrier shatter panel is overlaid on the display panel and has a plurality of sub-openings aligned in the lateral direction and electrically switchable between a light transmission state and a light shielding state. The detector detects a position of the observer. The region determination part determines whether the position of the observer detected by the detector is included in the designed stereoscopic region. The panel controller switches each of the plurality of sub-openings in the parallax barrier shutter panel between the light transmission state and the light shielding state in accordance with the position of the observer to change a pattern of an integrated opening configured by sub-openings in the light transmission state among the plurality of sub-openings. The region setting part sets the designed stereoscopic region. The panel controller is configured to, in a case where the region determination part has determined that the position of the observer is included in the designed stereoscopic region, apply a plurality of cyclic patterns to the integrated opening in accordance with the position of the observer, the plurality of cyclic patterns each having one cycle and connected by a plurality of boundaries among which a phase shift exists, and in a case where the region determination part has determined that the position of the observer is no longer included in the designed stereoscopic region, adjust the pattern of the integrated opening to cause the boundaries to disappear while maintaining the one cycle.

A stereoscopic image display device according to another aspect of the present invention displays a stereoscopic image toward an observer who is located within a designed stereoscopic region. The stereoscopic image display device includes a display panel, a parallax barrier shutter panel, a detector, a region determination part, a panel controller, and a region setting part. The display panel includes a plurality of sub-pixel pairs aligned in a lateral direction, and the plurality of sub-pixel pairs each have two stab-pixels that respectively display images for left and right eyes. The parallax barrier shutter panel is overlaid on the display panel and has a plurality of sub-openings aligned in the lateral direction and electrically switchable between a light transmission state and a light shielding state. The detector detects a position of the observer. The region determination part determines whether the position of the observer detected by the detector is included in the designed stereoscopic region. The panel controller switches each of the plurality of sub-openings in the parallax barrier shutter panel between the light transmission state and the light shielding state in accordance with the position of the observer to change a pattern of an integrated opening configured by sub-openings in the light transmission state among the plurality of sub-openings. The region setting part sets the designed stereoscopic region. The panel controller is configured to, in a case where the region determination part has determined that the position of the observer is included in the designed stereoscopic region, apply a plurality of cyclic patterns to the integrated opening in accordance with the position of the observer, the plurality of cyclic patterns each having one cycle and connected by a plurality of boundaries among which a phase shift exists, and in a case where the region determination part has determined that the position of the observer is no longer included in the designed stereoscopic region, cause the display panel to display an image with no parallax, reduce a transmittance of sub-openings in the light transmission state among the plurality of sub-openings in the parallax barrier shutter panel, and increase a transmittance of sub-openings in the light shielding state among the plurality of sub-openings in the parallax barrier shutter panel.

In the stereoscopic image display device according to one aspect of the present invention, the integrated opening is configured by sub-openings in the light transmission state among the plurality of sub-openings in the parallax barrier shutter panel. If the position of the observer is included in the designed stereoscopic region, the plurality of cyclic patterns each having one cycle and connected by the plurality of boundaries among which a phase shift exists is applied to the integrated opening in accordance with the position of the observer. If the position of the observer is no longer included in the designed stereoscopic region, the pattern of the integrated opening is adjusted so as to eliminate the above-described boundaries while maintaining the above-described one period. Accordingly, even if the observer has moved to outside the designed stereoscopic region, the observer is less likely to visually recognize emission lines or dark lines caused by control of the parallax barrier shutter panel.

In the stereoscopic image display device according to another aspect of the present invention, the integrated opening is configured by sub-openings in the light transmission state among the plurality of sub-openings in the parallax barrier shutter panel. If the position of the observer is included in the designed stereoscopic region, the plurality of cyclic patterns each having one cycle and connected by the plurality of boundaries among which a phase shift exists is applied to the integrated opening in accordance with the position of the observer. If the position of the observer is no longer included in the designed stereoscopic region, an image with no parallax is displayed on the display panel, the transmittance of the sub-openings in the light transmission state in the parallax barrier shutter panel is reduced, and the transmittance of the sub-openings in the light shielding state in the parallax barrier shutter panel is increased. Accordingly, even if the observer has moved to outside the designed stereoscopic region, the observer is less likely to visually recognize emission lines or dark lines caused by control of the parallax barrier shutter panel.

### BRIEF DESCRIPTION OF THE DRAWINGS

FIG. 1 is a cross-sectional view schematically illustrating a configuration of a display device according to a first prerequisite technique;

FIG. 2 is a partial plan view of sub-openings configured in a parallax barrier shutter panel of the display device according to the first prerequisite technique;

FIG. 3 is a partial plan view illustrating a pattern 1 of a light transmission state and a light shielding state formed by the sub-openings in FIG. 2;

FIG. 4 is a partial plan view illustrating a pattern 2 of the light transmission state and the light shielding state formed by the sub-openings in FIG. 2;

FIG. 5 is a partial plan view illustrating a pattern 3 of the light transmission state and the light shielding state formed by the sub-openings in FIG. 2;

FIG. 6 is a partial plan view illustrating a pattern 4 of the light transmission state and the light shielding state formed by the sub-openings in. FIG. 2;

FIG. 7 is a partial plan view illustrating a pattern 5 of the light transmission state and the light shielding state formed by the sub-openings in FIG. 2;

FIG. 8 is a partial plan view illustrating a pattern 6 of the light transmission state and the light shielding state formed by the sub-openings in FIG. 2;

FIG. 9 is a partial plan view illustrating a pattern 7 of the light transmission state and the light shielding state formed by the sub-openings in FIG. 2;

FIG. 10 is a partial plan view illustrating a pattern 8 of the light transmission state and the light shielding state formed by the sub-openings in FIG. 2;

FIG. 11 is a diagram for describing the angular distribution of orientations in the display device in FIG. 1;

FIG. 12 is a graph showing an example of the result of calculating the angular distribution of luminous intensity of light emitted from the sub-pixels of the display panel and passing through the integrated openings in the parallax barrier shutter panel according to the first prerequisite technique;

FIG. 13 illustrates the result of calculating various characteristics including the angular width of flat-luminance region under calculation conditions 1 to 6 according to the first prerequisite technique;

FIG. 14 is a diagram for describing an angular distribution of luminous intensity of excess light that is emitted from the sub-pixels in the display panel and is not blocked by integrated light shielding parts in the parallax barrier shutter panel according to the first prerequisite technique;

FIG. 15 is a diagram for describing a change in the angular distribution of luminous intensity of light emitted from sub-pixels that display right images, following the shift of the integrated openings in the parallax barrier shutter panel according to the first prerequisite technique;

FIG. 16 is a graph showing an example of the result of calculating a change in the angular distribution of luminous intensity, following the operation of switching the sub-openings in the parallax barrier shutter panel according to the first prerequisite technique;

FIG. 17 is a graph showing an example of the result of calculating a change in the angular distribution of luminous intensity, following the operation of switching the sub-openings in the parallax barrier shutter panel according to the first prerequisite technique;

FIG. 18 is a graph showing an example of the result of calculating a change in the angular distribution of luminous intensity, following the operation of switching the sub-openings in the parallax barrier shutter panel according to the first prerequisite technique;

FIG. 19 is a diagram showing an example of the result of calculating a change in the angular distribution of luminous intensity, following the operation of switching the sub-openings in the parallax barrier shutter panel according to the first prerequisite technique;

FIG. 20 illustrates an example of the result of calculating the relationship between the number of divisions N and total relative peak luminance according to the first prerequisite technique;

FIG. 21 is a partial plan view schematically illustrating a wiring configuration of the parallax barrier shutter panel in a naked-eye stereoscopic image display panel according to Example 1 of a second prerequisite technique;

FIG. 22 is a diagram illustrating voltage patterns applied to first transparent electrodes in the parallax barrier shutter panel according to the second prerequisite technique;

FIG. 23 is a partial plan view showing an example of integrated openings formed in the parallax barrier shutter panel according to the second prerequisite technique;

FIG. 24 is a partial plan view for describing the operating state of the entire parallax barrier shutter panel according to the second prerequisite technique;

FIG. 25 is a partial plan view illustrating the arrangement of sub-pixels in the display panel relative to the integrated openings in the parallax barrier shutter panel according to the second prerequisite technique;

FIG. 26A is a schematic diagram illustrating a state in which the boundaries of light emitted from the sub-pixels constituting the sub-pixel pairs in the display panel extend from each position on the screen to the space in front of the screen according to Example 1 of the second prerequisite technique;

FIG. 26B is a partial enlarged view of an elliptic portion indicated by a dashed dotted line in FIG. 26A;

FIG. 27 is a schematic diagram illustrating a state in which the boundaries of light emitted from the sub-pixels constituting the sub-pixel pairs in the naked-eye stereoscopic image display panel extend from each position on the screen to the space in front of the screen, in the case where the actual observation distance is greater than the designed observation distance according to Example 1 of the second prerequisite technique;

FIG. 28 is a graph illustrating the result of calculating the amount of optimum displacement to be provided between the center position of a light shielding barrier provided between sub-pixels constituting a sub-pixel pair and the center position of an integrated opening according to Example 1 of the second prerequisite technique;

FIG. 29 is a partial plan view illustrating the formation of the integrated openings when the actual observation distance is greater than the designed observation distance according to Example 1 of the second prerequisite technique;

FIG. 30 is a partial plan view illustrating the formation of the integrated openings when the actual observation distance is smaller than the designed observation distance according to Example 1 of the second prerequisite technique;

FIG. 31 is a partial cross-sectional view illustrating a computation model for orientation characteristics according to Example 1 of the second prerequisite technique;

FIG. 32 is a graph illustrating the result of calculating the orientation characteristics according to Example 1 of the second prerequisite technique;

FIG. 33 is a graph illustrating the result of calculating the orientation characteristics according to Example 1 of the second prerequisite technique;

FIG. 34 is a graph illustrating the result of calculating the orientation characteristics according to Example 1 of the second prerequisite technique;

FIG. 35 is a graph illustrating the result of calculating of the orientation characteristics according to Example 1 of the second prerequisite technique;

FIG. 36 is a graph illustrating the result of calculating the orientation characteristics according to Example 1 of the second prerequisite technique;

FIG. 37 is a partial plan view illustrating the formation of the integrated openings when the actual observation distance is greater than the designed observation distance according to Example 2 of the second prerequisite technique;

FIG. 38 is a partial plan view illustrating the formation of the integrated openings when the actual observation distance is smaller than the designed observation distance according to Example 2 of the second prerequisite technique;

FIG. 39 is a partial cross-sectional view illustrating a computation model for orientation characteristics according to Example 2 of the second prerequisite technique;

FIG. 40 is a graph illustrating the result of calculating the orientation characteristics according to Example 2 of the second prerequisite technique;

FIG. 41 is a graph illustrating the result of calculating the orientation characteristics according to Example 2 of the second prerequisite technique;

FIG. 42 is a graph illustrating the result of calculating the orientation characteristics according to Example 2 of the second prerequisite technique;

FIG. 43 is a graph illustrating the result of calculating the orientation characteristics according to Example 2 of the second prerequisite technique;

FIG. 44 is a graph illustrating the result of calculating the orientation characteristics according to Example 2 of the second prerequisite technique;

FIG. 45 is a block diagram schematically illustrating a configuration of a stereoscopic image display device according to Embodiment 1 of the present invention;

FIG. 46 is a diagram for describing a designed stereoscopic region and an observer-detectable region that are set by a region setting part in FIG. 45;

FIG. 47 is a diagram for describing operations performed by the stereoscopic image display device when an observer moves from a position P1 via a position P2 to a position P3 in FIG. 46;

FIG. 48 is a graph for describing an example operation performed in a 3D mode in FIG. 47 by the parallax barrier shutter panel;

FIG. 49 is a graph for describing a first operation performed by the parallax barrier shutter panel upon start of a transition mode 1 in FIG. 47;

FIG. 50 is a graph for describing a second operation performed by the parallax barrier shutter panel upon start of the transition mode 1 in FIG. 47;

FIG. 51 is a graph for describing an operation performed in a non-3D mode in FIG. 47 by the parallax barrier shutter panel;

FIG. 52 is a diagram for describing operations performed by the stereoscopic image display device when an observer moves from the position P3 via the position P2 to the position P1 in FIG. 46;

FIG. 53 is a graph for describing example operations performed in modes starting from a fixed mode via a transition mode 2 to a non-3D mode in FIG. 52 by the parallax barrier shutter panel;

FIG. 54 is a diagram for describing an operation mode of the stereoscopic image display device according to Embodiment 2 of the present invention in the case where an observer moves from the position P1 via the position P2 to the position P3 in FIG. 46;

FIG. 55 is a graph corresponding to FIG. 54;

FIG. 56 is a diagram for describing an operation mode of the stereoscopic image display device according to Embodiment 2 of the present invention in the case where an observer moves from the position P3 via the position P2 to the position P1 in FIG. 46; and

FIG. 57 is a graph corresponding to FIG. 56.

### DESCRIPTION OF THE PREFERRED EMBODIMENTS

Hereinafter, first and second prerequisite techniques will be first described, and then embodiments of the present invention will be described. Note that constituent elements that are the same or similar in the following drawings are given the same reference numerals, and redundant description thereof will be omitted.

First Prerequisite Technique

First of all, a first prerequisite technique is described below, which serves as a prerequisite technique for embodiments of the present invention described later.

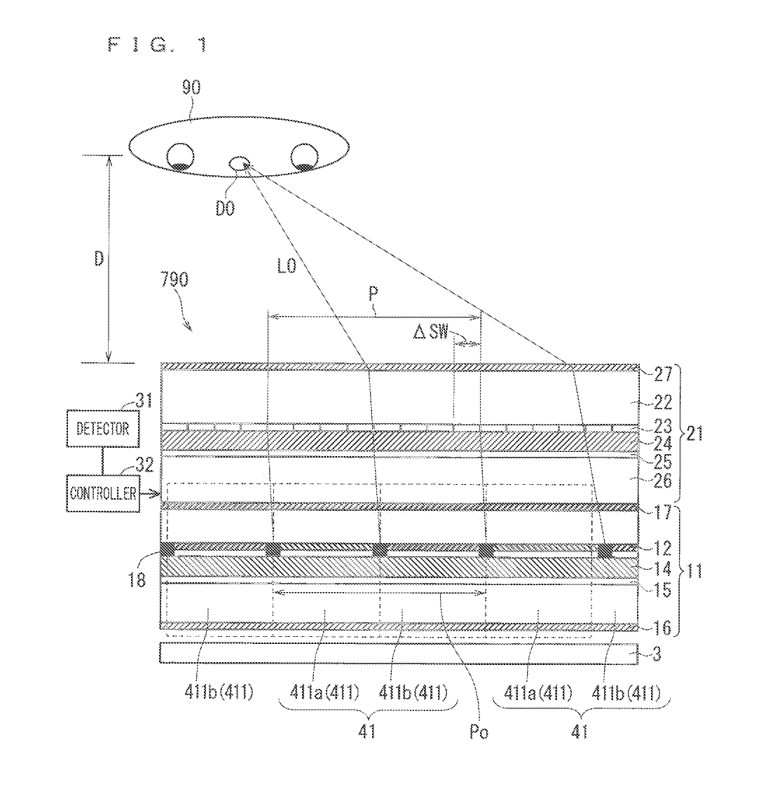

FIG. 1 is a cross-sectional view schematically illustrating a configuration of a stereoscopic image display device according to the first prerequisite technique. This display device is capable of displaying two images simultaneously. These two images are respectively a parallax image for the right eye (also referred to as a right image or an image for a first observation direction) and a parallax image for the left eye (also referred to as a left image or an image for a second observation direction) that differs slightly from the parallax image for the right eye. This display device allows an observer to visually recognize a stereoscopic image with naked eyes without wearing special glasses. Alternatively, the display device is capable of displaying a different image for each observation direction. The following description is primarily given regarding a case where the display device displays parallax images for the left and right eyes, in other words, a case where the display device serves as a stereoscopic image display device.

The display device includes a naked-eye stereoscopic image display panel 790, a detector 31 that detects, for example, the head position of an observer 90, and a controller 32 that controls the naked-eye stereoscopic image display panel 790 on the basis of the result (e.g., video signal) of detection by the detector 31. In the following description, the up-down direction in FIG. 1 is referred to as a back-and-forth direction, the left-right direction in FIG. 1 as a lateral direction, and a direction perpendicular to the plane of FIG. 1 as a longitudinal direction.

FIG. 1 illustrates a sectional structure of the naked-eye stereoscopic image display panel 790. The naked-eye stereoscopic image display panel 790 includes a display panel 11, a parallax barrier shutter panel 21 (photo-inducing member) overlaid on the display panel, and a backlight 3. A specific arrangement is such that the parallax barrier shutter panel 21 (photo-inducing member) is disposed in front of the display panel 11 (on the upper side in FIG. 1), and the backlight 3 is disposed behind the display panel 11 (on the lower side in FIG. 1). The parallax barrier shutter panel 21 may be disposed behind the display panel 11. The display panel 11 is a matrix display panel, and a transmission liquid crystal panel is adopted in the illustrated example. The liquid crystal panel serving as the display panel 11 includes a liquid crystal 14, a sub-pixel transparent electrode 12 and a counter transparent electrode 15 that drive the liquid crystal 14 with the liquid crystal 14 sandwiched therebetween, an intermediate polarizing plate 17 provided on a transparent substrate that supports the sub-pixel transparent electrode 12, and a secondary-surface polarizing plate 16 provided on a transparent substrate that supports the counter transparent electrode 15. The backlight 3 is disposed behind the secondary-surface polarizing plate 16 (on the lower side in FIG. 1). Note that the display panel 11 is not limited to a liquid crystal panel. For example, an organic EL panel or a plasma display panel may be adopted, in which case the backlight 3 is omitted.

The display panel 11 has sub-pixels 411a for displaying the aforementioned right image and sub-pixels 411b for displaying the aforementioned left image, which are arranged alternately in the lateral direction with a light shielding barrier 18 sandwiched between each pair of sub-pixels 411a and 411b. Note that the sub-pixels 411a and the sub-pixels 411b are also collectively referred to as sub-pixels 411. The sub-pixels 411a and the sub-pixels 411b have the same or approximately the same width. Here, each pair of adjacent sub-pixels 411a and 411b constitutes a sub-pixel pair 41 that displays two different images (left and right parallax images, or images for the first and second observation directions) on the left and right sides. The sub-pixel pairs 41 are aligned at a predetermined uniform pitch in the lateral direction on the display panel 11. In the naked-eye stereoscopic image display panel 790, the sub-pixel pairs 41 are aligned not only in the lateral direction but also in the longitudinal direction.

In the naked-eye stereoscopic image display panel 790, a reference parallax barrier pitch P is defined as a reference pitch in the lateral direction that corresponds to the width of the sub-pixel pairs 41. Here, the reference parallax barrier pitch P is set such that a virtual light beam LO converge to a designed viewpoint DO that is separated toward the front by a designed observation distance D from the naked-eye stereoscopic image display panel 790, the virtual light beam LO being a light beam emitted from the center of one light shielding barrier 18 provided in the center between the sub-pixels 411a and 411b, which constitute a sub-pixel pair 41, and passing through the center point of the corresponding reference parallax barrier pitch P.

The parallax barrier shutter panel 21 includes two transparent substrates transparent substrate 22 and second transparent substrate 26), a liquid crystal layer 24 held between the two transparent substrates, first and second transparent electrodes 23 and 25, a display-surface polarizing plate 27 provided on the surface of the first transparent substrate 22 opposite to the surface thereof facing the liquid crystal layer 24, and a polarizing plate provided on the surface of the second transparent substrate 26 that faces the display panel 11. Here, the intermediate polarizing plate 17 of the display panel 11 also serves as the polarizing plate. Examples of usable modes of liquid crystals include twisted nematic (TN), super-twisted nematic (STN), in-plane switching, and optically compensated bend (OCB). Note that examples of using some of these modes will be described later.

The surface of the first transparent substrate 22 that faces the liquid crystal layer 24 has a plurality of first transparent electrodes 23 formed extending in the longitudinal direction (direction perpendicular to the plane of FIG. 1). The surface of the second transparent substrate 26 that faces the liquid crystal layer 24 has at least one second transparent electrode 25 formed extending in the lateral direction (left-right direction in FIG. 1). The first transparent electrodes 23 and the second transparent electrode(s) 25 drive the liquid crystal of the liquid crystal layer 24 by applying an electric field to the liquid crystal layer 24.

Each first transparent electrode 23 corresponds to each electrode that is obtained by dividing a single transparent electrode into an even number of electrodes (here, eight) within the region of the corresponding reference parallax barrier pitch P. That is, an even number of (here, eight) first transparent electrodes 23 are aligned within the region of each reference parallax barrier pitch P. Note that the first transparent electrodes 23 are electrically isolated from one another, unless otherwise specified.

On the other hand, at least one second transparent electrode 25 may, for example, be a plurality of electrodes aligned at a predetermined pitch in the longitudinal direction (direction perpendicular to the plane of FIG. 1), but in the present embodiment, at least one second transparent electrode 25 is assumed to be a single electrode that extends in the longitudinal and lateral directions. A voltage is selectively applied between the single second transparent electrode 25 and each first transparent electrode 23. Accordingly, the parallax barrier shutter panel 21 can switch between the light transmission state and the light shielding state in units of the width of the first transparent electrodes 23 by electrical control. In the following description, optical openings of the parallax barrier shutter panel 21 that are switchable between the light transmission state and the light shielding state in units of the width of the first transparent electrodes 23 are referred to as “sub-openings.”

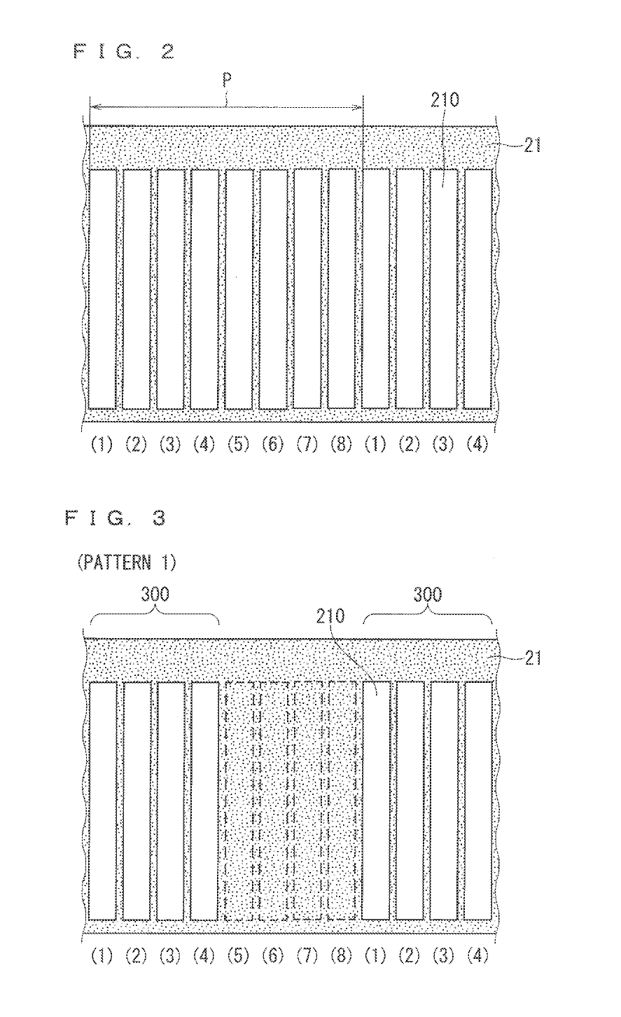

FIG. 2 is a partial plan view illustrating sub-openings 210 formed in the parallax barrier shutter panel 21. Since the plurality of first transparent electrodes 23 (FIG. 1) is aligned in the lateral direction, the plurality of sub-openings 210 is also aligned in the lateral direction. Since an even number of (here, eight) first transparent electrodes 23 are aligned within the region of each reference parallax barrier pitch P, the same even number of (here, eight) sub-openings 210 are included within the region of each reference parallax barrier pitch P. In the drawing, these eight sub-openings 210 are respectively numbered (1) through (8). The eight first transparent electrodes 23 correspond to each sub-pixel pair 41 (FIG. 1).

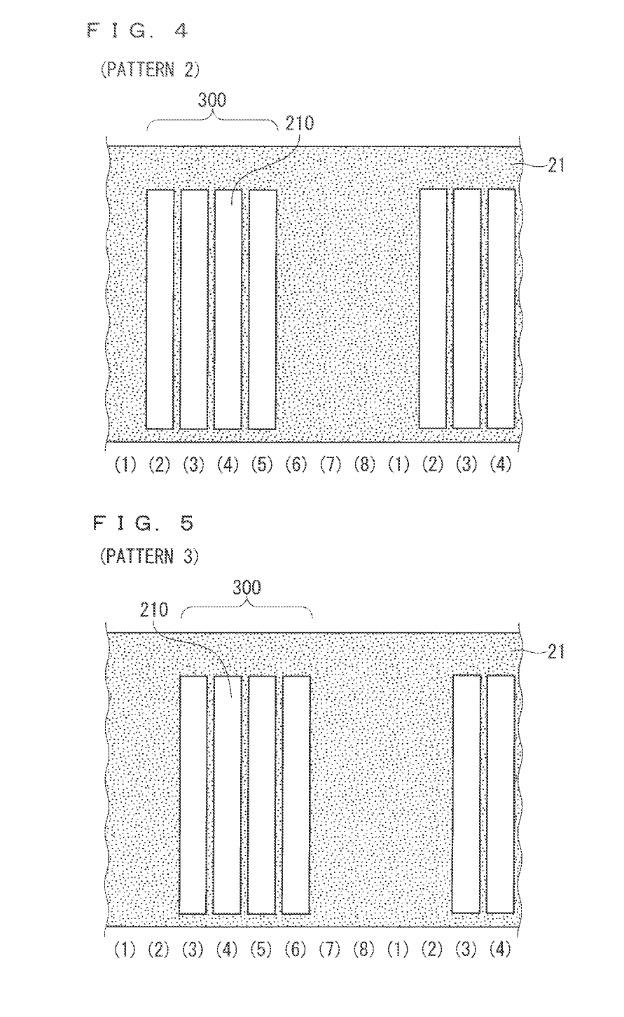

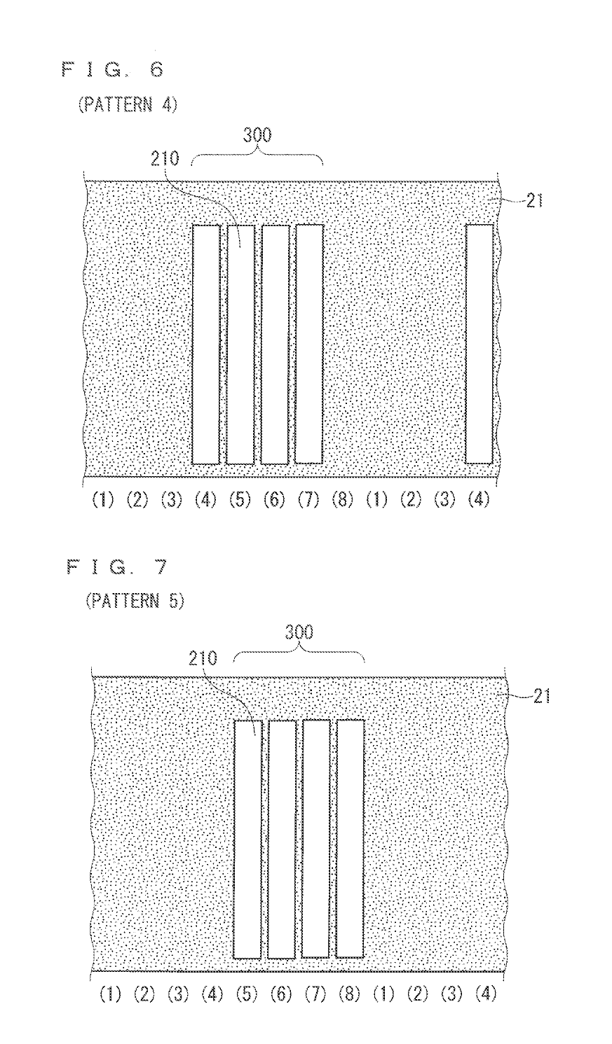

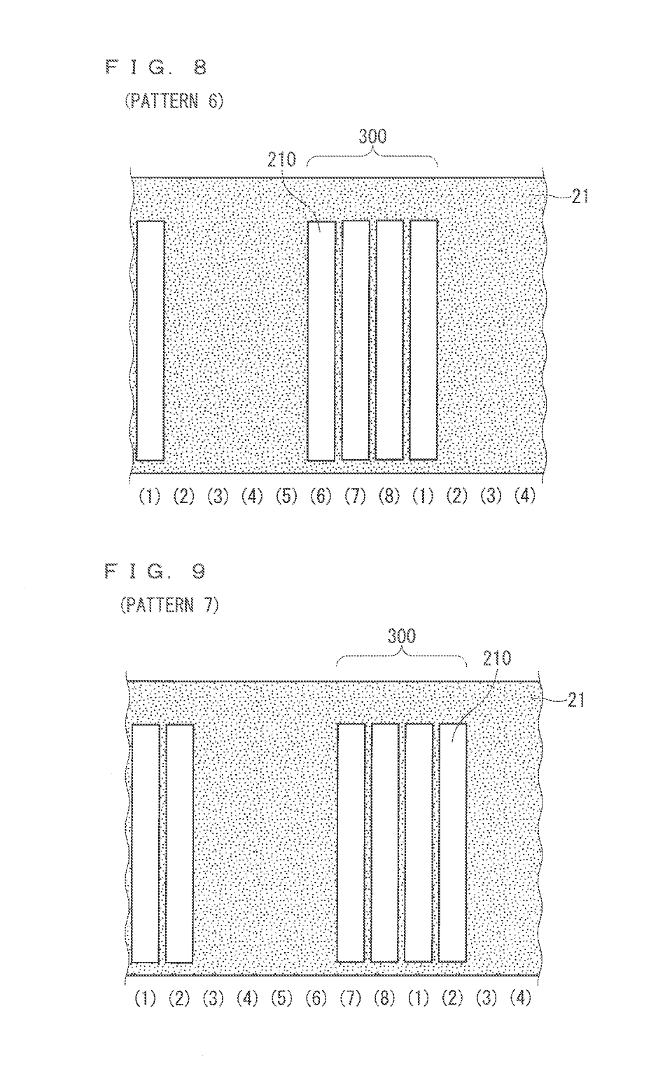

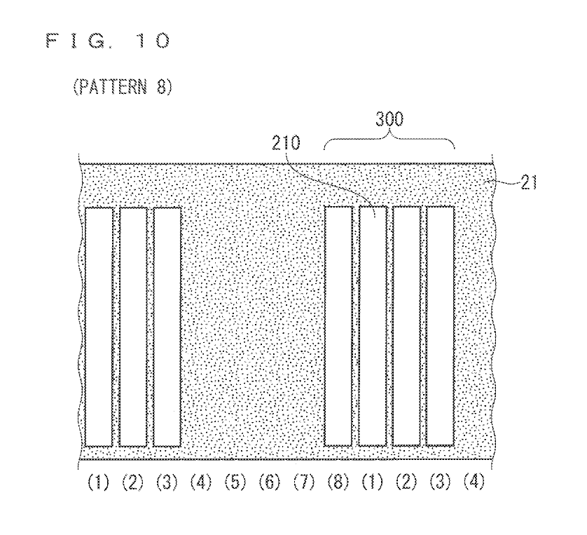

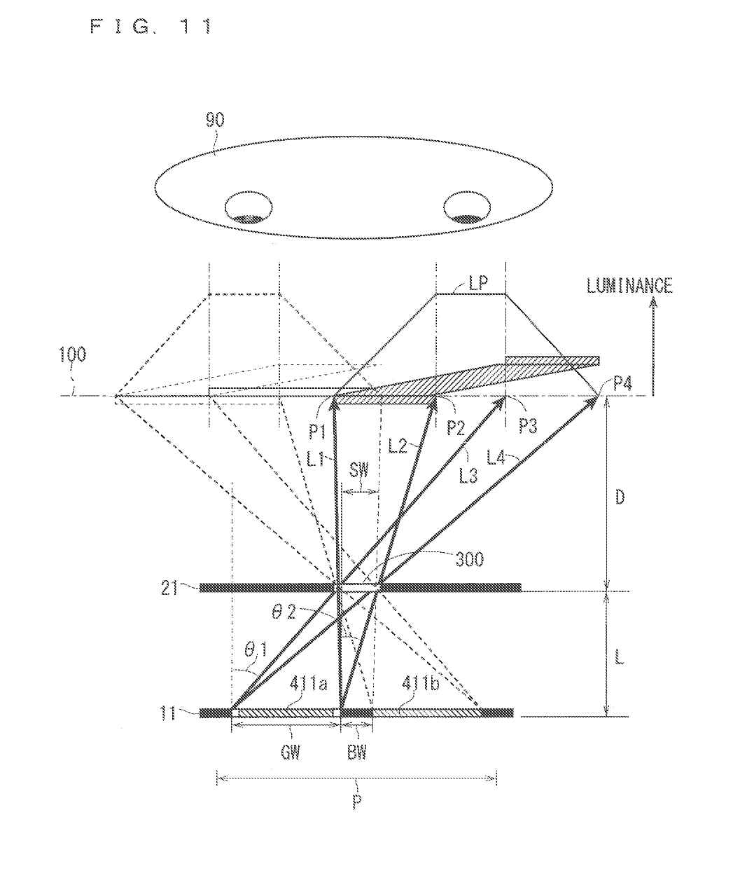

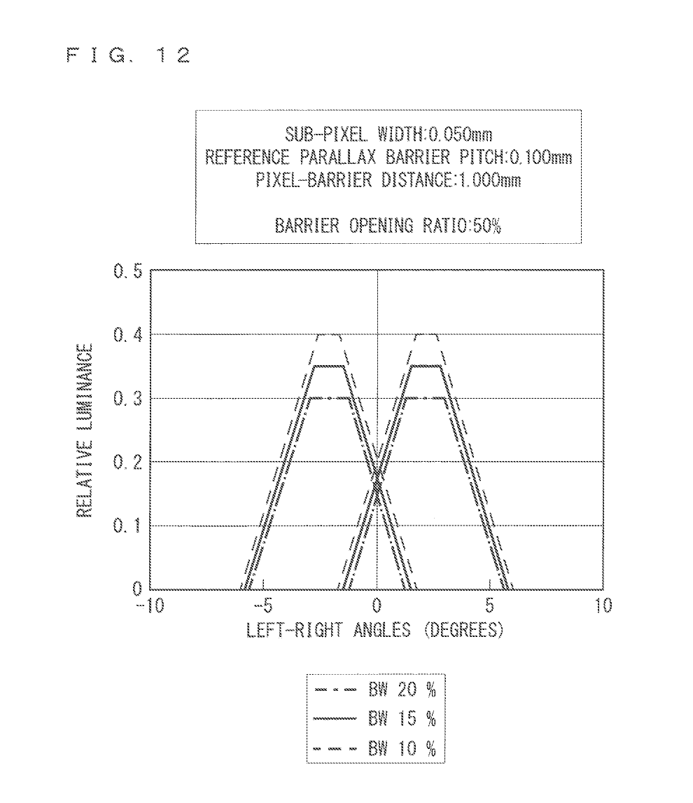

FIGS. 3 to 10 are partial plan views respectively illustrating patterns 1 to 8 of the light transmission state and the light shielding state, formed by the sub-openings 210. Among the above-described even number of (eight) sub-openings 210 within the region of each reference parallax barrier pitch P, a half (four) of the even number of adjacent sub-openings 210 are set to the light transmission state, and the remaining half (four) of the sub-openings 210 (the other sub-openings 210) are set to the light shielding state. Accordingly, a plurality of integrated openings 300, each consisting of an arbitrary number of (here, four) sub-openings 210, is configured. The integrated openings 300 configured by the sub-openings 210 in this way guide the light emitted from the sub-pixels 411b (FIG. 1) for displaying the left image and the light emitted from the sub-pixels 411a (FIG. 1) for displaying the right image in different directions.

Referring to, for example, the pattern 1 (FIG. 3), four continuous sub-openings 210 numbered (1) to (4) within the region of each reference parallax barrier pitch P are set to the light transmission state, and four continuous sub-openings 210 (the other sub-openings 210) numbered (5) to (8) are set to the light shielding state, so that each integrated opening 300 is formed of the four sub-openings 210 in the light transmission state. The pattern 2 is obtained from this pattern 1 by setting the sub-opening 210 numbered (1) to the light shielding state and setting the sub-opening 210 numbered (5) to the light transmission state. That is, the arrangement of the integrated openings 300 in the parallax barrier shutter panel 21 transitions from the pattern 1 to the pattern 2. This transition causes the integrated openings 300 to shift to the right by an amount equivalent to the pitch of the sub-openings 210 (hereinafter, also referred to as a “sub-opening pitch ΔSW”). More generally speaking, the sub-opening 210 at one end of each integrated opening 300 is set to the light shielding state, and the sub-opening 210 that is adjacent to the other end of the integrated opening 300 is set to the light transmission state, so that the integrated opening 300 can be shifted by an amount equivalent to the sub-opening pitch ΔSW in the direction from the one end of the integrated opening toward the other end.

The sub-opening pitch ΔSW is approximately the width of one sub-opening 210. However, as will be described later, each two adjacent first transparent electrodes 23 are slightly separated from each other, and a boundary part that prevents the application of an electric field to the liquid crystal layer 24 exists between the first transparent electrodes 23. Thus, strictly speaking, the sub-opening pitch ΔSW is the sum of the width of one sub-opening 210 and the width of the boundary part.

Next, operations of the stereoscopic image display device (FIG. 1) will be described briefly. As described above, the detector 31 detects the position of the observer 90. The controller 32 performs overall control of the display panel 11 and the parallax barrier shutter panel 21 on the basis of the result of detection by the detector 31. Specifically, the controller 32 controls the positions of the integrated openings 300 in the lateral direction of the parallax barrier shutter panel 21 by changing which of the plurality of sub-openings 210 are in the light transmission state on the basis of the result of detection by the detector 31. That is, with the display device according to the present technique, the integrated openings 300 can be shifted in the lateral direction in accordance with the position of the observer 90 who moves left and right. Accordingly, even the observer 90 who may move is able to visually recognize a stereoscopic image.

Here, in the case where the angular distribution of luminous intensity (light intensity luminance distribution) has large unevenness or in the case where the integrated openings 300 are shifted improperly, the observer 90 who is moving perceives fluctuations (flicker) in the luminance of the stereoscopic image. In order to suppress such fluctuations in the luminance of the image, the following conditions (C1) to (C3) need to be satisfied. The condition (C1) is that the luminance of parallax images for the left and right eyes of the observer 90 is flat (constant) in an observation region where the sub-openings 210 are not switched between the light transmission state and the light shielding state. The condition (C2) is that a region in which parallax images for one of the eyes are observed includes a range in which parallax images for the other eye are not observed. The condition (C3) is that the luminance along the travel path of the observer 90 is flat (constant) even if the sub-openings 210 are switched between the light transmission state and the light shielding state, following the shift of the integrated openings 300. The details of each of these conditions will be described hereinafter.

Condition (C1)

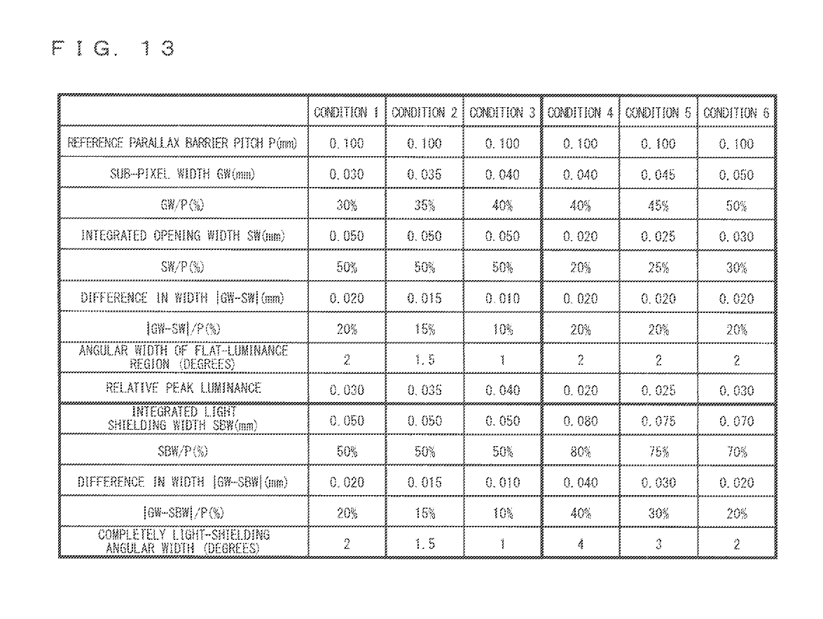

FIG. 11 is a diagram for describing the angular distribution of orientations of the display device (FIG. 1). In FIG. 11, an integrated opening width SW indicates the opening width of each integrated opening 300, a sub-pixel width GW indicates the width of an emission range of each sub-pixel 411, and a light shielding barrier width BW indicates the width of each light shielding barrier 18. Note that the designed observation distance D and a pixel-bather distance L that is a distance between the parallax barrier shutter panel 21 and the sub-pixels 411 are illustrated as approximately the same for the convenience of illustration, but in actuality the designed observation distance D is approximately 100 to 1000 times greater than the pixel-barrier distance L. Also, in order to simplify the description, it is assumed that the light emitted from the sub-pixels 411 is uniform, irrespective of position and radiation angle (angle from the direction perpendicular to the display panel 1) and that there occurs no refraction on the surface of the parallax barrier shutter panel 21. With this assumption, the seeming magnitudes of the angles of light beams in the drawing are of no significance with respect to the luminance of the sub-pixels 411, and there is significance in the relationship between the relative positions of the sub-pixels 411 emitting these light beams and the integrated openings 300.

Based on this premise, the following description is given regarding the luminance distributions (illumination distributions) of light that is emitted from a sub-pixel 411a for displaying the right image, passes (is transmitted) through an integrated opening 300 in the parallax barrier shutter panel 21, and reaches a virtual screen 100 that is separated by the designed observation distance D from the display device.

Light beams L1 and L2 emitted from the right end of the sub-pixel 411a respectively pass through one and the other ends of the integrated opening 300 and reach positions P1 and P2 on the virtual screen 100. Thus, a region between the positions P1 and P2 indicated by cross hatching in the drawing is irradiated with the light emitted from the right end of the sub-pixel 411a. Similarly, light beams L3 and L4 emitted from the left end of the sub-pixel 411a respectively pass through one and the other ends of the integrated opening 300 and reach positions P3 and P4 on the virtual screen 100. Thus, a region between the positions P3 and P4 is irradiated with the light emitted from the left end of the sub-pixel 411a. Note that the irradiated region between the positions P3 and P4 is illustrated slightly shifted above from the virtual screen 100 by cross hatching for the convenience of illustration. Light beams emitted from any one of points other than the left and right ends of the sub-pixel 411a also pass through the integrated opening 300 and are applied to a region of approximately the same size on the virtual screen 100. Such regions irradiated with the light beams emitted from the sub-pixel 411a are illustrated as a region of a parallelogram shape indicated by cross hatching in the drawing.

The luminance distribution of the sub-pixel 411a on the virtual screen 100 is obtained by accumulating overlaps of the regions indicated by cross hatching as described above at each position in the lateral direction. As a result, a graph of a luminance distribution LP illustrated in the drawing is obtained. The higher the position of the line of the luminance distribution LP in the drawing, the higher the luminance at that position. Note that the luminance distribution is also illustrated in the same manner in some of the drawings described below. The luminance distribution LP is flat between the positions P2 and P3, but exhibits a gradient between the positions P1 and P2 and between the positions P3 and P4.

Here, in order to satisfy the aforementioned condition (C1), i.e., in order to make the luminance as flat (constant) as possible irrespective of the angular distribution of luminous intensity, it is necessary to increase the distance between the positions P2 and P3 so as to extend the flat portion of the luminance distribution. LP. That is, a radiation angle θ2 of the light beam L2 and a radiation angle θ1 of the light beam L3 need not to be parallel to each other, and the difference between these radiation angles needs to be as large as possible. That is, the difference between the sub-pixel width GW, which is the width of the emission region of a pixel (width of the sub-pixel 411), and the integrated opening width SW needs to be as large as possible. This increases the angle range where the luminance is constant.

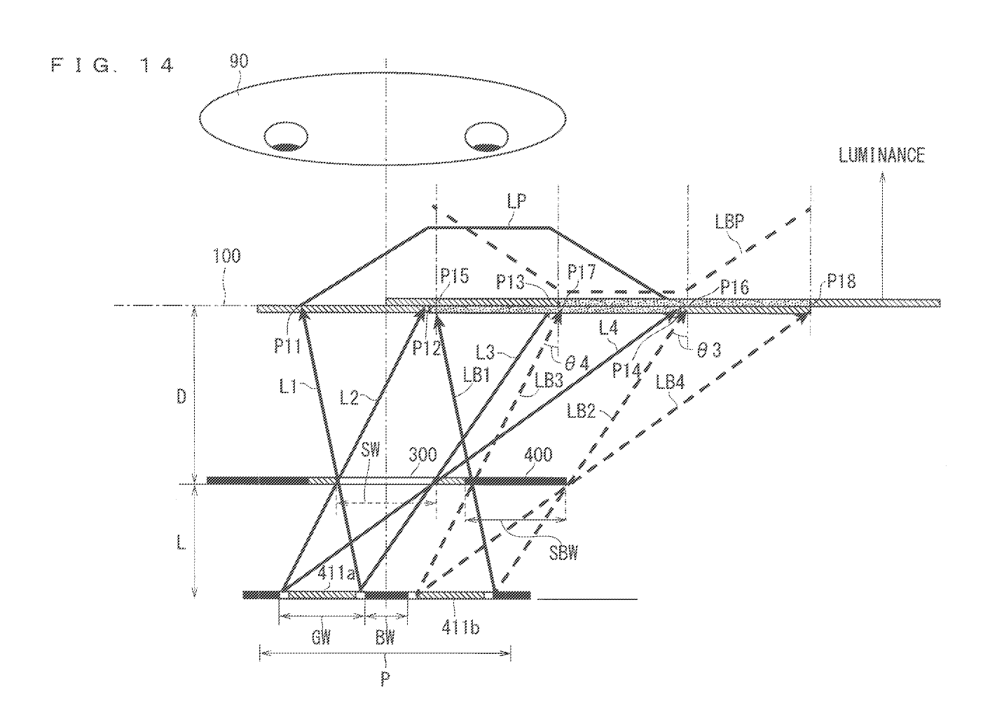

FIG. 12 illustrates the result of calculating the angular distributions of luminous intensity of light that is emitted from the sub-pixels 411 in the display panel 11 and passes through the integrated openings 300 in the parallax barrier shutter panel 21. The condition for calculation is assumed such that the sub-pixel width GW in the display panel 11 is 0.050 mm, the reference parallax barrier pitch P of the parallax bather shutter panel 21 is 0.100 mm, the pixel-barrier distance L is 1.000 mm, and the integrated opening width SW is 0.050 mm. Also, the refractive indices of the display panel 11 and the parallax barrier shutter panel 21 are assumed to be 1.5. FIG. 12 illustrates the angular distributions of luminous intensity in the cases where the light shielding barrier width BW is 20%, 15%, and 10% of the reference parallax barrier pitch P under the above-described condition.

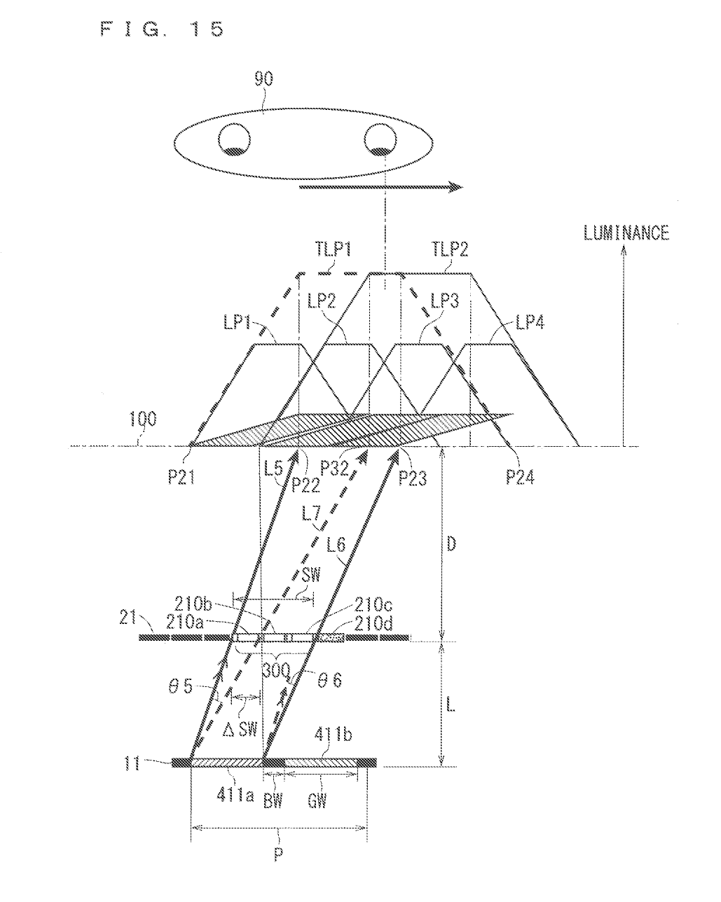

FIG. 13 is a diagram illustrating the results of surveys of various characteristics such as the angular width of flat-luminance region while changing the condition in more various ways. In the drawing, the differences in width |GW−SW| under conditions 1, 2, and 3 are respectively 0.020 mm, 0.015 mm, and 0.010 mm, and the angular widths of flat-luminance region are respectively 2 degrees, 1.5 degrees, and 1 degree. That is, the result that matches the aforementioned description is obtained, i.e., the flat portion of the luminance distribution extends as the difference in width increases. Accordingly, in order to satisfy the condition (C1), i.e., in order to increase the angular width of flat-luminance region, it is necessary to increase the difference between the sub-pixel width GW and the integrated opening width SW.

Condition (C2)

The following description is given regarding a configuration that satisfies the aforementioned condition (C2), i.e., a configuration that satisfies the condition that a region in which parallax images for one of the eyes are observed includes a range in which parallax images for the other eye are not observed.

FIG. 14 is a diagram for describing the angular distribution of luminous intensity of excess light that is emitted from the sub-pixel 411b for displaying the left image and is not blocked by an integrated light shielding part 400. The integrated light shielding part 400 is a light shielding part formed of sub-openings 210 in the light shielding state in the parallax barrier shutter panel 21. An integrated light shielding width SBW indicates the width of the integrated light shielding part 400. As in FIG. 11, the designed observation distance D and the pixel-barrier distance L, which is the distance between the parallax barrier shutter panel 21 and the sub-pixels 411, are illustrated as approximately the same in FIG. 14 for the convenience of illustration, but in actuality the designed observation distance D is approximately 100 to 1000 times greater than the pixel-barrier distance L. Also, in order to simplify the description, it is assumed that the light emitted from the sub-pixel 411a is uniform, irrespective of position and radiation angle, and that there occurs no refraction on the surface of the parallax barrier shutter panel 21. With this assumption, as in FIG. 11, the seeming magnitudes of the angles of light beams in the drawing are of no significance with respect to the luminance of the sub-pixels 411a, and there is significance in the relationship among the relative positions of the sub-pixel 411a emitting these light beams, the integrated openings 300, and the integrated light shielding parts 400. Based on this premise, description is given regarding the luminance distributions of excess light emitted from the sub-pixel 411b for displaying the left image on the virtual screen 100.

Light beams LB1 and LB2 emitted from the right end of the sub-pixel 411b are respectively blocked by one and the other ends of the integrated light shielding part 400. Thus, the light emitted from the right end of the sub-pixel 411b does not reach a region between positions P15 and P16 on the virtual screen 100. Similarly, light beams LB3 and LB4 emitted from the left end of the sub-pixel 411b and indicated by broken lines are also respectively blocked by one and the other ends of the integrated light shielding part 400, and therefore the light does not reach a region between positions P17 and P18 on the virtual screen 100. Accordingly, excess light emitted from the sub-pixel 411b forms a luminance distribution LBP illustrated in the drawing on the virtual screen 100.

Here, a condition for the existence of a completely light-shielding angle range where parallax images are not observed is considered as a prerequisite for satisfying the aforementioned condition (C2). In order to satisfy this condition, the position P17 needs to be located on the left side of the position P16. In order to satisfy this condition for an arbitrary designed observation distance D, a radiation angle θ3 of the light beam LB2 needs to be greater than or equal to a radiation angle θ4 of the light beam 133. That is, the integrated light shielding width SBW needs to be greater than or equal to the sub-pixel width GW. Note that the completely light-shielding angle range extends as the difference in width |SBW−GW| increases.

Next, a condition for including the light emitted from the sub-pixel 411a for displaying the right image within the completely light-shielding angle range is considered as a prerequisite for satisfying the aforementioned condition (C2). In order to satisfy this condition, the integrated light shielding width SBW needs to be greater than or equal to the integrated opening width SW. Here, in order to avoid misregistration between the range of light emitted from the sub-pixel 411a and the completely light-shielding angle range when the integrated light shielding width SBW is equal to the integrated opening width SW (SBW=SW), the distance between the center of the sub-pixel 411a and the center of the sub-pixel 411b needs to be equal to the distance between the center of the integrated opening 300 and the center of the integrated light shielding part 400, i.e., needs to be a half of the reference parallax barrier pitch P. This indicates that the light shielding barrier widths BW on the left and right sides of the sub-pixel 411a need to be equal and that the light shielding barrier widths BW on the left and right sides of the sub-pixel 411b need to be equal.

For example, in the case where the integrated light shielding width SBW and the integrated opening width SW are both a half of the reference parallax barrier pitch P and are equal to each other and the light shielding barrier width BW in the display panel 11 is uniform, the completely light-shielding angle range of one of the sub-pixels 411a and 411b overlaps with the flat-luminance region of the other sub-pixel.

FIG. 13, described previously, illustrates the result of calculating the angular width of flat-luminance region and the completely light-shielding region under different conditions. Here, the reference parallax barrier pitch P of the parallax barrier shutter panel 21 is set to 0.100 mm under all of the conditions 1 to 6.

The integrated opening width SW of the parallax barrier shutter panel 21 is set to be greater than the sub-pixel width GW under the conditions 1 to 3. Here, the integrated opening width SW is set constant at 0.050 mm, which is a half of the reference parallax barrier pitch P, and the sub-pixel width GW is set to 0.030 mm, 0.035 mm, and 0.040 mm respectively under the conditions 1, 2, and 3. In this case, the difference in width |SW−GW| decreases in order from the conditions 1 to 3, and therefore the angular width of flat-luminance region also narrows in the order as described above.

FIG. 13 also shows relative peak luminance. In general, average luminance that corresponds to the relative peak luminance is a value obtained by multiplying the luminance of the sub-pixels 411 in the display panel 11 by a smaller one of the ratio of the sub-pixel width GW to the reference parallax barrier pitch P (ratio GW/P) and the ratio of the integrated opening width SW to the reference parallax barrier pitch P (ratio SW/P). Thus, these ratios are also shown in FIG. 13. Since the ratio GW/P is smaller than the ratio SW/P under the conditions 1 to 3, not the ratio SW/P but the ratio GW/P corresponds to the relative peak luminance.

Also, the integrated light shielding widths SBW (=P−SW) under the conditions 1 to 3 are 0.050 mm. Then, the completely light-shielding angle range (completely light-shielding angular width) corresponds to the difference in width |SBW−GW| as described in relation to the condition (C2).

Referring to the conditions 4 to 6, the sub-pixel width GW is set to be greater than the integrated opening width SW of the parallax barrier shutter panel 21, as opposed to those under the conditions 1 to 3. Here, the difference in width |SW−GW | is set uniform at 0.02 mm. Also, under the conditions 4, 5, and 6, the sub-pixel widths GW are respectively set to 0.040 mm, 0.045 mm, and 0.050 mm, and the integrated opening widths SW are respectively set to 0.020 mm, 0.025 mm, and 0.030 mm. In this case, since the difference in width |SW−GW| is constant under the conditions 4 to 6, the angular width of flat-luminance region is also constant.

Also, the relative peak luminance under the conditions 4 to 6 corresponds not to the ratio GW/P but to the ratio SW/P because the ratio SW/P is smaller than the ratio GW/P. Also, the integrated light shielding widths SBW (=P−SW) under the conditions 4, 5, and 6 are respectively set to 0.080 mm, 0.075 mm, and 0.070 mm. Then, the completely light-shielding angle range (completely light-shielding angular width) corresponds to the difference in width |SBW−GW| as described in relation to the condition (C2). Here, the completely light-shielding angular widths under the conditions 4, 5, and 6, i.e., 4, 3, and 2 degrees, are greater than or equal to the maximum value, 2 degrees, of the completely light-shielding angular widths under the conditions 1 to 3.

A comparison of the conditions 1 and 6 shows that the value of the sub-pixel width GW and the value of the integrated opening width SW are interchanged between one and the other conditions, but the angular width of flat-luminance region, the relative peak luminance, and the completely light-shielding angular width are the same between these two conditions. Also, although not shown, even under a condition in which the values of the sub-pixel width GW and the integrated opening width SW for the condition 2 are interchanged, the angular width of flat-luminance region, the relative peak luminance, and the completely light-shielding angular width that are obtained are the same as those obtained under the condition 2.

In summary, from the viewpoint of increasing luminance, a greater one of the ratio GW/P and the ratio SW/P is preferably set in the range of 40 to 50%. The other ratio(smaller ratio) is preferably set as appropriate in consideration of the fact that if this ratio becomes too large, |GW−SW| decreases and accordingly the angular width of flat-luminance region narrows, and if this ratio becomes too small, the relative peak luminance decreases.

Since the light shielding barriers 18 (FIG. 1) exist in the actual liquid crystal panel, the sub-pixel width GW is smaller than the half of the reference parallax barrier pitch P. Accordingly, in the liquid crystal panel, making the integrated opening width SW of the parallax barrier shutter panel 21 greater than the sub-pixel width GW is more effective to increase the difference between the integrated opening width SW and the sub-pixel width GW.

Condition (C3)

The following description is given regarding a configuration that satisfies the aforementioned condition (C3), i.e., a configuration that satisfies the condition that the luminance along the travel path of the observer 90 is flat (constant) even if the sub-openings 210 are switched between the light transmission state and the light shielding state, following the shift of the integrated openings 300.

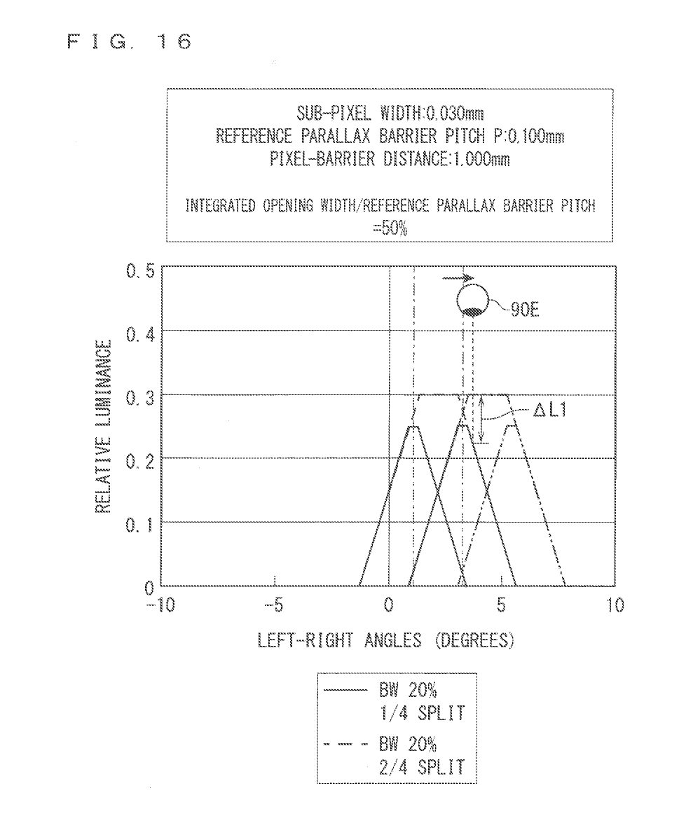

FIG. 15 is a diagram for describing a change in the angular distribution of luminous intensity of light emitted from the sub-pixel 411a for displaying the right image on the virtual screen 100, following the shift of the integrated openings 300. It is assumed that the same prerequisite as that applied in FIGS. 11 and 14 is also applied in FIG. 15. Taking the result of the condition (C1) into consideration, a region where the luminance is constant is extended on the virtual screen 100. That is, the integrated opening width SW is made greater than the sub-pixel width GW so as to extend the flat portion of the angular distribution of luminous intensity.

In the drawing, an integrated opening 300 is formed by three sub-openings 210a, 210b, and 210c. Light beams emitted from the sub-pixel 411a pass through the sub-opening 210a and form a luminance distribution LP1 on the virtual screen 100. Similarly, light beams emitted from the sub-pixel 411a pass through the sub-openings 210b and 210c and form luminance distributions LP2 and LP3 on the virtual screen 100. Then, an integrated luminance distribution TLP1 obtained by accumulating these luminance distributions LP1 to LP3 forms an actual luminance distribution on the virtual screen 100.

A position P22 on the virtual screen 100 that corresponds to the left end of the flat portion of the integrated luminance distribution TLP1 is determined by a light beam L5 that is emitted from the left end of the sub-pixel 411a and passes through the left end of the one sub-opening 210a. Also, a position P23 on the virtual screen 100 that corresponds to the right end of that flat portion is determined by a light beam L6 that is emitted from the right end of the sub-pixel 411a and passes through the right end of the sub-opening 210c.

Next, a state is considered in which an integrated opening 300 is formed by three sub-openings 210b, 210c, and 210d by setting the sub-opening 210a to the light shielding state and setting the sub-opening 210d to the light transmission state. That is, consider a state in which the integrated opening 300 is shifted by an amount equivalent to the sub-opening pitch ΔSW to the right from the aforementioned state. At this time, the luminance distribution LP1 is not formed, and a luminance distribution LP4 is formed by light beams emitted from the sub-pixel 411a and passing through the sub-opening 210d. Then, an integrated luminance distribution TLP2 obtained by accumulating these luminance distributions LP2, LP3, and LP4 forms a luminance distribution of light passing through the integrated opening 300 on the virtual screen 100.

A position P32 on the virtual screen 100 that corresponds to the left end of the flat portion of this integrated luminance distribution TLP2 is determined by a light beam L7 that is emitted from the left end of the sub-pixel 411a and passes through the left end of the sub-opening 210b. Here, if the position P32 is located on the right side of the position P23, the condition (C3) is not satisfied because a valley is formed between the flat portion of the integrated luminance distribution TLP1 and the flat portion of the integrated luminance distribution TLP2. Thus, in order to satisfy the condition (C3), the position P32 needs to be located on the left side of the position P23. Here, if the designed observation distance D is increased in the case where an angle θ5 formed between the light beams L5 and L7 is greater than an angle θ6 formed between the light beams L5 and L6 (in the case illustrated in FIG. 15), the light beams L7 and L6 will intersect with each other, and the position P32 will be located on the right side of the position P23. Although the designed observation distance D is illustrated as short in FIG. 15 for the convenience of illustration, in actuality the designed observation distance D is much greater than the pixel-barrier distance L, and with this in consideration, it is understood that the aforementioned positional relationship can possibly develop in ordinary cases.

In view of this, in order to satisfy the condition (C3) for an arbitrary designed observation distance D, the angle θ5 between the light beams L5 and L7 needs to be less than or equal to the angle θ6 between the light beams L5 and 6, unlike in the case illustrated in FIG. 15. In the case where the angle θ5 is approximated by the sub-opening pitch ΔSW, the angle θ6 can be approximated by the difference between the integrated opening width SW and the sub-pixel width GW, so that the sub-opening pitch ΔSW needs to be less than or equal to the difference between the integrated opening width SW and the sub-pixel width GW.

Here, the observer 90 is assumed to have moved in the direction indicated by the arrow (right direction) in FIG. 15. The detector 31 detects the position (motion) of the observer 90. The controller 32 controls the parallax barrier shutter panel 21 on the basis of the detection result so that, when the left eye of the observer 90 is positioned between the positions P32 and P23, the sub-opening 210a is set to the light shielding state and the sub-opening 210d is set to the light transmission state. Accordingly, even the observer 90 who is moving is able to continue to visually recognize a stereoscopic image without perceiving a change in the luminance of the image.

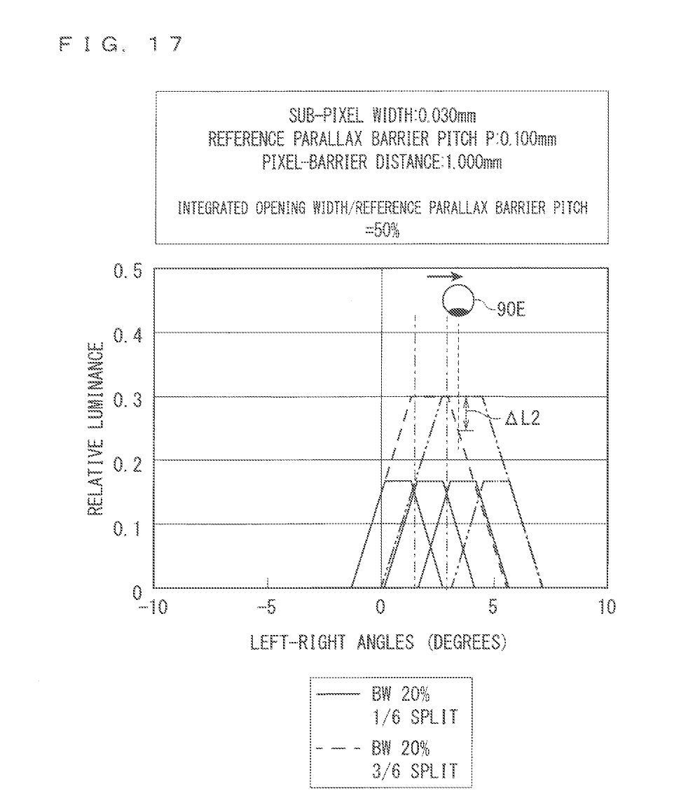

Next, the content described above will be described in detail with reference to FIGS. 16 to 19. FIGS. 16 to 19 illustrate the result of calculating a change in the angular distribution of luminous intensity, following the operation of switching the sub-openings 210. Here, the condition for performing the calculation in FIGS. 16 to 18 is assumed to be approximately the same as the condition 1 in FIG. 13. It is assumed here that the reference parallax barrier pitch P of the parallax barrier shutter panel 21 is 0.100 mm, the integrated opening width SW is 0.050 mm, i.e., a half of the reference parallax barrier pitch P, the sub-pixel width GW is 0.030 mm, and the difference in width |GW−SW| is 0.020 mm.

FIGS. 16 to 18 illustrate the result of calculation performed on condition that the sub-opening pitch ΔSW is 1/N of the reference parallax barrier pitch P, where N is an even number greater than or equal to four, under the condition 1. Specifically, the conditions applied in FIGS. 16, 17, and 18 are respectively 1/4 (N=4), 1/6 (N=6), and 1/8 (N=8). Since the integrated opening width SW is 0.050 mm, i.e., a half of the reference parallax barrier pitch P, the integrated opening 300 is configured by N/2 sub-openings 210.

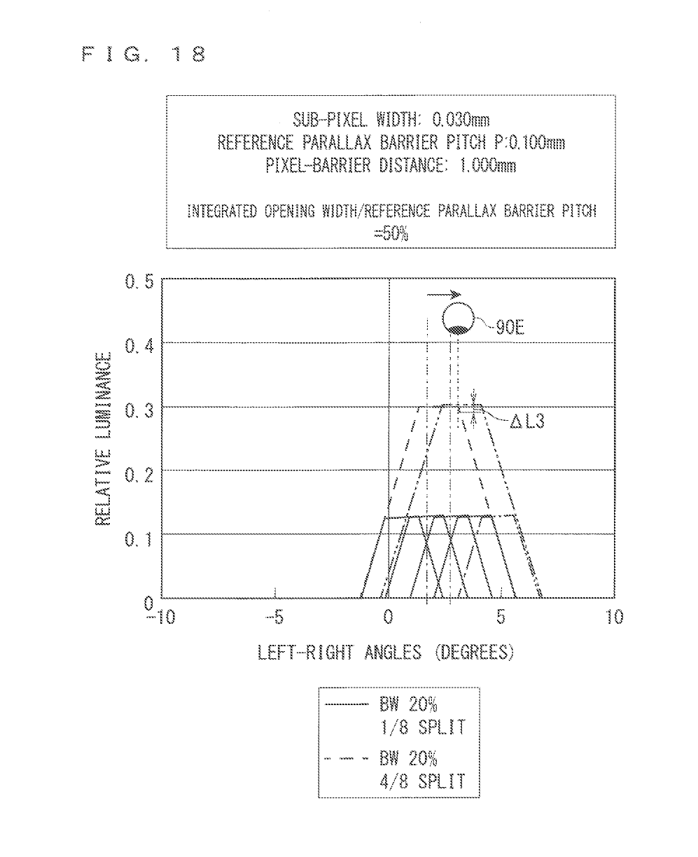

Here, the condition of N=4 in FIG. 1 (hereinafter, also referred to as the “condition 1-1”) fails to satisfy the condition (C3) because the sub-opening pitch ΔSW is 0.025 mm (=P/N) and greater than the difference in width |GW−SW| of 0.020 mm. On the other hand, the condition of N=6 in FIG. 17 (hereinafter, referred to as the “condition 1-2”) satisfies the condition (C3) because the sub-opening pitch ΔSW is approximately 0.017 mm (=P/N) and smaller than the difference in width |GW−SW| of 0.020 mm. Also, the condition of N=8 in FIG. 18 (hereinafter, referred to as the “condition 1-3”) satisfies the condition (C3) because the sub-opening pitch ΔSW is approximately 0.0125 mm (=P/N) and smaller than the difference in width |GW−SW| of 0.020 mm.

In FIGS. 16 to IS, luminance distributions of light having passed through individual sub-openings 210 are indicated by solid lines, and integrated luminance distributions each having a flat portion and obtained by overlaying the luminance distributions are indicated by broken lines. Also, luminance distributions of light having passed through sub-openings 210 that are newly set to the light transmission state when the integrated openings 300 are shifted by an amount equivalent to the sub-opening pitch ΔSW to the right, and integrated luminance distributions that take these luminance distributions into consideration are indicated by dashed double-dotted lines. Also, points that indicate the timing of switching the positions of the integrated openings 300 in accordance with the position of an eye 90E of the observer are indicated by dashed dotted lines in the drawing. When the detector 31 has detected that the eye 90E of the observer has moved beyond a switching point in the right direction, the integrated luminance distributions are shifted to the right without changing the shape under the control of the controller 32. Based on this premise, the results of calculation under the conditions 1-1 to 1-3 will be described hereinafter.

The condition 1-1 is not a configuration that satisfies the condition (C3), and therefore, gradients develop between the flat portions of the integrated luminance distributions before and after switching as illustrated in FIG. 16. Thus, the observer perceives a change in luminance even if there is no time interval between when the eye 90E of the observer has crossed a switching point and when the switching of the sub-openings 210 is completed. If this time interval is long, the observer will perceive a greater change ΔL1 in luminance.

In contrast, the condition 1-2 is a configuration that satisfies the condition (C3), and therefore, the flat portions of the integrated luminance distributions in the vicinity of the switching points overlap one another and there are no gradients as illustrated in FIG. 17. Accordingly, the observer does not perceive a change in luminance if there is no time interval between when the eye 90E of the observer has crossed a switching point and when the switching of the sub-openings 210 is completed. Even if the time interval is somewhat long, the observer perceives only a relatively small change ΔL2 in luminance.

Similarly, the condition 1-3 is a configuration that satisfies the condition (C3), and therefore, the observer does not perceive a change in luminance as in the case of the condition 1-2 if there is no time interval in the switching of the sub-openings 210 when shifting the integrated openings 300. Even if this time interval is somewhat long, the observer perceives only a relatively small change ΔL3 in luminance. Note that the change ΔL3 in luminance under the condition 1-3 is smaller than the change ΔL2 in luminance under the condition 1-2. Accordingly, the sub-opening pitch ΔSW is preferably as small as possible in order to minimize a change in luminance.

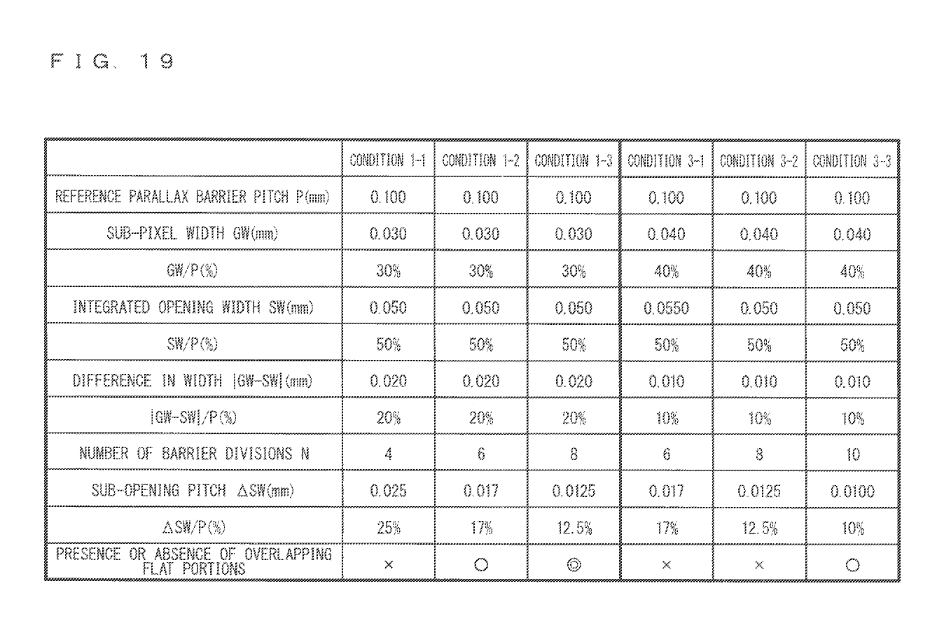

The left side in FIG. 19 summarizes the above-described calculation results. In the drawing, a cross indicates that the flat portions of the integrated luminance distributions before and after switching are separated from one another, an open circle indicates that these flat portions overlap within a narrow range, and a double circle indicates that these flat portions overlap within a wide range.

The right side in FIG. 19 illustrates, as conditions 3-1 to 3-3, the results of calculation performed when the sub-opening pitch ΔSW is set to 1/6 (N=6), 1/8 (N=8), and 1/10 (N=10) of the reference parallax barrier pitch P under the condition 3 in FIG. 13. Under the condition 3-1 (N=6), there are no overlaps of the flat portions because the sub-opening pitch ΔSW is approximately 0.017 mm (=P/N) and greater than the difference in width. |GW−SW| of 0.010 mm. Under the condition 3-2 (N=8), there are no overlaps of the flat portions because the sub-opening pitch ΔSW is 0.0125 mm (=P/N) and greater than the difference in width |GW−SW| of 0.010 mm. On the other hand, under the condition 3-3 (N=10) in. FIG. 17, the flat portions overlap one another because the sub-opening pitch ΔSW is 0.010 mm (=P/N) and the same as the difference in width |GW−SW| of 0.010 mm.

As a result, it is found that the sub-opening pitch ΔSW needs to be small in order to satisfy the condition (C3). However, in current production techniques, if the partition width between the first transparent electrodes 23 (FIG. 1) is set to approximately 1 μm or less, the costs of facilities for manufacturing processes and the frequency of occurrence of insulation failures will increase. In consideration of this point, the sub-opening pitch ΔSW is desirably greater than or equal to 4 μm.

Here, the stationary naked-eye stereoscopic image display panel 790 that is highly required to control a stereoscopic area in accordance with the position of the observer and that is observed by one observer is typically a medium-size display whose diagonal is approximately 10 to 20 inches and in which the sub-pixel width GW is in the range of approximately 0.040 to 0.100 mm. In this case, the reference parallax barrier pitch P is in the range of 0.080 to 0.200 mm. Then, when the sub-opening pitch ΔSW is set to 4 μm as described previously and the reference parallax barrier pitch P is set in the range of 0.080 to 0.200 mm, the sub-opening pitch ΔSW is 2% to 5% of the reference parallax barrier pitch P. Accordingly, the realistic number of divisions N required to achieve the desired sub-opening pitch ΔSW is a maximum of approximately 20 to 50 according to the value of the reference parallax barrier pitch P.

However, the total width of the boundary parts between the first transparent electrodes 23 of the parallax barrier shutter panel 21 increases as the number of divisions N increases. These boundary parts are portions that prevent the application of an electric field to the liquid crystal layer 24. If the boundary parts become light-transmittable, light leakage occurs and 3D crosstalk becomes worse. On the other hand, if the boundary parts serve as light absorbers and block light, the light transmission coefficient is reduced.

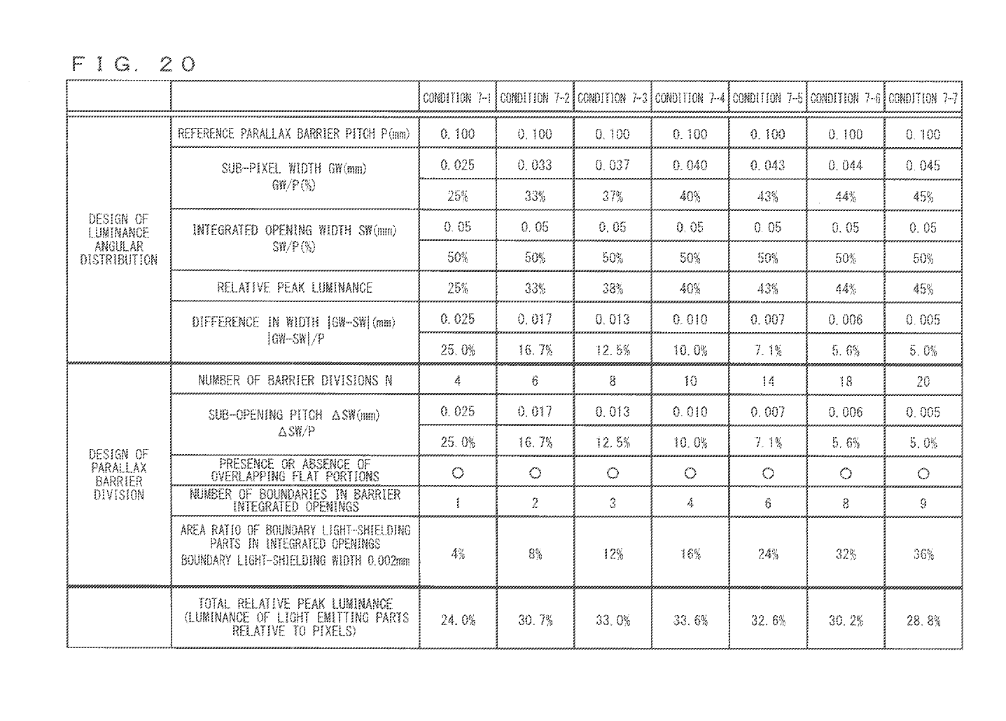

FIG. 20 illustrates the relationship between the number of divisions N and total relative peak luminance (luminance of light emitting parts relative to pixels). It is assumed here that the boundary parts are composed of light absorbers, and the transmittance decreases as the number of boundary parts (hereinafter, referred to as “boundary light shielding parts”) increases. Here, the partition width is assumed to be 1 μm, and the width of the boundary light shielding parts is assumed to be approximately two times (here, 2 μm) the partition width. Also, the reference parallax barrier pitch P is set to 0.100 mm, the integrated opening width SW is set constant at 0.050 mm (50%), and the difference between the sub-pixel width GW and the integrated opening width SW is set to be exactly equal to the sub-opening pitch ΔSW, i.e., SW=GW=ΔSW.

In the drawing, the sub-opening pitch ΔSW decreases as the number of divisions N increases, as shown by conditions 7-1 to 7-7. Here, since GW=SW−ΔSW and the integrated opening width SW is constant, the sub-pixel width GW increases and accordingly the relative peak luminance (fourth row from the top in the drawing) also increases. As a result, under the conditions 7-1 to 7-4, the total relative peak luminance increases as the number of divisions N increases. However, the ratio of the area of the boundary light shielding parts increases as the number of divisions N increases, and if the number of divisions N has increased to some extent, a reduction in the total relative peak luminance due to the increase in the ratio of the area of the boundary light shielding parts becomes more remarkable than the increase in the total relative peak luminance due to the increase in the relative peak luminance. As a result, as shown by the conditions 7-4 to 7-7, the total relative peak luminance decreases as the number of divisions N increases.

According to these results, the total relative peak luminance is greater than 30% when the number of divisions N is in the range of 6 to 18, and takes a maximum value when the number of divisions N is 10. In the case where the reference parallax barrier pitch P is smaller than 0.100 mm and the width of the boundary light shielding parts is greater than 2 μm, the number of divisions N at which the total relative peak luminance takes a maximum value becomes smaller, and in contrast, in the case where the reference parallax barrier pitch P is greater than 0.100 mm and the width of the boundary light shielding parts is less than 2 μm, the number of divisions N at which the total relative peak luminance takes a maximum value becomes greater.

### SUMMARY

In the display device as described above, the pitch of the sub-openings 210 in the parallax barrier shutter panel 21 is less than or equal to the difference between the width of the sub-pixels 411 in the display panel 11 and the width of the integrated openings 300 in the parallax barrier shutter panel 21. This suppresses the formation of a valley between the flat portions of luminance distributions before and after switching. Accordingly, it is possible to prevent the observer who is moving from perceiving a change in the luminance of images and to suppress the occurrence of flicker.

Also, as described above, a greater one of the ratio GW/P of the sub-pixel width GW to the reference parallax barrier pitch P and the ratio SW/P of the integrated opening width SW to the reference parallax barrier pitch P is desirably set in the range of 40 to 50%. Also, since it is proper to obtain the sub-opening pitch ΔSW by dividing the reference parallax barrier pitch P into six to eighteen parts, it is proper for the sub-opening pitch ΔSW to be approximately 10 to 25% of the reference parallax barrier pitch P. That is, it is proper to set the smaller one of the ratio GW/P and the ratio SW/P to a value obtained by deducting 10 to 25% from the greater ratio. However, the smaller ratio is desirably set to a value obtained by deducting 10 to 20% from the greater ratio in order to preferably avoid a 50 percent reduction in transmittance.

With the settings as described above, light-use efficiency can be improved. Also, if the sub-openings 210 located at the ends of the integrated openings 300 are switched between the light shielding state and the light transmission state in accordance with the position of the observer, it is possible to prevent a change in the luminance of an image at the time of shifting the integrated openings 300 and to prevent the observer from perceiving flicker.

As described above, the detector 31 illustrated in FIG. 1 detects the position (motion) of the observer 90. The controller 32 controls the positions of the integrated openings 300 in the lateral direction of the parallax barrier shutter panel 21 by changing which of the sub-openings 210 are in the light transmission state on the basis of the result of detection by the detector 31. That is, the display device according to the present technique allows the integrated openings 300 to be shifted in the lateral direction in accordance with the position of the observer 90 when the position of the observer 90 has moved in the left-right direction. As a result, even the observer 90 who is moving is able to visually recognize a stereoscopic image.

However, there are cases in which the detector 31 cannot detect the position of the observer 90, such as a case where the observer 90 has moved to a position that is inclined significantly from the front side of the display device. In a case such as described above, it is also possible to display a two-dimensional image (image with no parallax) by setting all the sub-openings 210 in the parallax barrier shutter panel 21 to the light transmission state, and at the same time causing the sub-pixels 411a and 411b in the display panel 11 to display the same image data. In this case, even if a malfunction has occurred in the detector 31, images can reliably be displayed. Instead of causing the sub-pixels 411a and 411b to display the same image data, all of the sub-pixels 411a and 411b in the display panel 11 may be caused to display a single piece of two-dimensional image data. This enables a higher resolution of display.

Example 1 of Second Prerequisite Technique

The following description is given regarding Example 1 of a second prerequisite technique that is a technique serving as a prerequisite for embodiments of the present invention, which will be described later.

In the naked-eye stereoscopic image display panel 790 described in the aforementioned first prerequisite technique, the number of first transparent electrodes 23 extending in the longitudinal direction of the parallax barrier shutter panel 21 (direction perpendicular to the plane of FIG. 1) is N/2 times the number of pieces of wiring extending in the longitudinal direction of the display panel 11 and is a relatively large number. This configuration makes it difficult to drive the parallax barrier shutter panel 21 by a segment method. Also, the pitch of junctions is narrowed due to an increase in the number of junctions with a flexible plated circuit for applying voltage from the outside, which makes an installation operation somewhat difficult. Alternatively, the cost of structural components increases as the required number of drive integrated circuits (IC) increases. Also, in the case where the actual observation distance differs from the designed observation distance D, there is the risk that the observer may perceive flicker caused by a local change in luminance that can be visually recognized as emission lines or dark lines. A naked-eye stereoscopic image display panel according to the second prerequisite technique described below can resolve these problems. Hereinafter, constituent elements that are the same as or similar to those described in the first prerequisite technique are given the same reference numerals, and the following description focuses on differences from the first prerequisite technique.

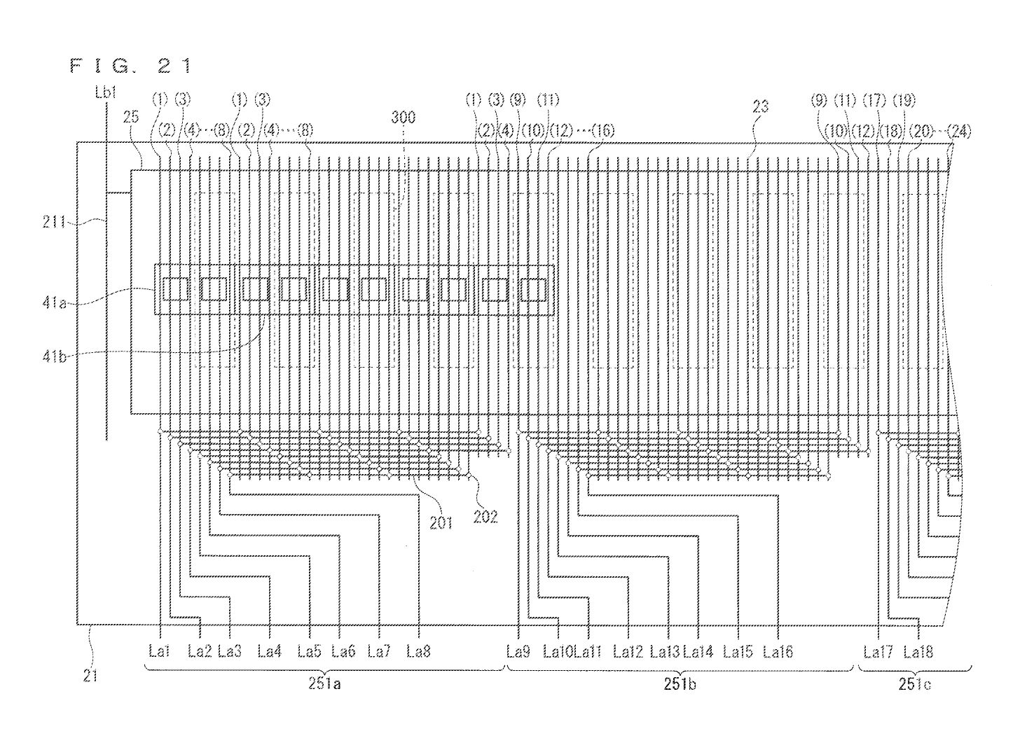

FIG. 21 is a partial plan view schematically illustrating a wiring configuration of the parallax barrier shutter panel 21 in the naked-eye stereoscopic image display panel according to the second prerequisite technique. According to the second prerequisite technique, a plurality of common drive areas are provided by dividing the display area of the parallax barrier shutter panel 21 in the lateral direction (left-right direction in the drawing). Although the partial plan view in FIG. 21 illustrates a first common drive area 251a, a second common drive area 251b located on the right side of the first common drive area 251a, and part of a third common drive area 251c located on the right side of the second common drive area 251b, there may be more common drive areas. In the following description, a plurality of common drive areas including the first common drive area 251a, the second common drive area 251b, and the third common drive area 251c are also collectively referred to as common drive areas 251.

First sub-pixel pairs 41a and second sub-pixel pairs 41b that are adjacent to one another in the lateral direction belong to each common drive area 251. The first sub-pixel pairs 41a and the second sub-pixel pairs 41b are the same as the plurality of sub-pixel pairs 41 (FIG. 1). Although only five sub-pixel pairs are illustrated in the drawing, there are also other sub-pixel pairs (not shown) in the other areas.

Each first transparent electrode 23 extends in the longitudinal direction (up-down direction in FIG. 21). The plurality of first transparent electrodes 23 is divided into even numbers N (here, N=8) each within the reference parallax barrier pitch P (see FIG. 1) corresponding to each sub-pixel pair 41. That is, an even number N of (here, eight) first transparent electrodes 23 correspond to each sub-pixel pair 41 and are aligned in the lateral direction. Here, the number of pieces of wiring that form an integrated opening 300 (see FIGS. 3 to 10) configured by a plurality of sub-openings 210 is assumed to be N/2 (here, four).

According to the second prerequisite technique, in each common drive area 251, each of the even number N of (eight) first transparent electrodes 23 that correspond to the first sub-pixel pair 41a and each of the even number N of (eight) first transparent electrodes 23 that correspond to the second sub-pixel pair 41b are electrically connected to each other. This connection is established so as to enable control of the sub-openings 210 as will be described later.

For example, the first transparent electrode 23 that is numbered (1) in the first sub-pixel pair 41a is electrically connected via common wiring 201 and a contact hole 202 to the first transparent electrode 23 that has the same number (1) in the second sub-pixel pair 41b and that is the N-th (here, eighth) first transparent electrode counted from the first transparent electrode 23 numbered (1) in the first sub-pixel pair 41a. Similarly, each of the first transparent electrodes 23 numbered (2) to (N) in the first sub-pixel pair 41a, where N=8, is electrically connected via common wiring 201 and a contact hole 202 to the N-th first transparent electrode 23 having the same number, i.e., one of (2) to (N), in the second sub-pixel pair 41b, where N=8. The first transparent electrodes 23 having the same number in M sub-pixel pairs 41, where M is a positive integer and in the present example M=4, are electrically connected to one another via the common wiring 201 and the contact holes 202. That is, in the first common drive area 251a, the first transparent electrodes 23 are electrically connected to one another at intervals of N first transparent electrodes 23 (with a space of N-1 first transparent electrodes), and accordingly eight sets of M first transparent electrodes 23 connected to one another are configured.

Moreover, N/2 (here, four) first transparent electrodes 23 numbered (1) to (4) are added to the right end of the first common drive area 251a. These four first transparent electrodes 23 are also each electrically connected via common wiring 201 and contact holes 202 to the first transparent electrodes 23 having the same number in the same manner as described above. Also in this case, the relationship that the first transparent electrodes 23 are electrically connected to one another at intervals of N first transparent electrodes 23 (with a space of N-1 first transparent electrodes) remains intact. Accordingly, the number of first transparent electrodes 23 electrically connected to one another is M+1 for each of the numbers (1) to (4) and is M for each of the numbers (5) to (8). Here, M is assumed to be N/2 (here, four). The eight pieces of common wiring 201 that are connected respectively to the first transparent electrodes 23 numbered (1) to (8) are connected respectively to eight terminals La1 to La8, which are also collectively referred to as terminals La.

In the second common drive area 251b, first transparent electrodes 23 numbered (9) to (16) are repeatedly aligned M times. Moreover, N/2 (here, four) first transparent electrodes 23 numbered (9) to (12) are added to the right end of the second common drive area 251b. These four first transparent electrodes 23 are also each electrically connected via common wiring 201 and contact holes 202 to the first transparent electrodes 23 having the same number in the same manner. Also in this case, the relationship that the first transparent electrodes 23 are electrically connected via the common wiring 201 and the contact holes 202 to one another at intervals of N first transparent electrodes 23 (with a space of N-1 first transparent electrodes) remains intact. The eight pieces of common wiring 201 that are connected respectively to the first transparent electrodes 23 numbered (9) to (16) are connected respectively to eight terminals La9 to La16. Moreover, in the third common drive area 251c, eight pieces of common wiring 201 that are connected respectively to the first transparent electrodes 23 numbered (17) to (24) are connected respectively to eight terminals La17 to La24.

In the display device described above, if a voltage is selectively applied to the terminals La1 to La8, it is possible to apply the same voltage equally to the first transparent electrodes 23 having the same number in the first common drive area 251a and to apply different voltages to the first transparent electrodes 23 having different numbers. The same applies to the other common drive areas 251.

Next, the second transparent electrode 25 will be described. The second transparent electrode 25 is a single common electrode that extends in the lateral and longitudinal directions and is connected to common wiring 211 connected to a terminal Lb1 as illustrated in FIG. 21.

The terminals La1 to La8 and the terminal Lb1 are joined to a flexible plated circuit or a drive IC in the peripheral portion of the parallax barrier shutter panel 21 other than the display area and configured to receive a voltage from outside via the flexible plated circuit or the drive IC. This display device eliminates the need to install one terminal for each of the first transparent electrodes 23 to control the sub-openings 210. For example, in the case of driving each sub-opening 210 in one common drive area 251 illustrated in FIG. 21, the same number of terminals as the number of first transparent electrodes 23, i.e., 36 terminals, are conventionally required. However, according to the second prerequisite technique, the required number of terminals is eight (terminals La1 to La8). This number is smaller than the number of sub-pixel transparent electrodes 12, i.e., 9, (FIG. 1) in the display panel 11 within the corresponding width. Accordingly, ICs having the same terminal pitch as the ICs for driving the display panel 11 can be used to drive the parallax barrier shutter panel 21. Alternatively, one IC may be used to drive both of the display panel 11 and the parallax barrier shutter panel 21. Moreover, if the number M of first transparent electrodes 23 that are electrically connected to one another via one common wiring 201 and the contact holes 202 is increased, the number of terminals can further be reduced.

As described above, in the display device according to this second prerequisite technique, the first transparent electrodes 23 that correspond to the first sub-pixel pair 41a are electrically connected to the first transparent electrodes 23 that correspond to the second sub-pixel pair 41b. This reduces the number of terminals required for the first transparent electrodes 23, thereby facilitating the installation operation. Also, the size of the substrate on which the first transparent electrodes 23 are provided can be reduced. Moreover, since the number of drive ICs can be reduced, the cost of structural components can be reduced.

Next is a description of operations of the display device having the above-described configuration according to the second prerequisite technique.

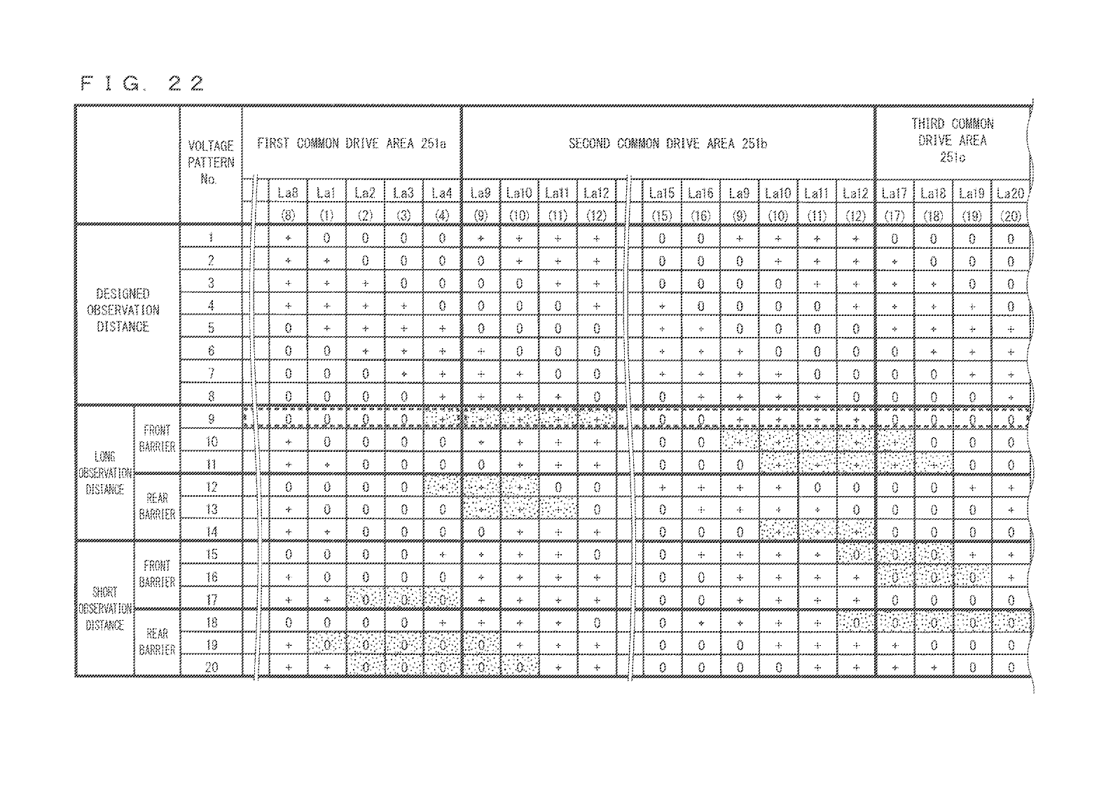

FIG. 22 illustrates patterns of a voltage applied to the first transparent electrodes 23 numbered (1) to (20) in the first to third common drive areas 251a to 251c of the parallax barrier shutter panel 21 according to the second prerequisite technique of the present invention. The drawing illustrates in particular voltage patterns in the vicinity of the boundary part between the common drive areas 251a and 251b and in the vicinity of the boundary part between the common drive areas 251b and 251c. Here, according to the second prerequisite technique of the present invention, a normally white twisted nematic (TN) mode is assumed as the liquid crystal mode of the liquid crystal layer 24 (FIG. 1) of the parallax barrier shutter panel 21. The number of pieces of wiring that form an integrated opening 300 (FIGS. 3 to 10) is N/2 (here, four). Note that a null (zero) voltage is applied to the terminal Lb1 of the second transparent electrode 25. That is, “0” in FIG. 22 indicates that no voltage is applied, and accordingly the corresponding sub-opening 210 is set to the light transmission state. Also, “+” indicates that a voltage is applied, and accordingly the corresponding sub-opening 210 is set to the light shielding state.

Next, specific operations will be described using a voltage pattern No. 1 (FIG. 22) as an example. Here, the order in which the plus voltage and the null voltage are applied to the terminals differs for each common drive area 251. For example, a plus voltage is applied to the four terminals La9 to La12 counted from the left end in the second common drive area 251b, whereas a null voltage is applied to the four terminals La17 to La20 counted from the left end in the third common drive area 251. That is, the correspondence relationship between the order of terminals and the value of the voltage in each common drive area 251 is shifted by an amount equivalent to four terminals between adjacent common drive areas 251. In this way, voltage is applied such that, when the voltages of terminals in adjacent common drive areas 251 are compared, terminals located at positions shifted by an amount equivalent to N/2 (here, four) terminals from each other are at the same voltage. Accordingly, the voltage patterns as illustrated in FIG. 22 (patterns in which four first transparent electrodes 23 in the light shielding state and four first transparent electrode 23 in the light transmission state are repeatedly aligned over the common drive areas 251a to 251c) can be formed for the display device, which is configured such that N·M+N/2 first transparent electrodes 23 are electrically connected to one another at intervals of N first transparent electrodes 23 (with a space of N-1 first transparent electrodes) as illustrated in FIG. 21. In the voltage pattern No. 1, a null voltage is applied to the terminals La1 to La4 of the first transparent electrodes 23 in the first common drive area 251a, a plus voltage is applied to the terminals La5 to La8, a plus voltage is applied to the terminals La9 to La12 of the first transparent electrodes 23 in the second common drive area 251b, a null voltage is applied to the terminals La13 to La16, a null voltage is applied to the terminals La17 to La20 of the first transparent electrodes 23 in the third common drive area 251c, and a plus voltage is applied to the terminals La21 to La24. Accordingly, the same voltage, either a null voltage or a plus voltage, is applied to the first transparent electrodes 23 having the same number. As a result, the voltage pattern No. 1 in FIG. 22 can be achieved.

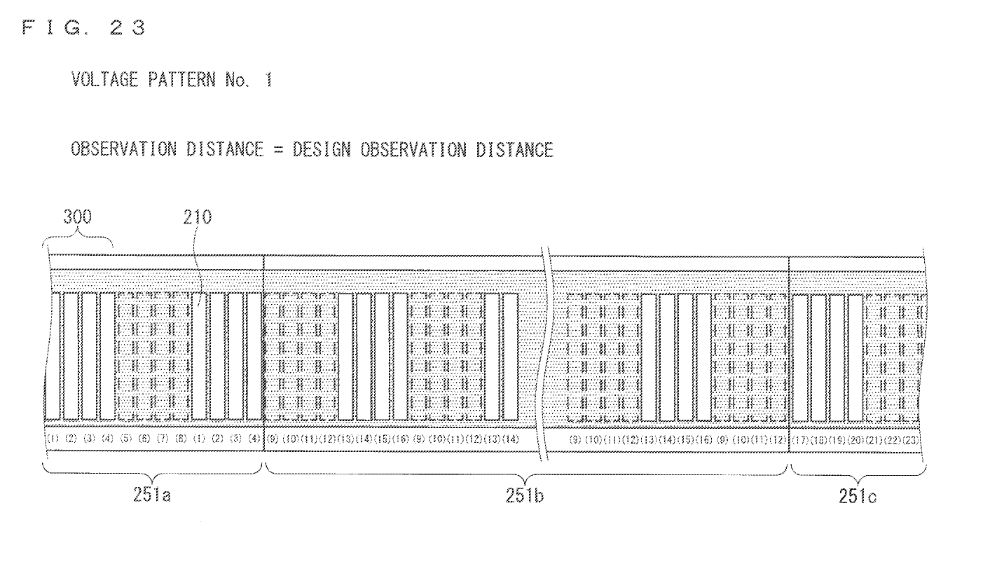

In the case of the voltage pattern No. 1 (FIG. 22), four continues sub-openings 210 that correspond to the first transparent electrodes 23 to which a plus voltage is applied are set to the light shielding state, and four continuous sub-openings 210 that correspond to the first transparent electrodes 23 to which a null voltage is applied are set to the light transmission state as illustrated in FIG. 23. This achieves a state in which the integrated openings 300 each having a width equivalent to a half of the reference parallax barrier pitch P are formed as in the case of the pattern 1 (FIG. 3). Then, each voltage pattern applied to the terminals is shifted by an amount equivalent to one terminal in sequence as shown by the voltage patterns No. 2 to No. 8 (FIG. 22), so that the positions of the integrated openings 300 can be shifted by an amount equivalent to the sub-opening pitch ΔSW as in the case of the patterns 2 to 8 (FIGS. 4 to 10).

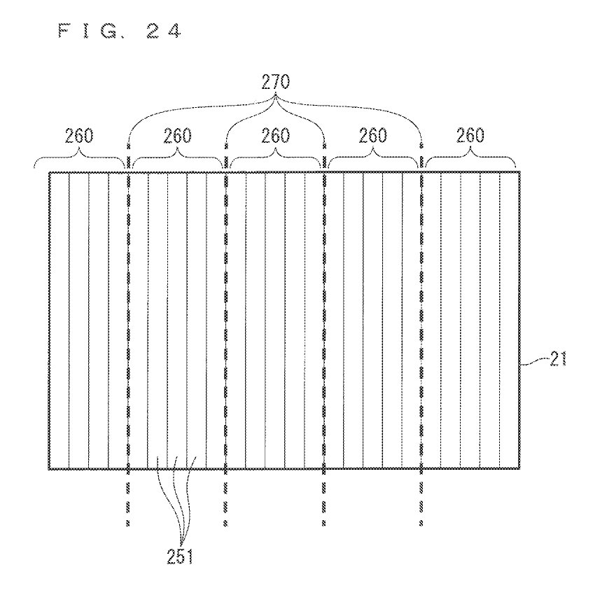

FIG. 24 is a partial plan view for describing the operating state of the entire parallax barrier shutter panel 21. The display surface of the parallax barrier shutter panel 21 includes a plurality of common drive areas 251, and in each common drive area 251, the voltage pattern is individually set so as to control the width and positions of the integrated openings 300. In the operating state illustrated in FIG. 24, the common drive areas 251 are sectioned into common barrier mode areas 260. Each common barrier mode area 260 includes a plurality of continuous common drive areas 251. In one and the same common barrier mode area 260, the same voltage pattern is applied to each common drive area 251. In the illustrated example, there are five common barrier mode areas 260. In each common barrier mode area 260, the integrated openings 300 with an equal width are aligned at an equal pitch in the left-right direction. That is, the integrated openings 300 exist periodically. However, the integrated openings 300 are out of phase with one another among adjacent common barrier mode areas 260. This phase shift will be described later in detail. The positions of the boundaries between the common barrier mode areas 260, i.e., the positions of barrier mode shift boundaries 270, can be shifted by an amount equivalent to the width of the common drive areas 251.

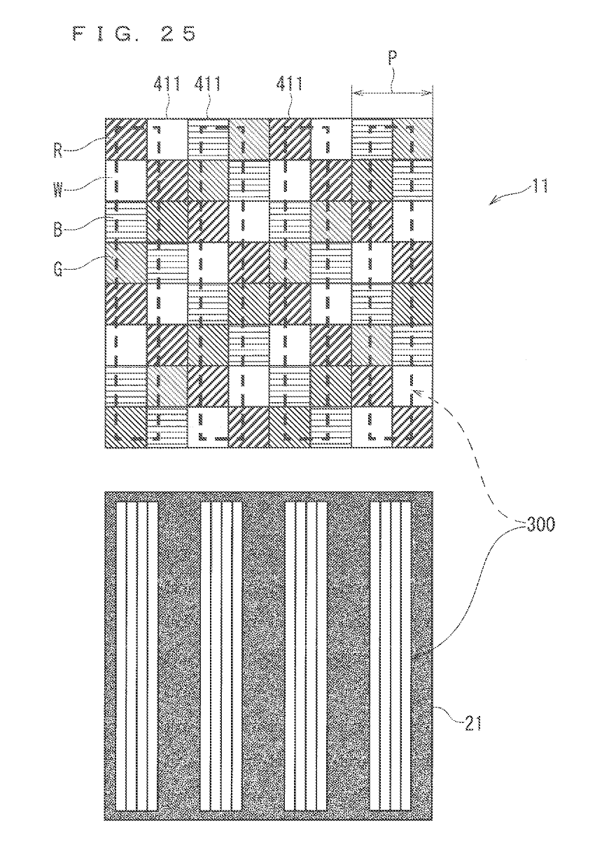

FIG. 25 is a partial plan view illustrating a state of arrangement of the sub-pixels 411 in the display panel 11 with respect to the integrated openings 300 in the parallax barrier shutter panel 21 in the naked-eye stereoscopic image display panel according to the second prerequisite technique. In the drawing, the pixels in the display panels 11 are configured by sub-pixels 411 of a first primary color (white; W), a second primary color (green; G), a third primary color (red; R), and a fourth primary color (blue; B) in order of brightness. Here, each sub-pixel 411 has the same width. It is assumed that, when combined with the longitudinally striped integrated openings 300 in the parallax barrier shutter panel 21, the first and third columns of pixels are observed from the first observation direction, and the second and fourth columns of pixels are observed from the second observation direction. The sub-pixels 411 to which either the first primary color (W) or the second primary color (G) is allocated in the first column and the sub-pixels 411 to which either the second primary color (G) or the first primary color (W) are assigned in the third column are arranged in the same row. Also, the sub-pixels 411 to which either the first primary color (W) or the second primary color (G) are allocated in the second column and the sub-pixels 411 to which either the second primary color (G) or the first primary color (W) are allocated in the fourth column are arranged in the same row. Then, the sub-pixels of, for example, the first primary color (white; W), are diagonally aligned, spanning the first to fourth columns.

Here, the plurality of first transparent electrodes 23 is divided into even numbers N (N=8) within the lateral reference parallax barrier pitch P that corresponds to two sub-pixels 411. Also, the number of pieces of wiring that form an integrated opening 300 is assumed to be N/2 (here, four), and the positions of the integrated openings 300 in the parallax barrier shutter panel 21 are formed in a longitudinal stripe shape.

With this pixel configuration in the display panel 11, even if the integrated openings 300 in the parallax barrier shutter panel 21 are aligned in a longitudinal stripe shape, it is possible to suppress deterioration in the sense of resolution of a stereoscopic image during monochrome display. Also, in the case where the parallax barrier shutter panel 21 is set to a full light transmission state, it is possible to provide a two-dimensional image with a smooth sense of resolution.

Description of Operations of Parallax Barrier Shutter Panel Depending on Observer's Position

FIG. 26A is a schematic diagram illustrating a state in which the boundaries of light emitted from the sub-pixels 411a and 411b constituting a sub-pixel pair 41 in the display panel 11 extend from each position on the screen to the space in front of the screen according to Example 1 of the second prerequisite technique. FIG. 26B is an enlarged view of a portion enclosed by an ellipse indicated by the dashed dotted line illustrated at the right end of the naked-eye stereoscopic image display panel in FIG. 26A, and is a partial cross-sectional view for describing the amount of displacement between the sub-pixel pair 41 and the integrated opening 300 in the parallax barrier shutter panel 21, the amount of displacement determining the direction of radiation of a virtual light beam. The light beams virtually emitted from the centers of the light shielding barriers 18 between the sub-pixels 411a and 411b conform to the above-described boundaries. In the upper section in FIG. 26A, boundary lines (virtual light beams) are indicated by arrows, using six points aligned in the lateral direction (left-right direction in the drawing), as an example, on the display surface of the naked-eye stereoscopic image display panel. Moreover, the lower section in FIG. 26A illustrates a plan view that shows the operating state on the entire surface of the parallax barrier shutter panel 21. FIG. 26B illustrates that the direction of radiation of a virtual light beam is determined by the amount of displacement between the sub-pixel pair 41 and the integrated opening 300 in the parallax barrier shutter panel 21. With reference to these drawings, control of the parallax barrier shutter panel 21 performed by the display device according to the second prerequisite technique of the present invention will be described.

Boundary lines LOA indicated by solid lines in FIG. 26A correspond to virtual light beams when a voltage with the same voltage pattern No. 3 is applied to a group of electrodes in all the common drive areas 251 of the parallax barrier shutter panel 21. The display surface of the parallax barrier shutter panel 21 includes a plurality of common drive areas 251, and in the operating state illustrated in FIG. 26A, a voltage with the same voltage pattern is applied to a group of electrodes in all of the common drive areas 251. Accordingly, a single common barrier mode area 260 is formed in FIG. 26A. That is, there are no barrier mode shift boundaries 270, which are boundaries between the common barrier mode areas 260. The display device is configured such that, when the voltage pattern No. 1 is applied as described above, virtual light beams that correspond to the boundary lines LOA between each common drive area 251 converge to a light converging point 3 in front of the center of the screen. This is implemented by setting the amount of optimum displacement Z to be provided between the center position of the light shielding barrier 18 between the sub-pixels 411a and 411b of the sub-pixel pair 41 and the center position of the integrated opening 300 in accordance with Equation (1) below with respect to a distance X from the center in the lateral direction (left-right direction in the drawing) of the display panel 11.

Z=X·T/(D·n) (1)

Here, T is the distance between the aperture plane of the display panel 11 and the aperture plane of the parallax harder shutter panel 21, n is the refractive index of a medium therebetween, and D is the designed observation distance.

When the display panel 11 has a pitch Po of the sub-pixel pairs, the reference parallax barrier pitch P of the parallax barrier shutter panel 21 is set to a value expressed by Equation (2) below.

P=P₀·{1−T/(D·n)} (²)

Boundary lines LOB indicated by broken lines in FIG. 26A represent boundary lines in the case where a voltage with the aforementioned voltage pattern No. 5 is applied to the group of electrodes in all or the common drive areas 251 of the parallax barrier shutter panel 21. In this case, virtual light beams that correspond to the boundary lines LOB between each common drive area 251 converge to a light converging point 5. Similarly, in the cases where a voltage with the voltage pattern No. 1, a voltage with the voltage pattern No. 2, and a voltage with the voltage pattern No. 4 are each applied to the group of electrodes in the common drive areas 251, virtual light beams corresponding to the boundary lines between each common drive area 251 converge respectively to light converging points 1, 2, and 4.

According to the second prerequisite technique of the present invention, the controller 32 (FIG. 1) is configured to determine the positions of the integrated openings 300 in the parallax barrier shutter panel 21 for each common drive area 251 on the basis of the result of detection by the detector 31. Specifically, in the case where it has been determined on the basis of the detection result of the detector 31 that the position of the observer is close to the designed observation distance D, the controller 32 controls the parallax barrier shutter panel 21 such that the virtual light beams corresponding to the boundary lines between each common drive area 251 converge to only one of the light converging points 1 to 5. Accordingly, the light emitted from the sub-pixels 411a for left eyes at all positions on the screen of the, display panel 11 is applied to the left eye of the observer, and the light emitted from the sub-pixels 411b for right eyes at all positions is applied to the right eye of the observer. Thus, the observer is able to visually recognize a stereoscopic image on the entire screen. At this time, the entire screen is a single common barrier mode area 260 because a voltage with the same voltage pattern is applied to the group of electrodes in all of the common drive areas 251 of the parallax barrier shutter panel 21.

Specifically, in the case where the position of the observer is at an observation point A (FIG. 26A) that is separated by the designed observation distance D from the naked-eye stereoscopic image display panel in a front direction of the screen, a voltage with the voltage pattern No. 3 is applied to the group of electrodes in each common drive area 251 so that the virtual light beams corresponding to the boundary lines between each common drive area 251 converge to the light converging point 3 located between the left and right eyes of the observer. In this state, when the observer has moved to an observation point B (FIG. 26A) at which one of the eyes of the observer is located at the light converging point 3, a voltage with the voltage pattern No. 5 is applied to the group of electrodes in each common drive area 251 so that the virtual light beams corresponding to the boundary lines between each common drive 251 converge to the light converging point 5 located between the left and right eyes of the observer.

The display device according to the second prerequisite technique of the present invention, which perform operations as described above, causes the aforementioned boundary lines to converge to a single point between the left and right eyes. Thus, even if the observer has moved in the left-right direction, the observer is able to observe an excellent stereoscopic image on the entire screen. In general, significant 3D crosstalk and a significant change in luminance occur in the vicinity of the boundary lines, and therefore the point to which the boundary lines converge is desirably in the vicinity of the center of the left and right eyes of the observer.

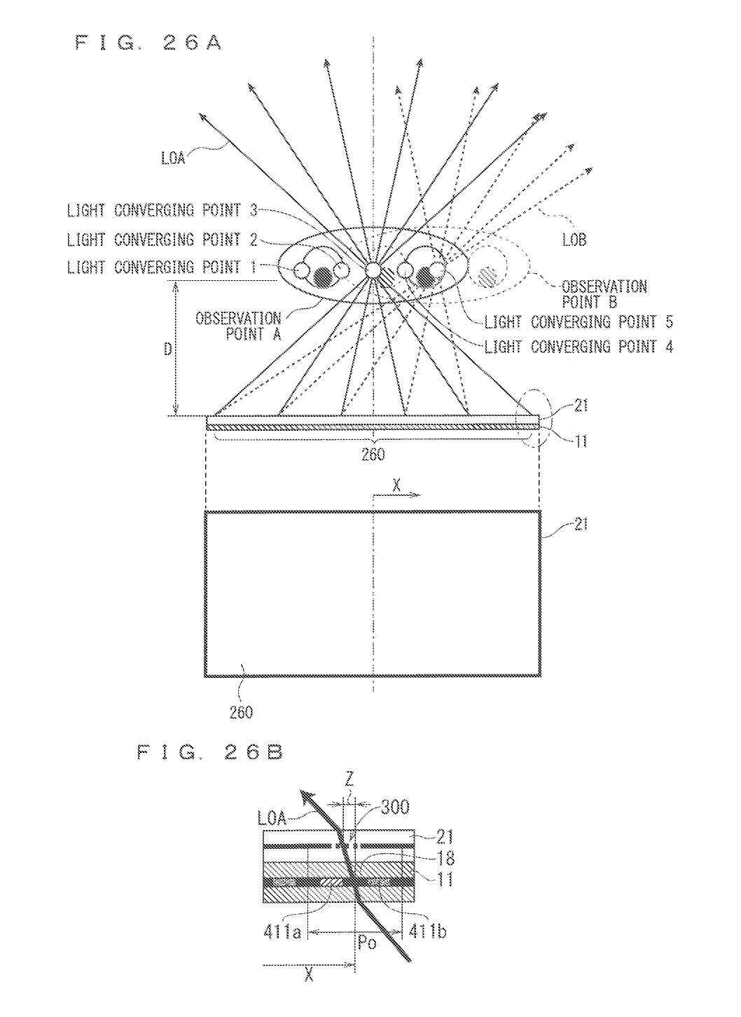

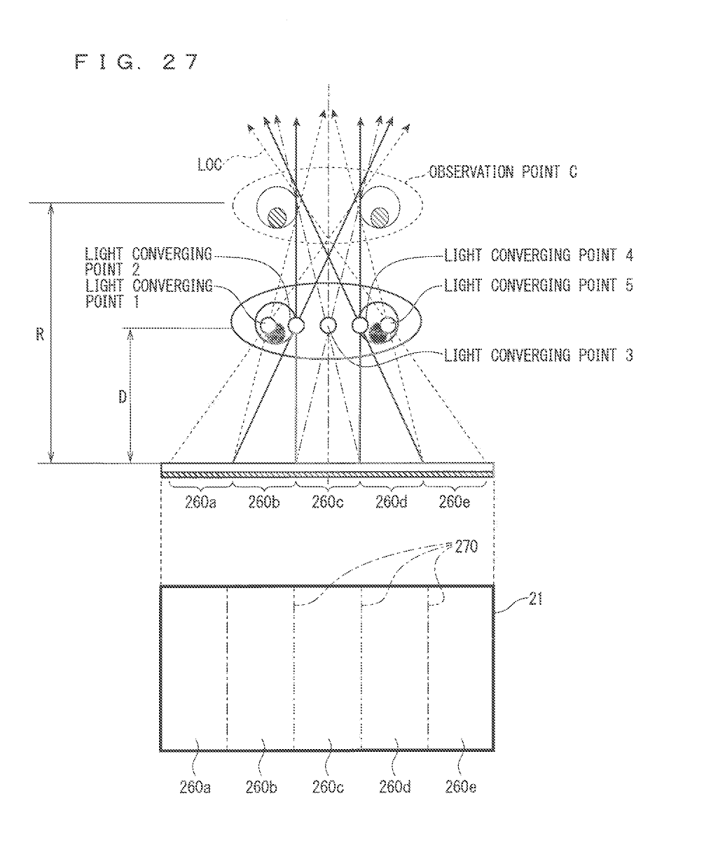

Similarly to FIG. 26A, FIG. 27 is a schematic diagram illustrating boundary lines that conform to virtual light beams in the case where light is virtually emitted from the centers of the light shielding barriers 18 between the sub-pixels 411a and 411b that constitute the sub-pixel pairs 41. FIG. 27 illustrates the boundary lines in the case where the position of the observer is at an observation point C that is separated by an actual observation distance R, which is longer than the designed observation distance D, from the naked-eye stereoscopic image display panel. In particular, boundary lines LOC indicated by broken lines are boundary lines that correspond to around the ends of the display surface of the naked-eye stereoscopic image display panel, and arrows indicated by dashed dotted lines are boundary lines corresponding to around the center of the display surface of the naked-eye stereoscopic image display panel.

The controller 32 according to the second prerequisite technique of the present invention is configured to control the parallax barrier shutter panel 21 such that, when it has been determined on the basis of the detection result of the detector 31 that the position of the observer is farther than the designed observation distance D, virtual light beams corresponding to the boundary lines from each common drive area 251 converge to different light converging points 1 to 5 for each position on the display screen.

Specifically, in the case where the position of the observer is at the observation point C (FIG. 22), five common barrier mode areas 260a to 260e are formed. The controller 32 applies a voltage with the voltage pattern No. 3 to a group of electrodes in the common drive areas 251 within the common barrier mode area 260c located in the center so as to cause the virtual light beams corresponding to the boundary lines from each common drive area 251 to converge to the light converging point 3. Also, the controller 32 applies a voltage with the voltage pattern No. 1 to a group of electrodes in the common drive areas 251 within the leftmost common barrier mode area 260a so as to cause the virtual light beams corresponding to the boundary lines from each common drive area 251 to converge to the light converging point 1. Hereinafter, in the same manner, the virtual light beams corresponding to the boundary lines from each common drive area 251 within the other common barrier mode areas 260b, 260d, and 260e are caused to converge respectively to the light converging points 2, 4, and 5.

Here, the virtual light beams that correspond to each boundary line and that have converged to the light converging points 1 to 5 spread again from a position farther from the designed observation distance D, but all of these virtual light beams pass between the left and right eyes of the observer whose position is at the observation point C. Thus, even if the position of the observer is farther than the designed observation distance D, the left and right eyes can respectively visually recognize left and right eye images. Accordingly, the observer is able to observe an excellent stereoscopic image on the entire screen.

Next, a method of determining the positions of the barrier mode shift boundaries 270 between the common barrier mode areas 260 will be described.

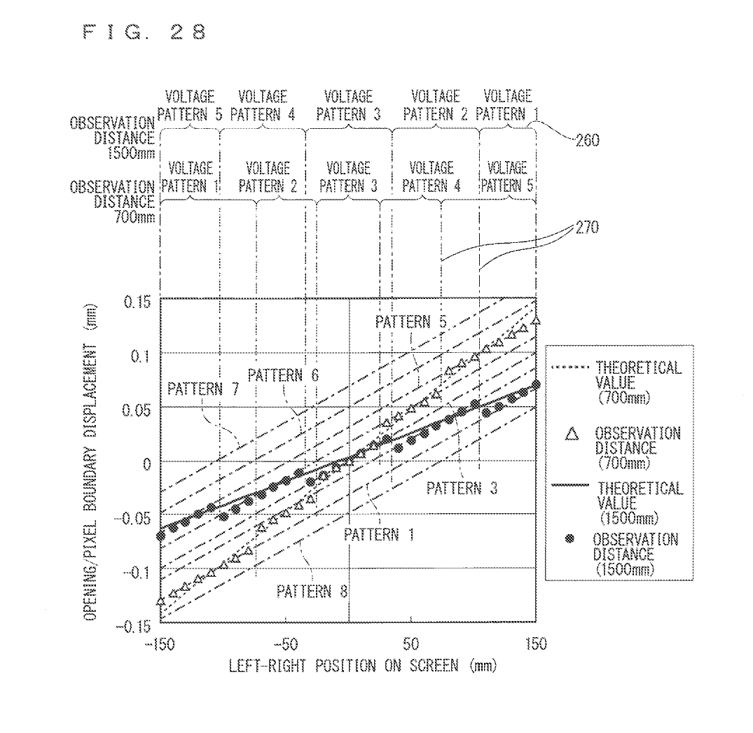

FIG. 28 illustrates the result of calculating the amount of optimum displacement (also referred to as “opening/pixel boundary displacement”) to be provided between the center position of the light shielding barrier 18 between the sub-pixel 411a and 411b constituting a sub-pixel pair 41 and the center position of an integrated opening 300 in order to allow the virtual light beams corresponding to the boundary lines from the entire screen to converge to a single point between the left and right eyes of the observer. It is assumed here that the screen width of the display panel 11 is 300 mm, the pitch of the sub-pixel pairs 41 is 0.100 mm, the number of divisions N of the reference parallax barrier pitch P of the parallax barrier shutter panel 21 is 8, and the sub-opening pitch ΔSW is 0.0125 mm. Note that the designed observation distance D is 1000 mm, the distance T between the aperture plane of the display panel 11 and the aperture plane of the parallax barrier shutter panel 21 is 1.0 mm, and the refractive index n is 1.5, which corresponds to the refractive index of typical glass.

In the present example, the designed observation distance D is assumed to be 1000 mm. In particular, in the case of applying the voltage pattern No. 3, display is optimized when the observer is the designed observation distance D of 1000 mm away from the screen in the front direction of the screen. Thus, in the drawing, the dashed dotted line indicating the pattern 3 conforms to the relationship between the left-right position on the screen and the above-described amount of optimum displacement in the case where the position of the observer is at a position along the front direction of the screen when the designed observation distance D is 1000 mm. This dashed dotted line is an upward right straight line as expressed by Equation (1). According to Example 1 of the second prerequisite technique of the present invention, since the parallax barrier shutter panel 21 is assumed to be placed on the observer side of the display panel 11, the reference parallax barrier pitch P is smaller by a ratio of 149.9/150 than the pitch Po of the sub-pixel pairs 412 as expressed by Equation (2).

In the drawing, the eight dashed dotted lines respectively indicate the amount of displacement between the center position of a sub-pixel pair 41 and the center position of an integrated opening 300, implemented on the display surface in the cases where the voltage pattern applied to the common drive areas 251 is set to the voltage patterns No. 1 to No. 8 illustrated in FIG. 22. Since the reference parallax barrier pitch P of the parallax barrier shutter panel 21 is designed using the designed observation distance D of 1000 mm, the dashed dotted lines have the same degree of slope. By changing the voltage pattern applied to the common drive areas 251, the amount of displacement can vary with a pitch equivalent to the sub-opening pitch ΔSW of the sub-openings 210. Here, the sub-opening pitch ΔSW is 0.0125 mm. When the observer has moved to the right from the front of the screen at the designed observation distance of 1000 mm, the line indicating the amount of optimum displacement also moves in parallel in the right direction. In response, if the voltage pattern applied to the common drive areas 251 is appropriately changed, this amount of optimum displacement can be approximated by the variation width of 0.0125 mm of the sub-opening pitch ΔSW. At this time, an approximation error on the entire screen can be confined within 0.00625 mm, which is a half of ΔSW.

Also, theoretical values of the amount of optimum displacement at the left-right position on the screen for the cases where the observation distance of the observer is 700 mm and 1500 mm are respectively indicated by broken lines and solid lines in the drawing. The amount of optimum displacement depends on the designed observation distance D as expressed by Equation (1). Thus, the slopes of the straight lines indicating the amount of optimum displacement differs from the slope for the case where the observation distance is 1000 mm. In the drawing, plots indicated respectively by triangles and circles indicate a state in which different voltage patterns are applied to a plurality of common barrier mode areas 260 in order to optimize the display of the display device, which is designed using the designed observation distance D of 1000 mm, for the observation distances of 700 mm and 1500 mm.

In the case where the observation distance is 1500 mm, the graph (solid line in the drawing) that shows the result of calculating the amount of optimum displacement is a straight line having a gradient smaller than that in the case where the observation distance is 1000 mm, i.e., corresponds to the designed observation distance D. In order to implement display with characteristics close to those of the above-described graph by using the display device adopting the designed observation distance D of 1000 mm, the screen is divided into five common barrier mode areas 260 in the left-right direction, and five different types of voltage patterns are respectively applied to the five common barrier mode areas 260. Here, in each common barrier mode area 260, a voltage pattern that produces the amount of displacement closest to the amount of optimum displacement at a position in the common barrier mode area is selected. Thus, the positions of the barrier mode shift boundaries 270 are assumed to be at positions at which the difference between the amount of optimum displacement with respect to the observation distance at that position and the amount of displacement that can be implemented artificially is a half of the sub-opening pitch ΔSW. Accordingly, the difference between the amount of optimum displacement and the amount of actual displacement on the entire display surface can be reduced to less than or equal to the half of the sub-opening pitch ΔSW. In the case where the observation distance is 700 mm, the graph (broken line in the drawing) that shows the result of calculating the amount of optimum displacement is a straight line having a gradient greater than that in the case where the observation distance is 1000 mm, i.e., corresponds to the designed observation distance D. In order to obtain characteristics that conform approximately to this straight line, the screen is divided into five common barrier mode areas 260, and five different types of voltage patterns are applied to these five common barrier mode areas.

However, in the case where the number M of first transparent electrodes 23 that are electrically connected to one another via the common wiring 201 and the contact holes 202 is large, i.e., in the case where the common drive areas 251 have a large width, the difference between the amount of optimum displacement and the amount of actual displacement may become greater than the half of the sub-opening pitch ΔSW. Accordingly, the width of the common drive areas 251 is desirably as small as possible from the viewpoint of the above-described approximation accuracy.

Next, description is given regarding a voltage pattern applied to the first transparent electrodes 23 in the common drive areas 251 M the vicinity of the barrier mode shift boundaries 270. In the present example, the parallax barrier shutter panel 21 is installed on the observer side of the display panel 11 as described previously. In this case, the ideal parallax barrier pitch is designed to be slightly smaller than the pitch of the sub-pixel pairs 41, as expressed by Equation (2). As the observation distance increases, the ideal parallax barrier pitch increases and approaches the pitch of the sub-pixel pairs 41. Thus, in the case where the actual observation distance is greater than the designed observation distance D, the gradient of the graph showing the result of calculating the amount of optimum displacement is smaller than that of the graph showing the calculation result for the case of the designed observation distance D as illustrated in FIG. 28. In contrast, as the observation distance decreases, the ideal parallax barrier pitch decreases, and the difference with the pitch of the sub-pixel pairs 41 increases. Thus, in the case where the actual observation distance is smaller than the designed observation distance D, the gradient of the graph showing the result of calculating the amount of optimum displacement is greater than that of the graph showing the calculation result for the case of the designed observation distance D as illustrated in FIG. 28.

That is, in the case where the actual observation distance is greater than the designed observation distance D, a local parallax barrier pitch that is the sum of the number of sub-openings 210 in the light transmission state and the number of sub-openings 210 in the light shielding state needs to be increased at the barrier mode shift boundaries 270 by an amount equivalent to one sub-opening 210 in order to increase the average parallax barrier pitch on the display surface. In contrast, in the case where the actual observation distance is smaller than the designed observation distance D, the aforementioned local parallax barrier pitch needs to be reduced in order to reduce the average parallax barrier pitch on the display surface.

A specific method of driving the parallax barrier shutter panel 21 will be described.

First, in the case where the actual observation distance is greater than the designed observation distance D, as described previously, it is necessary to increase the local parallax barrier pitch, which is the sum of the number of sub-openings 210 in the light transmission state and the number of sub-openings 210 in the light shielding state, at the barrier mode shift, boundaries 270 by an amount equivalent to one sub-opening pitch ΔSW in order to increase the average parallax barrier pitch on the display surface. Examples of conceivable methods for implementing this include a method of increasing the number of sub-openings 210 in the light transmission state without changing the number of sub-openings 210 in the light shielding state and a method of increasing the number of sub-openings 210 in the light shielding state without increasing the number of sub-openings 210 in the light transmission state. As will be described later, the method of increasing the number of sub-openings 210 in the light shielding state without changing the number of sub-openings 210 in the light transmission state is more suitable because it has the effect that the observer is less likely to perceive luminance flicker when moving left and right.

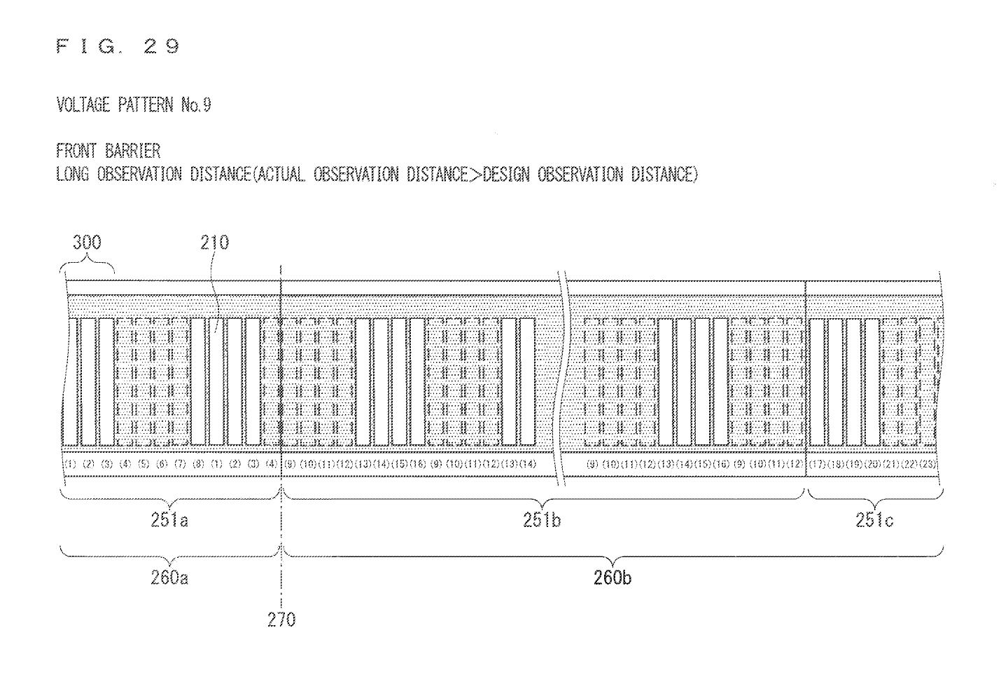

FIG. 29 illustrates the arrangement of the integrated openings 300 formed depending on the application of voltage to the first transparent electrodes 23 in the vicinity of a barrier mode shift boundary 270 when the actual observation distance is greater than the designed observation distance (in the case of a long observation distance). This arrangement is obtained by application of the voltage pattern No. 9 (FIG. 22). The term “front barrier” in the drawing indicates that the parallax barrier shutter panel 21 is disposed in front of the display panel 11 as in the present example. Here, five first transparent electrodes 23 to which a plus voltage (corresponding to the light shielding state) is applied are disposed at the boundary part between the first common drive area 251a and the second common drive area 251b. In the other area, the pitch consisting of four first transparent electrodes 23 corresponding to the light transmission state and four first transparent electrodes 23 corresponding to the light shielding state is maintained. Thus, the interval between the integrated openings 300 at the boundary part between the first common drive area 251a and the second common drive area 251b is increased by an amount equivalent to one first transparent electrode 23. That is, a barrier mode shift boundary 270 is formed at the boundary part between the first common drive area 251a and the second common drive area 251b. Also, at the barrier mode shift boundary 270, the local parallax barrier pitch, which is the sum of the number of sub-openings 210 in the light transmission state and the number of sub-openings 210 in the light shielding state, is increased by an amount equivalent to one first transparent electrode 23 (amount equivalent to one sub-opening pitch ΔSW) by increasing the number of sub-openings 210 in the light shielding state without changing the number of sub-openings 210 in the light transmission state. In other words, a parallax barrier pitch that is the sum of the number of sub-openings 210 in the light transmission state and the number of sub-openings 210 in the light shielding state is increased locally at the barrier mode shift boundary 270 by an amount equivalent to one first transparent electrode 23. Referring to the row of the voltage pattern No. 9 in the graph in FIG. 22, the common barrier mode areas 260 that are divided by the barrier mode shift boundary 270 (FIG. 29) and in which the pitch of the integrated openings 300 (FIG. 29) is maintained are indicated by broken-line rectangles.

Also, in the state of the voltage pattern No. 10 (FIG. 22), the integrated openings 300 in the parallax barrier shutter panel 21 are shifted to the right in response to the observer moving in the right direction while maintaining the aforementioned long observation distance. Here, a plus voltage (corresponding to the light shielding state) is applied to five first transparent electrodes 23 not at the boundary part between the first common drive area 251a and the second common drive area 251b but at the boundary part between the second common drive area 251b and the third common drive area 251c. In the other area, the pitch consisting of four first transparent electrodes 23 corresponding to the light transmission state and four first transparent electrodes 23 corresponding to the light shielding state is maintained. Thus, the interval of the integrated openings 300 at the boundary part between the second common drive area 251b and the third common drive area 251c is increased by an amount equivalent to one first transparent electrode 23. That is, a barrier mode shift boundary 270 is formed at the boundary part between the second common drive area 251b and the third common drive area 251c, and the local parallax barrier pitch, which is the sum of the number of sub-openings 210 in the light transmission state and the number of sub-openings 210 in the light shielding state, is increased by an amount equivalent to one first transparent electrode 23 by increasing the number of sub-openings 210 in the light shielding state without changing the number of sub-openings 210 in the light transmission state.

The state of the voltage pattern No. 11 (FIG. 22) is similar to the state of the voltage pattern No. 10, with the exception that the integrated openings 300 are shifted in the right direction by an amount equivalent to one first transparent electrode 23 from the state of the voltage pattern 10. Thus, in each of the common barrier mode areas 260 on both side of the barrier mode shift boundary 270, the integrated openings 300 can be shifted in the right direction by an amount equivalent to the pitch of the first transparent electrodes 23 while maintaining their equal width and pitch, in response to the observer moving in the right direction.

The above-described operations are made implementable by the configuration in which N·M+N/2 first transparent electrodes 23 are disposed in each common drive area 251. Here, N is an even number that corresponds to the number of first transparent electrodes 23 within the reference parallax barrier pitch P, and M is an arbitrary positive integer. With this configuration, in the case where the display device is driven with the number of first transparent electrodes 23 in the light transmission state and the number of first transparent electrodes 23 in the light shielding state being equally N/2, the phases of the integrated openings 300 are shifted by a half cycle at the left and right ends of the common drive areas 251. For this reason, a first transparent electrode 23 corresponding to the light shielding state always appear at either of the ends. Thus, the number of first transparent electrodes 23 corresponding to the light shielding state can be increased by one at either of the left and right ends of the common drive areas 251. Accordingly, either of the left and right ends of the common drive areas 251 becomes a barrier mode shift boundary 270.

Here, the voltage applied to each terminal La of the stereoscopic image display device with the configuration in FIG. 21 will be described in detail with reference to FIG. 29. In FIG. 29, the barrier mode shift boundary 270 is formed at the boundary part between the first common drive area 251a and the second common drive area 251b. Thus, the phases of the integrated openings 300 are shifted by an amount equivalent to one sub-opening at the left and right ends of the barrier mode shift boundary 270. On the other hand, the phases of the integrated openings 300 are kept constant within each common barrier mode area 260. However, in the stereoscopic image display device with the configuration in FIG. 21, N·M+N/2 first transparent electrodes 23 included in each common drive area 251 are electrically connected to one another at an interval of N first transparent electrodes 23. Thus, in order to keep the phases of the integrated openings 300 constant within the common barrier mode areas 260, the order in which voltages are applied needs to be changed by an amount equivalent to N/2 terminals between adjacent common drive areas 251. Specifically, a plus voltage is applied to the terminals La9 to La12 in the second common drive area 251b, a null voltage is applied to the terminals La13 to La16 therein, a null voltage is applied to the terminals La17 to La20 in the third common drive area 251c, and a plus voltage is applied to the terminals La21 to La24 therein. That is, the order in which voltages are applied is shifted by N/2 between adjacent common drive areas 251. This makes constant the phases of the integrated openings 300 within the common barrier mode areas 260.

On the other hand, in the case where the actual observation distance is smaller than the designed observation distance D (in the case of a short observation distance), as described previously, it is necessary to reduce the local parallax barrier pitch, which is the sum of the number of sub-openings 210 in the light transmission state and the number of sub-openings 210 in the light shielding state, at the barrier triode shift boundaries 270 by an amount equivalent to one sub-opening pitch ΔSW in order to reduce the average parallax barrier pitch on the display surface. Examples of conceivable methods for implementing this include a method of reducing the number of sub-openings 210 in the light transmission state without changing the number of sub-openings 210 in the light shielding state and a method of reducing the number of sub-openings 210 in the light shielding state without reducing the number of sub-openings 210 in the light transmission state. However, as will be described below, the method of reducing the number of sub-openings 210 in the light transmission state without changing the number of sub-openings 210 in the light shielding state is more suitable because it has the effect that the observer is less likely to perceive luminance flicker, which is visually recognized as emission lines or dark lines, at barrier mode shift boundaries 270.

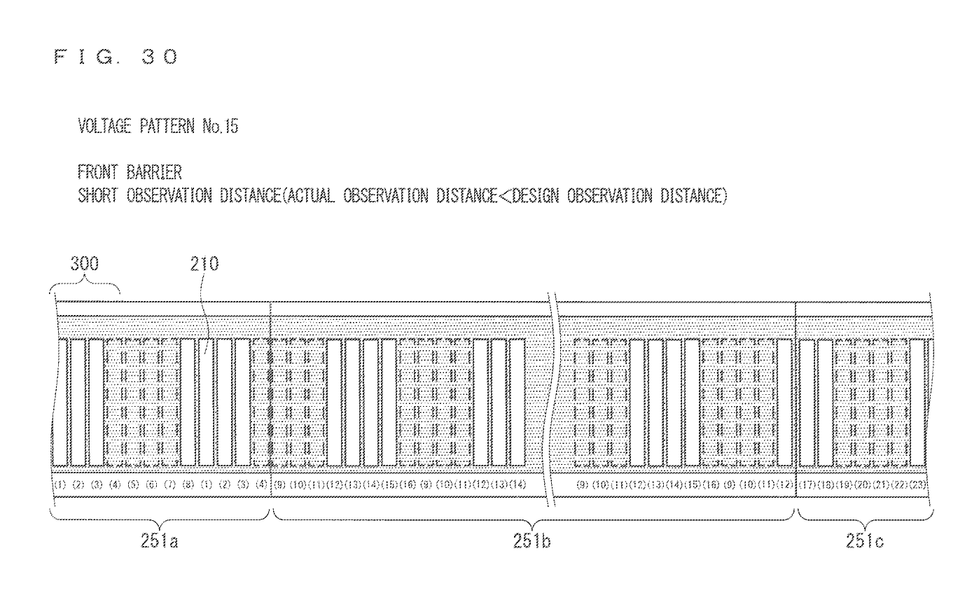

FIG. 30 illustrates the arrangement of the integrated opening 300 formed depending on the application of voltage to the first transparent electrodes 23 in the vicinity of a barrier mode shift boundary 270 in the case where the actual observation distance is smaller than the designed observation distance (in the case of a short observation distance). This arrangement is obtained by application of the voltage pattern No. 15 (FIG. 22). Here, three first transparent electrodes 23 to which a null voltage (corresponding to the light transmission state) is applied are disposed at the boundary part between the second common drive area 251b and the third common drive area 251c. In the other areas, the pitch consisting of four first transparent electrodes 23 corresponding to the light transmission state and four first transparent electrodes 23 corresponding to the light shielding state is maintained. Thus, the barrier mode shift boundary 270 is formed at the boundary part between the second common drive area 251b and the third common drive area 251c. Then, at the barrier mode shift boundary 270, the local parallax barrier pitch, which is the sum of the number of sub-openings 210 in the light transmission state and the number of sub-openings 210 in the light shielding state, is reduced by an amount equivalent to one sub-opening pitch ΔSW (amount equivalent to one first transparent electrode 23) by reducing the number of sub-openings 210 in the light transmission state without changing the number of sub-openings 210 in the light shielding state. In other words, a parallax barrier pitch that is the sum of the number of sub-openings 210 in the light transmission state and the number of sub-openings 210 in the light shielding state is reduced locally at the barrier mode shift boundary 270 by an amount equivalent to one first transparent electrode 23.

Also, in the state of the voltage pattern No. 16 (FIG. 22), the integrated openings 300 in the parallax barrier shutter panel 21 are shifted to the right in response to the observer moving in the right direction while maintaining the aforementioned short observation distance. Also in this case, three first transparent electrodes 23 that corresponds to the light transmission state and to which a null voltage is applied are disposed at the boundary part between the second common drive area 251b and the third common drive area 251c. In the other area, the pitch consisting of four first transparent electrodes 23 corresponding to the light transmission state and four first transparent electrodes 23 corresponding to the light shielding state is maintained. Thus, a barrier mode shift boundary 270 is formed at the boundary part between the second common drive area 251b and the third common drive area 251c. Then, at the barrier mode shift boundary 270, the local parallax barrier pitch, which is the sum of the number of sub-openings 210 in the light transmission state and the number of sub-openings 210 in the light shielding state, is reduced by an amount equivalent to one sub-opening pitch ΔSW by reducing the number of sub-openings 210 in the light transmission state without changing the number of sub-openings 210 in the light shielding state.

Moreover, in the state of the voltage pattern No. 17 (FIG. 22), three first transparent electrodes 23 to which a null voltage (corresponding to the light transmission state) is applied are disposed at the boundary part between the first common drive area 251a and the second common drive area 251b. In the other area, the pitch consisting of four first transparent electrodes 23 corresponding to the light transmission state and four first transparent electrodes 23 corresponding to the light shielding state is maintained. Thus, a barrier mode shift boundary 270 is formed at the boundary part between the first common drive area 251a and the second common drive area 251b. Then, at the barrier mode shift boundary 270, the local parallax barrier pitch, which is the sum of the number of sub-openings 210 in the light transmission state and the number of sub-openings 210 in the light shielding state, is reduced by an amount equivalent to one sub-opening pitch ΔSW by reducing the number of sub-openings 210 in the light transmission state without changing the number of sub-openings 210 in the light shielding state.

In this way, even in the case where the actual observation distance is smaller than the designed observation distance D, within each of the common barrier mode areas 260 on both sides of the barrier mode shift boundary 270, the integrated openings 300 can be shifted in the right direction by an amount equivalent to the pitch of the first transparent electrodes 23 while maintaining their equal width and pitch, in response to the observer moving in the right direction.

The above-described operations are made implementable by the configuration in which N·M+N/2 first transparent electrodes 23 are disposed in each common drive area 251. Here, N is an even number that corresponds to the number of first transparent electrodes 23 within the reference parallax barrier pitch P, and M is an arbitrary positive integer. With this configuration, in the case where the display device is driven with the number of first transparent electrodes 23 in the light transmission state and the number of first transparent electrodes 23 in the light shielding state being equally N/2, the phases of the integrated openings 300 are shifted by a half cycle at the left and right ends of the common drive areas 251. For this reason, a first transparent electrode 23 corresponding the light shielding state always appears at either of the ends. Thus, the number of first transparent electrodes 23 corresponding to the light transmission state can be reduced by one at either of the left and right ends of the common drive areas 251. Accordingly, either of the left and right ends of the common drive areas 251 becomes a barrier mode shift boundary 270.

While the descriptions provided thus far have discussed a configuration in which N·M+N/2 first transparent electrodes 23 are disposed in all of the common drive areas 251, the present invention is not limited to this, and a configuration is also possible in which N·M first transparent electrodes 23 are disposed in some of the common drive areas 251. In that case, the common drive areas 251 in which N·M first transparent electrodes 23 are disposed will no longer be used to set the barrier mode shift boundaries 270, but this influence can be minimized by reducing the number of such common drive areas.

Relationship Between Luminous Intensity Distribution Characteristics and Widths of Integrated Openings and Integrated Light Shielding Parts

The following description is given regarding luminous intensity distribution characteristics in the case of changing the number of sub-openings in the light shielding state and the number of sub-openings in the light transmission state at the barrier mode shift boundaries 270.

Here, assume a model configured by the sub-pixels 411 in the display panel 11 and the integrated openings 300 in the parallax barrier shutter panel 21 as illustrated in FIG. 31. Then, luminous intensity distribution characteristics are calculated using geometrical optics. In the drawing, the center position of the light shielding barrier 18 between left and right sub-pixels 411a and 411b and the center position of an integrated opening 300a correspond to each other. Also, an integrated opening 300b is disposed on the left side of the integrated opening 300a, and an integrated opening 300c is disposed on the right side of the integrated opening 300a. It is assumed that the pitch of the sub-pixel pairs 41 (FIG. 1) is 0.12 mm, the distance between the aperture plane of the display panel 11 and the aperture plane of the parallax barrier shutter panel 21 is 1 mm, and the opening width of the sub-pixels is 0.03 mm. The designed observation distance D is 800 mm, and the number of sub-openings 210 within the reference parallax barrier pitch P is an even number N, where N=12. The number of sub-openings 210 in the light transmission state and the number of sub-openings 210 in the light shielding state in the parallax barrier shutter panel 21 are equally N/2=6, and the width of the integrated openings 300 is 50% of the reference parallax barrier pitch P. Note that six sub-openings 210 in the light shielding state form a single integrated light shielding part 330.

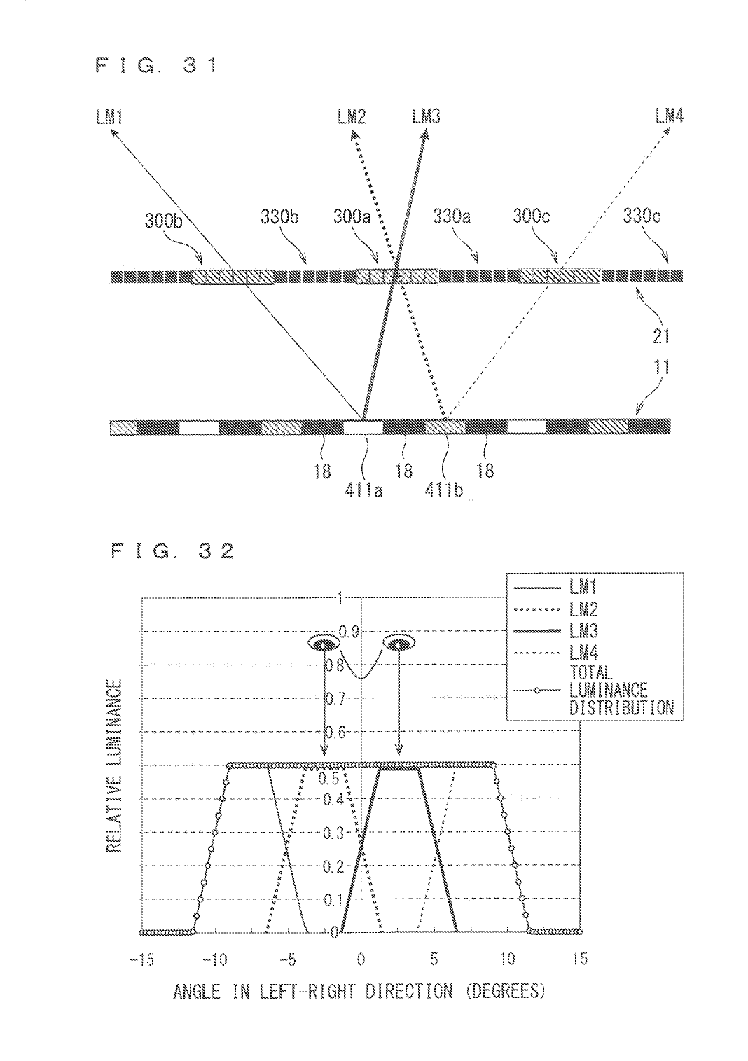

FIG. 32 illustrates the result of calculating the luminous intensity distribution characteristics in the case where the number of sub-openings 210 in the light transmission state and the number of sub-openings 210 in the light shielding state are each N/2=6. This is the case where no barrier mode shift boundaries 270 exist on the display surface, and corresponds to the case where the observation distance is equal to the designed observation distance D. The horizontal axis indicates the angle in the left-right direction when the front direction of the display surface is zero degrees, and the vertical axis indicates the relative luminance. As illustrated in FIG. 31, calculation is performed on four light beams LM1 to LM4 that are emitted from the left and right sub-pixels 411a and 411b and pass through the integrated opening 300a and the integrated openings 300b and 300c on both sides of the integrated opening 300a. This is because these four light beams travel in directions close to the observer. Here, the total luminance distribution for the case where the sub-pixel 411a and 411b are in a white display state is indicated by the solid line marked with a marker.

Here, if the intraocular distance of the observer is assumed to be 65 mm, the intraocular angle is 4.6 degrees. The left and right eyes are respectively located in the centers of the peaks of the luminous intensity distributions of the light beams LM2 and LM3 (FIG. 31). The total luminance distribution is completely flat over a wide angle range in the vicinity of the center of the horizontal axis. Thus, in the case where the observer has moved left and right with an observation distance of 800 mm, the observer does not perceive flicker caused by a change in luminance, which is visually recognized as emission lines or dark lines, at the barrier mode shift boundaries 270. Accordingly, setting the width of the integrated openings 300 in the parallax barrier shutter panel 21 to 50% of the reference parallax barrier pitch P is suited in order to prevent the observer who is moving in the lateral direction from perceiving luminance flicker, which is visually recognized as emission lines or dark lines, at the barrier mode shift boundaries 270. That is, it is desirable to set the number of first transparent electrodes 23 in the light transmission state and the number of first transparent electrodes 23 in the light shielding state to be equally N/2.

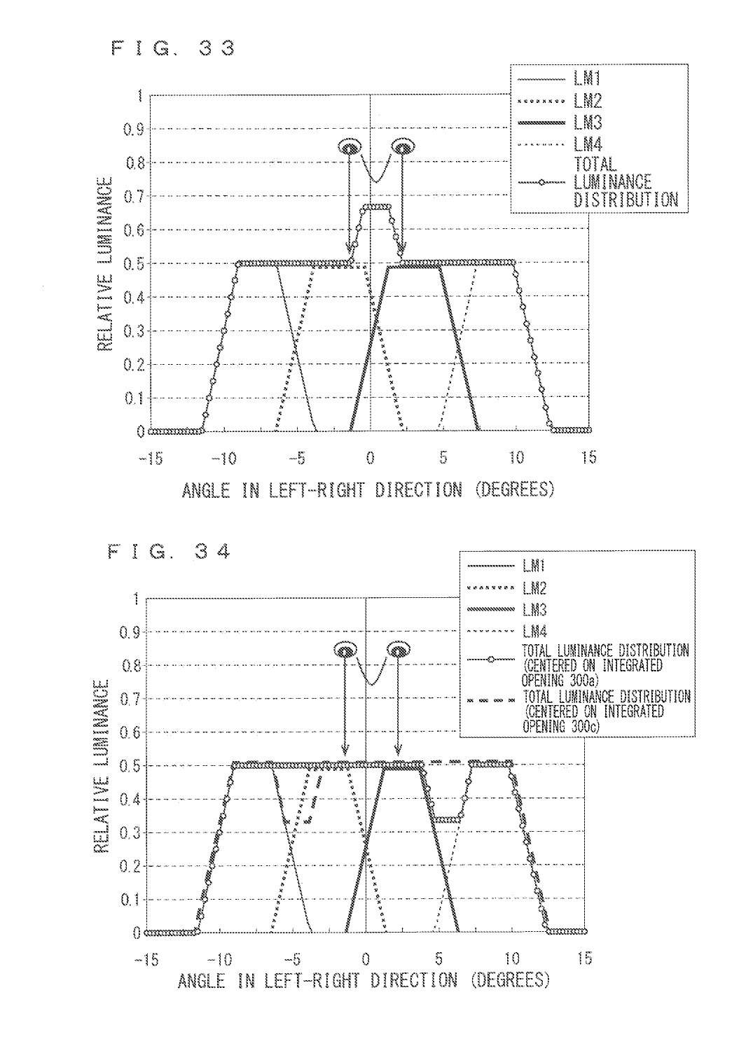

Next, consider a case where the actual observation distance is 1000 mm and greater than the designed observation distance D of 800 mm. In this case, it is necessary to increase the local parallax barrier pitch, which is the sum of the number of sub-openings 210 in the light transmission state and the number of sub-openings 210 in the light shielding state, at the barrier mode shift boundaries 270 by an amount equivalent to one sub-opening pitch ΔSW. FIG. 33 illustrates a case where the integrated opening 300a has a width equivalent to seven sub-openings 210, which is greater by an amount equivalent to one sub-opening 210 than in the model illustrated in FIG. 31. The width of the other integrated openings 300b and 300c and the width of the integrated light shielding parts 330a, 330b, and 330c remain unchanged at the width equivalent to six sub-openings 210. In this case, a mountain that represents luminance appears in the front direction. Here, if the intraocular distance of the observer is assumed to be 65 mm, the intraocular angle is 3.7 degrees and narrower than in the case of the designed observation distance. Since, as illustrated in FIG. 33, the intraocular angle is narrow as compared with the mountain representing luminance, there is the risk that even the observer's slight move in the left-right direction may cause the observer to perceive a change in luminance, which is visually recognized as emission lines at the barrier mode shift boundaries 270.

In contrast, FIG. 34 illustrates a case where the integrated light shielding part 330a has a width equivalent to seven sub-openings, which is greater by an amount equivalent to one sub-opening than in the model illustrated in FIG. 31, while the width of the integrated opening 300a remains unchanged at the width equivalent to six sub-openings 210. The width of the other integrated openings 300b and 300c and the width of the other integrated light shielding parts 330b and 330c remain unchanged at the width equivalent to six sub-openings 210. In this case, the luminance in the front direction is flat, and a valley that represents luminance appears at the right end. Note that the thick broken line in the drawing indicates the angular distribution of luminous intensity for the case where calculation is performed on three integrated openings 300 centered on the integrated opening 300c, and this distribution is bilaterally symmetrical with respect to the luminous intensity distribution centered on the integrated opening 300a. Either of the distributions shows that a region where the luminance is flat exists in the central part. Here, when the intraocular angle of the observer is taken into consideration, it is found that, even if the observer has moved to some extent in the left-right direction, the observer will not perceive a difference in luminance, which is visually recognized as dark lines, at the barrier mode shift boundaries 270. That is, since the intraocular angle of the observer decreases when the actual observation distance is greater than the designed observation distance D, increasing the number of sub-openings 210 in the integrated light shielding part 330 at the barrier mode shift boundaries 270, rather than increasing the number of sub-openings 210 in the integrated openings 300, is more effective to reduce the risk that the observer who is moving left and right may perceive a change in luminance, which is visually recognized as emission lines or dark lines at the bather mode shift boundaries 270.

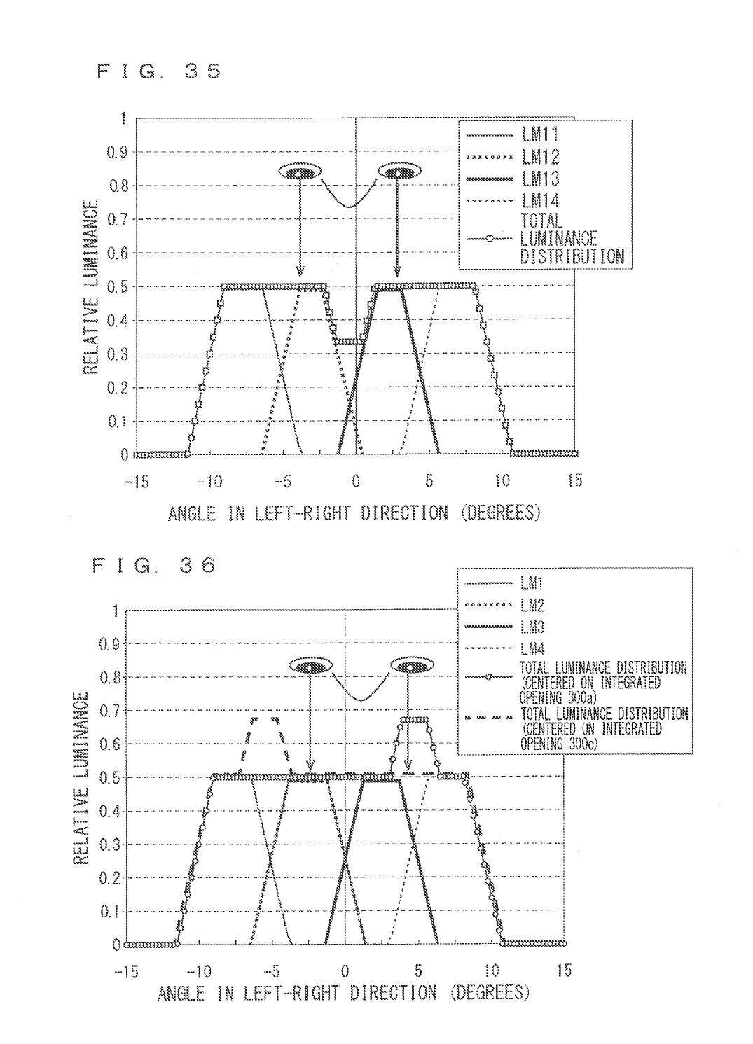

Next, consider a case where the actual observation distance is 600 mm and smaller than the designed observation distance D of 800 mm. In this case, it is necessary to reduce the local parallax barrier pitch, which is the sum of the number of sub-openings 210 in the light transmission state and the number of sub-openings 210 in the light shielding state, at the barrier mode shift boundaries 270 by an amount equivalent to one sub-opening pitch ΔSW. FIG. 35 illustrates a case where the integrated opening 300a has a width equivalent to five sub-openings, which is narrower by an amount equivalent to one sub-opening pitch ΔSW than in the model illustrated in FIG. 31. The width of the other integrated openings 300b and 300c and the width of the integrated light shielding parts 330a, 330b, and 330c remain unchanged at the width equivalent to six sub-openings 210. In this case, a valley representing luminance appears in the front direction. However, if the intraocular distance of the observer is assumed to be 65 mm, the intraocular angle is 6.2 degrees and wide. Since, as illustrated in FIG. 35, the intraocular angle is wide as compared with the valley representing luminance, even if the observer has moved to some extent in the left-right direction, the observer will not perceive a change in luminance, which is visually recognized as dark lines at the barrier mode shift boundaries 270.

In contrast, FIG. 36 illustrates a case where the integrated light shielding part 330a has a width equivalent to five sub-openings 21, which is narrower by an amount equivalent to one sub-opening than in the model illustrated in FIG. 31, while the width of the integrated opening 300a remains unchanged at the width equivalent to six sub-openings 210. The width of the other integrated openings 300b and 300c and the width of the integrated light shielding parts 330b and 330c remain unchanged at the width equivalent to six sub-openings 210. In this case, the luminance in the front direction is flat, and a mountain that represents luminance appears at the right end. Note that the thick broken line in the drawing indicates the angular distribution of luminous intensity for the case where calculation is performed on three integrated openings 300 centered on the integrated opening 300c, and this distribution is bilaterally symmetrical with respect to the luminous intensity distribution centered on the integrated opening 300a. Either of the luminous intensity distributions shows that a region where the luminance is flat exists in the central part. However, when the intraocular angle of the observer is taken into consideration, there is the risk that even the observer's slight move in the left-right direction may cause the observer to perceive a difference in luminance, which is visually recognized as emission lines, at the barrier mode shift boundaries 270 due to the mountains of luminance at the left and right ends. That is, since the intraocular angle of the observer increases when the actual observation distance is smaller than the designed observation distance D, reducing the number of sub-openings 210 in the integrated openings 300 at the barrier mode shift boundaries 270, rather than reducing the number of sub-openings 210 in the integrated light shielding parts 330, is more effective to reduce the risk that the observer who is moving left and right may perceive a change in luminance, which is visually recognized as emission lines or dark lines at the barrier mode shift boundaries 270.

As described above, according to the second prerequisite technique of the present invention, in the case where it has been detected that the position of the observer is smaller than the designed observation distance, at least one location where the number of continuous sub-openings in the light transmission state is N/2−1, and on each side of these continuous sub-openings, the number of continuous sub-openings in the light shielding state is N/2 is provided in the lateral direction. Accordingly, even if the observer who is located at an actual observation distance smaller than the designed observation distance has moved to some degree in the left-right direction, the observer is able to visually recognize a stereoscopic image without perceiving a change in luminance, which is visually recognized as emission lines or dark lines at the barrier mode shift boundaries 270.

Also, according to the second prerequisite technique of the present invention, in the case where it has been detected that the position of the observer is greater than the designed observation distance, at least one location where the number of continuous sub-openings in the light transmission state is N/2+1, and on each side of these continuous sub-openings, the number of continuous sub-openings in the light shielding state is N/2 is provided in the lateral direction. Accordingly, even if the observer who is located at the actual observation distance greater than the designed observation distance has moved to some degree in the left-right direction, the observer is able to visually recognize a stereoscopic image without perceiving a change in luminance, which is visually recognized as emission lines or dark lines at the barrier mode shift boundaries 270.

Moreover, according to the second prerequisite technique of the present invention, the number of pieces of wiring can be reduced by electrically connecting N·M+N/2 first transparent electrodes 23, where M is a positive integer, disposed within each common drive area 251 at an interval of N first transparent electrodes 23.

While the descriptions of the second prerequisite technique of the present invention have discussed a stereoscopic image display device with a configuration in which N·M+N/2 first transparent electrodes 23 are electrically connected to one another at an interval of N first transparent electrodes 23, the present invention is not limited to this, and the configuration may be such that a terminal La is provided for each first transparent electrode 23.

Also, the number of continuous sub-openings in the light transmission state may be changed as necessary only when it has been detected that the position of the observer is closer than the designed observation distance or only when it has been detected that the positon of the observer is farther than the designed observation distance.

Examples 2 of Second Prerequisite Technique

According to Example 1 of the second prerequisite technique described above, the parallax bather shutter panel 21 is installed on the observer side of the display panel 11 as illustrated in FIG. 1, but according to Example 2, the parallax barrier shutter panel 21 is installed between the display panel 11 and the backlight 3. In other words, the parallax barrier shutter panel 21 is installed on the side of the display panel 11 opposite to the observer. In this case, this configuration can be implemented by setting the amount of optimum displacement Z to be provided between the center position of the light shielding barrier 18 between the sub-pixels 411a and 411b constituting a sub-pixel pair 41 and the center position of an integrated opening 300 in accordance with Equation (3) below with respect to the distance X from the center in the lateral direction of the display panel 11.

Z=−X·T/(D·n) (3)

Here, T is the distance between the aperture plane of the display panel 11 and the aperture plane of the parallax barrier shutter panel 21, n is the refractive index of a medium therebetween, and D is the designed observation distance. Note that the sign in Equation (3) is opposite to that in Equation (1).

When the display panel 11 has a pitch Po of the sub-pixel pairs, the reference parallax barrier pitch P of the parallax barrier shutter panel 21 is set to a value expressed by Equation (4) below.

P=P₀·{1+T/(D·n)} (4)

In this case, the reference parallax barrier pitch P is designed to be slightly greater than the pitch Po of the sub-pixel pairs 41. As the observation distance increases, the ideal parallax barrier pitch decreases as expressed by Equation (4) and approaches the pitch Po of the sub-pixel pairs 41. In contrast, as the observation distance decreases, the ideal parallax barrier pitch increases. That is, in the case where the actual observation distance is greater than the designed observation distance D, a local parallax barrier pitch that is the sum of the number of sub-openings 210 in the light transmission state and the number of sub-openings 210 in the light shielding state needs to be reduced at the barrier mode shift boundaries 270 by an amount equivalent to one sub-opening pitch ΔSW in order to reduce the average parallax barrier pitch on the display surface. In contrast, in the case where the actual observation distance is less than the designed observation distance D, the local parallax barrier pitch, which is the sum of the number of sub-openings 210 in the light transmission state and the number of sub-openings 210 in the light shielding state, needs to be increased at the barrier mode shift boundaries 270 by an amount equivalent to one sub-opening pitch ΔSW in order to increase the average parallax barrier pitch on the display surface.

Next, a specific method of driving the parallax barrier shutter panel 21 will be described. First, in the case where the actual observation distance is greater than the designed observation distance D, as described previously, it is necessary to reduce the local parallax barrier pitch, which is the sum of the number of sub-openings 210 in the light transmission state and the number of sub-openings 210 in the light shielding state, at the barrier mode shift boundaries 270 by an amount equivalent to one sub-opening pitch ΔSW in order to reduce the average parallax barrier pitch on the display surface. Examples of methods for reducing the distance between the integrated openings 300 by an amount equivalent to one sub-opening pitch ΔSW include a method of reducing the number of sub-openings 210 in the light transmission state without changing the number of sub-openings 210 in the light shielding state and a method of reducing the number of sub-openings 210 in the light shielding state without changing the number of sub-openings 210 in the light transmission state. However, as will be described below, the method of reducing the number of sub-openings 210 in the light shielding state without changing the number of sub-openings 210 in the light transmission state is more suitable because it has the effect that the observer who is moving is less likely to perceive luminance flicker, which is visually recognized as emission lines or dark lines at the barrier mode shift boundaries 270.

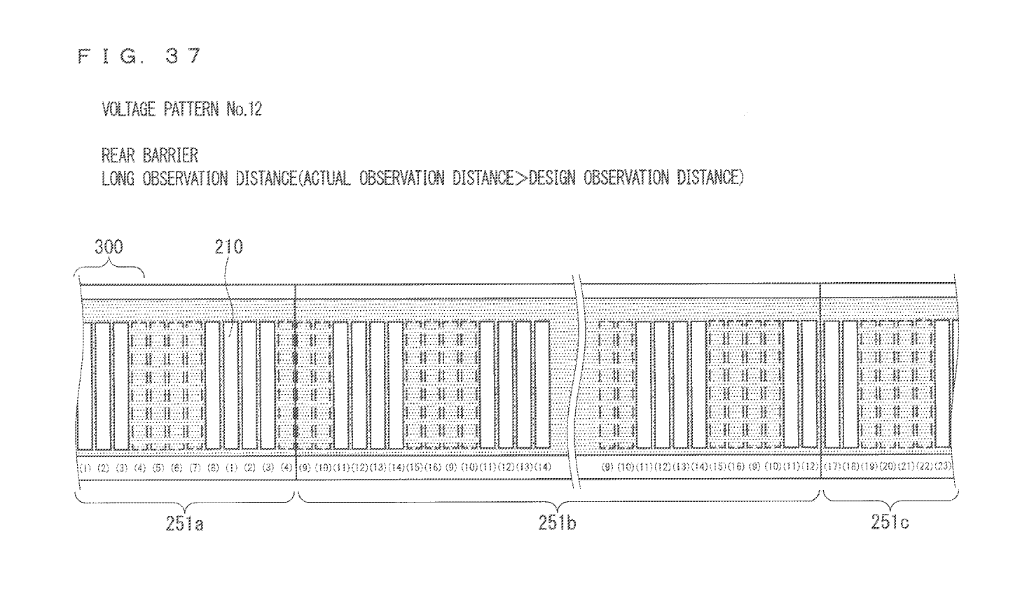

FIG. 37 illustrates the arrangement of the integrated openings 300 formed depending on the application of voltage to the first transparent electrodes 23 in the vicinity of a barrier mode shift boundary 270 when the actual observation distance is greater than the designed observation distance (in the case of a long observation distance). This arrangement is obtained by application of the voltage pattern No. 12 (FIG. 22). The term “rear barrier” in the drawing indicates that the parallax barrier shutter panel 21 is disposed behind the display panel 11 as in the present example. Here, three first transparent electrodes 23 to which a plus voltage (corresponding to the light shielding state) is applied are disposed at the boundary part between the first common drive area 251a and the second common drive area 251b. In the other area, the pitch consisting of four first transparent electrodes 23 corresponding to the light transmission state and four first transparent electrodes 23 corresponding to the light shielding state is maintained. Thus, a barrier mode shift boundary 270 is formed at the boundary part between the first common drive area 251a and the second common drive area 251b. Then, at the barrier mode shift boundary 270, the local parallax barrier pitch, which is the sum of the number of sub-openings 210 in the light transmission state and the number of sub-openings 210 in the light shielding state, is reduced by an amount equivalent to one sub-opening pitch ΔSW by reducing the number of sub-openings 210 in the light shielding state without changing the number of sub-openings 210 in the light transmission state.

Also, in the state of the voltage pattern No. 13 (FIG. 22), the integrated openings 300 in the parallax barrier shutter panel 21 are shifted to the right in response to the observer moving in the left direction while maintaining the aforementioned short observation distance. Also in this case, three first transparent electrodes 23 to which a plus voltage (corresponding to the light shielding state) is applied are disposed at the boundary part between the first common drive area 251a and the second common drive area 251b. In the other area, the pitch consisting of four first transparent electrodes 23 corresponding to the light transmission state and four first transparent electrodes 23 corresponding to the light shielding state is maintained. Thus, the barrier mode shift boundary 270 is formed at the boundary part between the first common drive area 251a and the second common drive area 251b. Then, at the barrier mode shift boundary 270, the local parallax barrier pitch, which is the sum of the number of sub-openings 210 in the light transmission state and the number of sub-openings 210 in the light shielding state, is reduced by an amount equivalent to one sub-opening pitch ΔSW by reducing the number of sub-openings 210 in the light shielding state without changing the number of sub-openings 210 in the light transmission state.

Moreover, in the state of the voltage pattern No. 14 (FIG. 22), a plus voltage (corresponding to the light shielding state) is applied to three first transparent electrodes 23 not at the boundary part between the first common drive area 251a and the second common drive area 251b, but at the boundary part between the second common drive area 251b and the third common drive area 251c. In the other area, the pitch consisting of four first transparent electrodes 23 corresponding to the light transmission state and four first transparent electrodes 23 corresponding to the light shielding state is maintained. Thus, in the first common drive area 251a (within the first common barrier mode area 260) and the third common drive area 251c (within the second common barrier mode area 260)), the integrated openings 300 can be shifted in the right direction by an amount equivalent to the sub-opening pitch ΔSW of the first transparent electrodes 23 while maintaining their equal width and pitch, in response to the observer moving in the left direction.

The above-described operations are made implementable by the configuration in which N·M+N/2 first transparent electrodes 23 are disposed in each common drive area 251. Here, N is an even number that corresponds to the number of first transparent electrodes 23 within the reference parallax barrier pitch P, and M is an arbitrary positive integer. With this configuration, in the case where the display device is driven with the number of first transparent electrodes 23 in the light transmission state and the number of first transparent electrodes 23 in the light shielding state being equally N/2, the phases of the integrated openings 300 are shifted by a half cycle at the left and right ends of the common drive areas 251. For this reason, a first transparent electrode 23 corresponding to the light shielding state always appear at either of the ends. Thus, the number of first transparent electrodes 23 corresponding to the light shielding state can be reduced by one at either of the left and right ends of the common drive areas 251. Accordingly, either of the left and right ends of the common drive areas 251 becomes a barrier mode shift boundary 270.

On the other hand, in the case where the actual observation distance is smaller than the designed observation distance D (in the case of a short observation distance), as described previously, it is necessary to increase the local parallax barrier pitch, which is the sum of the number of sub-openings 210 in the light transmission state and the number of sub-openings 210 in the light shielding state, at the barrier mode shift boundaries 270 by an amount equivalent to one sub-opening pitch ΔSW in order to increase the average parallax barrier pitch on the display surface. Examples of methods for implementing this include a method of increasing the number of sub-openings 210 in the light transmission state without changing the number of sub-openings 210 in the light shielding state and a method of increasing the number of sub-openings 210 in the light shielding state without changing the number of sub-openings 210 in the light transmission state. However, as will be described below, the method of increasing the number of sub-openings 210 in the light transmission state without changing the number of sub-openings 210 in the light shielding state is more suitable because it has the effect that the observer who is moving is less likely to perceive luminance flicker, which is visually recognized as emission lines or dark lines, at the barrier mode shift boundaries 270.

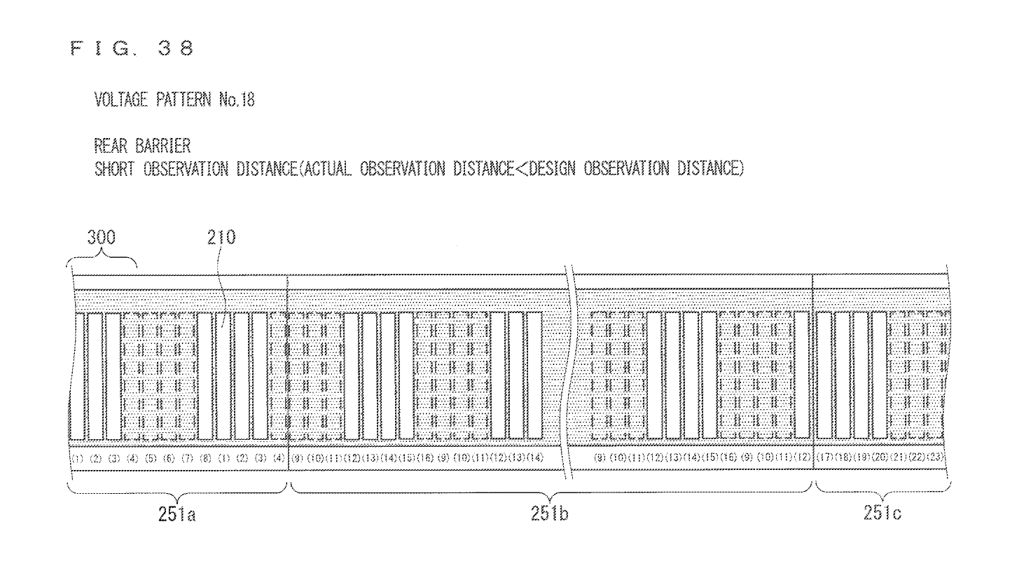

FIG. 38 illustrates the arrangement of the integrated openings 300 formed depending on the application of voltage to the first transparent electrodes 23 in the vicinity of the barrier mode shift boundary 270 when the actual observation distance is less than the designed observation distance (in the case of a short observation distance). This arrangement is obtained by application of the voltage pattern No. 18 (FIG. 22). Here, five first transparent electrodes 23 to which a null voltage (corresponding to the light transmission state) is applied are disposed at the boundary part between the second common drive area 251b and the third common drive area 251c. In the other area, the pitch consisting of four first transparent electrodes 23 corresponding to the light transmission state and four first transparent electrodes 23 corresponding to the light shielding state is maintained. Thus, a barrier mode shift boundary 270 is formed at the boundary part between the second common drive area 251b and the third common drive area 251c. Also, the local parallax barrier pitch, which is the sum of the number of sub-openings 210 in the light transmission state and the number of sub-openings 210 in the light shielding state, is increased by an amount equivalent to one sub-opening pitch by increasing the number of sub-openings 210 in the light transmission state without changing the number of sub-openings 210 in the light shielding state.

Also, in the state of the voltage pattern No. 19 (FIG. 22), the integrated openings 300 in the parallax barrier shutter panel 21 are shifted to the right in response to the observer moving in the left direction while maintaining the aforementioned short observation distance. Here, five first transparent electrodes 23 to which a null voltage (corresponding to the light transmission state) is applied are disposed at the boundary part between the first common drive area 251a and the second common drive area 251b. In the other area, the pitch consisting of four first transparent electrodes 23 corresponding to the light transmission state and four first transparent electrodes 23 corresponding to the light shielding state is maintained. Thus, a barrier mode shift boundary 270 is formed at the boundary part between the first common drive area 251a and the second common drive area 251b. Then, at the barrier mode shift boundary 270, the local parallax barrier pitch, which is the sum of the number of sub-openings 210 in the light transmission state and the number of sub-openings 210 in the light shielding state, is increased by an amount equivalent to one sub-opening pitch ΔSW by increasing the number of sub-openings 210 in the light transmission state without changing the number of sub-openings 210 in the light shielding state.

Moreover, similarly in the state of the voltage pattern No. 20 (FIG. 22), five first transparent electrodes 23 to which a null voltage (corresponding to the light transmission state) is applied are disposed at the boundary part between the first common drive area 251a and the second common drive area 251b. In the other area, the pitch consisting of four first transparent electrodes 23 corresponding to the light transmission state and four first transparent electrodes 23 corresponding to the light shielding state is maintained. Thus, a barrier mode shift boundary 270 is formed at the boundary part between the first common drive area 251a and the second common drive area 251b. Also, the local parallax barrier pitch, which is the sum of the number of sub-openings 210 in the light shielding state and the number of sub-openings 210 in the light transmission state, is increased by an amount equivalent to one sub-opening pitch by increasing the number of sub-openings 210 in the light transmission state without changing the number of sub-openings 210 in the light shielding state.

In this case, even in the case where the actual observation distance is smaller than the designed observation distance D, within the first common drive area 251a (within the first common barrier mode area) and the third common drive area 251c (within the second common barrier mode area), the integrated openings 300 can be shifted in the right direction by an amount equivalent to the sub-opening pitch ΔSW of the first transparent electrodes 23 while maintaining their equal width and pitch, in response to the observer moving in the left direction.

The above-described operations are made implementable by the configuration in which N·M+N/2 first transparent electrodes 23 are disposed in each common drive area 251. Here, N is an even number that corresponds to the number of first transparent electrodes 23 within the reference parallax barrier pitch P, and M is an arbitrary positive integer. With this configuration, in the case where the display device is driven with the number of first transparent electrodes 23 in the light transmission state and the number of first transparent electrodes 23 in the light shielding state being equally N/2, the phases of the integrated openings 300 are shifted by a half cycle at the left and right ends of the common drive areas 251. For this reason, a first transparent electrode 23 corresponding to the light transmission state always appear at either of the ends. Thus, the number of first transparent electrodes 23 corresponding to the light transmission state can be increased by one at either of the left and right ends of the common drive areas 251. Accordingly, either of the left and right ends of the common drive areas 251 becomes a barrier mode shift boundary 270.

Relationship Between Luminous Intensity Distribution Characteristics and Widths of Integrated Openings and Integrated Light Shielding Parts

The following description is given regarding luminous intensity distribution characteristics in the case of changing the number of sub-openings in the light shielding state and the number of sub-openings in the light transmission state at the barrier mode shift boundaries.

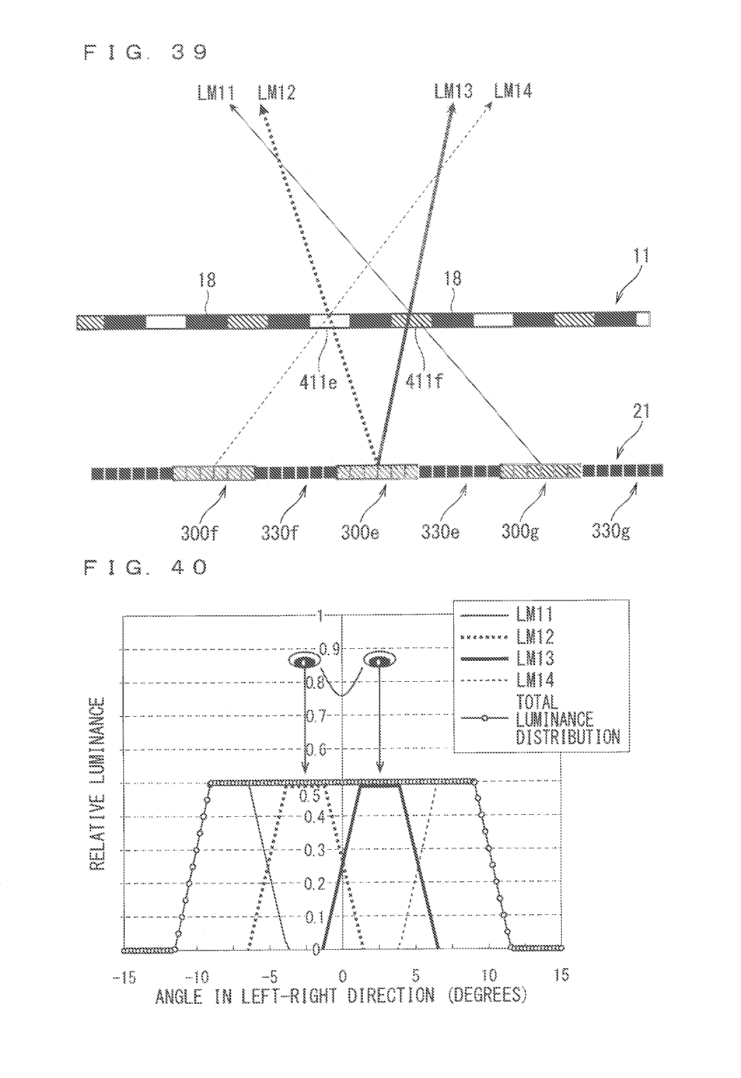

Here, assume a model configured by the sub-pixels 411 in the display panel 11 and the integrated openings 300 in the parallax barrier shutter panel 21 as illustrated in FIG. 39. In the drawing, the center position of the light shielding barrier 18 between left and right sub-pixels 411e and 411f and the center position of the integrated opening 300a correspond to each other. Also, an integrated opening 300f is disposed on the left side of the integrated opening 300e, and an integrated opening 300g is disposed on the right side of the integrated opening 300e. Note that the model in. FIG. 39 differs from the model in FIG. 31 in that the positions in the up-down direction of the display panel 11 and the parallax barrier shutter panel 21 are interchanged. The pitch of the sub-pixel pairs 41 is 0.12 mm, the pixel-barrier distance is 1 mm, and the opening width of the sub-pixels is 0.03 mm. The designed observation distance D is 800 mm, and the number of first transparent electrodes 23 within the reference parallax barrier pitch P is an even number N, where N=12. According to calculation using geometrical optics, the luminous intensity distribution characteristics are exactly the same as the result obtained with the model in FIG. 31.

FIG. 40 illustrates the result of calculating the luminous intensity distribution characteristics in the case where the number of sub-openings 210 in the light transmission state and the number of sub-openings 210 in the light shielding state are each N/2=6. This is the case where no barrier mode shift boundaries 270 exist on the display surface, and corresponds to the case where the observation distance is equal to the designed observation distance D. The horizontal axis indicates the angle in the left-right direction when the front direction of the display surface is zero degrees, and the vertical axis indicates the relative luminance. As illustrated in FIG. 39, calculation is performed on four light beams LM11, LM12, LM13, and LM14 that pass through the integrated opening 300e and the integrated openings 300f and 300g on both sides of the integrated opening 300e and are emitted from the left and right sub-pixels 411e and 411f. This is because these four light beams travel in directions close to the observer. Here, the total luminance distribution for the case where the left and right sub-pixels 411e and 411f are in a white display state is indicated by the solid line marked with a marker. This result is exactly the same as that illustrated in FIG. 32.

Here, if the intraocular distance of the observer is assumed to be 65 mm, the intraocular angle is 4.6 degrees. The left and right eyes are respectively located in the centers of the peaks of the luminous intensity distributions of the light beams LM12 and LM13 that has come out of the integrated opening 300e and passed through the sub-pixels 411e and 411f. The total luminance distribution is completely flat over a wide angle range in the vicinity of the center of the horizontal axis. Thus, in the case where the observer has moved left and right with an observation distance of 800 mm, the observer does not perceive flicker caused by a change in luminance, which is visually recognized as emission lines or dark lines, at the barrier mode shift boundaries 270. Accordingly, setting the width of the integrated openings 300 in the parallax barrier shutter panel 21 to 50% of the reference parallax barrier pitch P is suited in order to prevent the observer who is moving in the lateral direction from perceiving luminance flicker, which is visually recognized as emission lines or dark lines, at the barrier mode shift boundaries 270. That is, it is desirable to set the number of first transparent electrodes 23 in the light transmission state and the number of first transparent electrodes 23 in the light shielding state to be equally N/2.

Next, consider a case where the actual observation distance is 1000 mm and greater than the designed observation distance D of 800 mm. In this case, it is necessary to reduce the local parallax barrier pitch, which is the sum of the number of sub-openings 210 in the light transmission state and the number of sub-openings 210 in the light shielding state, at the barrier mode shift boundaries 270 by an amount equivalent to one sub-opening pitch ΔSW. FIG. 41 illustrates a case where the integrated opening 300e has a width equivalent to five sub-openings, which is narrower by an amount equivalent to one sub-openings than in the model illustrated in FIG. 39. The width of the other integrated openings 300f and 300g and the width of the integrated light shielding parts 330e, 330f, and 330g remain unchanged at the width equivalent to six sub-openings. In this case, a valley that represents luminance appears in the front direction. Here, if the intraocular distance of the observer is assumed to be 65 mm, the intraocular angle is 3.7 degrees and narrow. Since, as illustrated in FIG. 41, the intraocular angle is narrow as compared with the valley representing luminance, there is the risk that even the observer's slight move in the left-right direction may cause the observer to perceive a change in luminance, which is visually recognized as dark lines at the barrier mode shift boundaries 270.

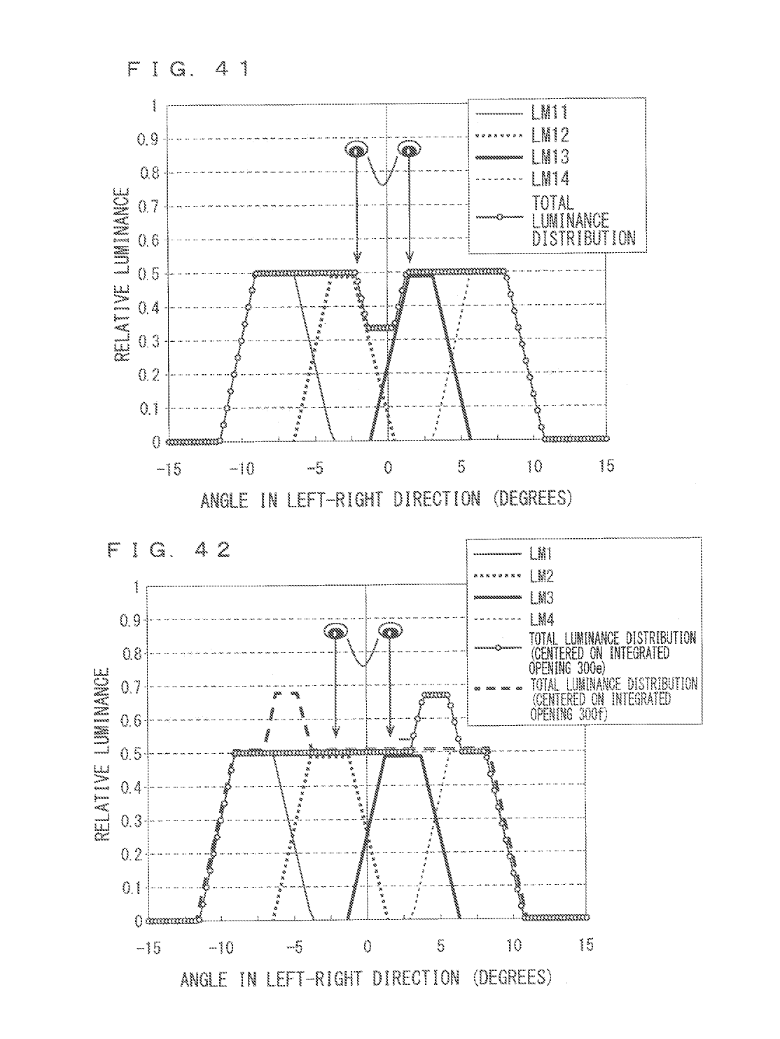

In contrast, FIG. 42 illustrates a case where the integrated light shielding part 330f has a width equivalent to five sub-openings, which is narrower by an amount equivalent to one sub-opening than in the model illustrated in FIG. 39, while the width of the integrated opening 300e remains unchanged at the width equivalent to six sub-openings 210. In this case, the luminance in the front direction is flat, and a mountain that represents luminance appears at the right end. Note that the thick broken line in the drawing indicates the angular distribution of the luminous intensity for the case calculation is performed centered on the integrated opening 300f, and this distribution is bilaterally symmetrical with respect to the luminous intensity distribution centered on the integrated opening 300e. Either of the luminous intensity distributions shows that a region where the luminance is flat exists in the central part. Here, when the intraocular angle of the observer is taken into consideration, it is found that, even if the observer has moved to some extent in the left-right direction, the observer will not perceive a difference in luminance, which is visually recognized as emission lines, at the barrier mode shift boundaries 270. That is, since the intraocular angle of the observer decreases when the actual observation distance is greater than the designed observation distance D, reducing the number of sub-openings 210 in the integrated light shielding part 330 at the barrier mode shift boundaries 270, rather than reducing the number of sub-openings 210 in the integrated opening 300, is more effective to reduce the risk that the observer who is moving left and right may perceive a change in luminance, which is visually recognized as emission lines or dark lines at the barrier mode shift boundaries 270.

Next, consider a case where the actual observation distance is 600 mm and smaller than the designed observation distance D of 800 mm. In this case, it is necessary to increase the local parallax barrier pitch, which is the sum of the number of sub-openings 210 in the light transmission state and the number of sub-openings 210 in the light shielding state, at the barrier mode shift boundaries 270 by an amount equivalent to one sub-opening pitch ΔSW. FIG. 43 illustrates a case where the integrated opening 300e has a width equivalent to seven sub-openings, which is wider by an amount equivalent to one sub-opening pitch ΔSW than in the model illustrated in FIG. 39. The width of the other integrated openings 300f and 300g and the width of the integrated light shielding parts 330e, 330f, and 330g remain unchanged at the width equivalent to six sub-openings 210. In this case, a mountain that represents luminance appears in the front direction. However, if the intraocular distance of the observer is assumed to be 65 mm, the intraocular angle is 6.2 degrees and wide. Since, as illustrated in FIG. 43, the intraocular angle is wide as compared with the mountain representing luminance, even if the observer has moved to some extent in the left-right direction, the observer will not perceive a change in luminance, which is visually recognized as emission lines at the barrier mode shift boundaries 270.

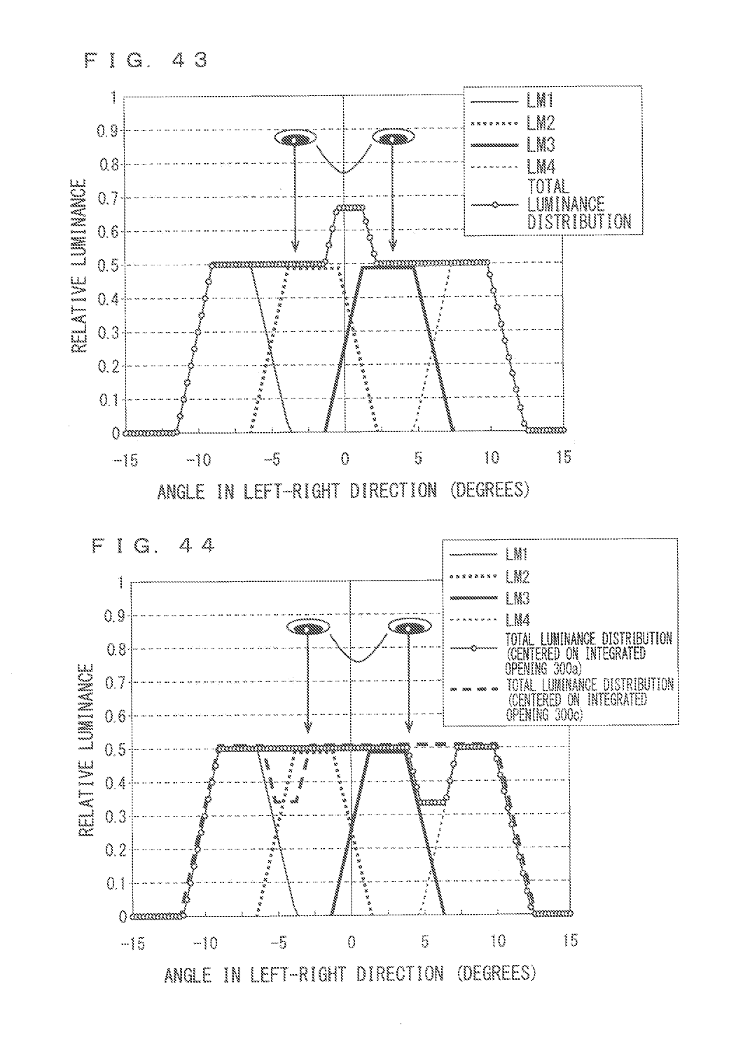

In contrast, FIG. 44 illustrates a case where the integrated light shielding part 330f has a width equivalent to seven sub-openings, which is wider by an amount equivalent to one sub-opening than in the model illustrated in FIG. 39, while the width of the integrated opening 300e remains unchanged at the width equivalent to six sub-openings 210. The widths of the other integrated openings 300f and 300g and the width of the integrated light shielding parts 330e and 330g remain unchanged at the width equivalent to six sub-openings. In this case, the luminance in the front direction is flat, and a valley that represents luminance appears at the right end. Note that the thick broken line in the drawing indicates the angular distribution of luminous intensity for the case where calculation is performed centered on the integrated opening 300f, and this distribution is bilaterally symmetrical with respect to the luminous intensity distribution centered on the integrated opening 300e. Either of the luminous intensity distribution shows that a region where the luminance is flat exists in the central part. However, when the intraocular angle of the observer is taken into consideration, there is the risk that even the observer's slight move in the left-right direction may cause the observer to perceive a difference in luminance, which is visually recognized as dark lines, at the barrier mode shift boundaries 270 due to the valleys of luminance at the left and right ends. That is, since the intraocular angle of the observer increases when the actual observation distance is smaller than the designed observation distance D, increasing the number of sub-openings 210 in the integrated opening 300 at the barrier mode shift boundaries 270, rather than increasing the number of sub-openings 210 in the integrated light shielding part 330, is more effective to reduce the risk that the observer who is moving left and right may perceive a change in luminance, which is visually recognized as emission lines or dark lines at the barrier mode shift boundaries 270.

### Embodiment 1

Relationship with Second Prerequisite Technique

As described above, the second prerequisite technique reduces the risk that an observer who observes a stereoscopic (3D) image presented by the stereoscopic image display device and who is moving may perceive a change in luminance, which is visually recognized as emission lines or dark line at the barrier mode shift boundaries 270. However, according to examinations performed by the inventors of the present invention, the position of the observer is away from an appropriate position for visually recognizing 3D images, emission lines or dark lines caused by control of the parallax barrier shutter panel and flicker caused by fluctuations in luminance may possibly be visually recognized to an extent that cannot be ignored, even with simple application of the second prerequisite technique. Also, double images produced by 3D crosstalk can highly possibly be visually recognized. The present embodiment intends to solve these problems. The following description is given regarding stereoscopic image display devices according to the present embodiment, focusing on the content that is not described in the aforementioned first and second prerequisite techniques. Note that constituent elements that are the same as or similar to those described above in the first and second prerequisite techniques are given the same reference numerals, and redundant descriptions may be omitted.

Configuration

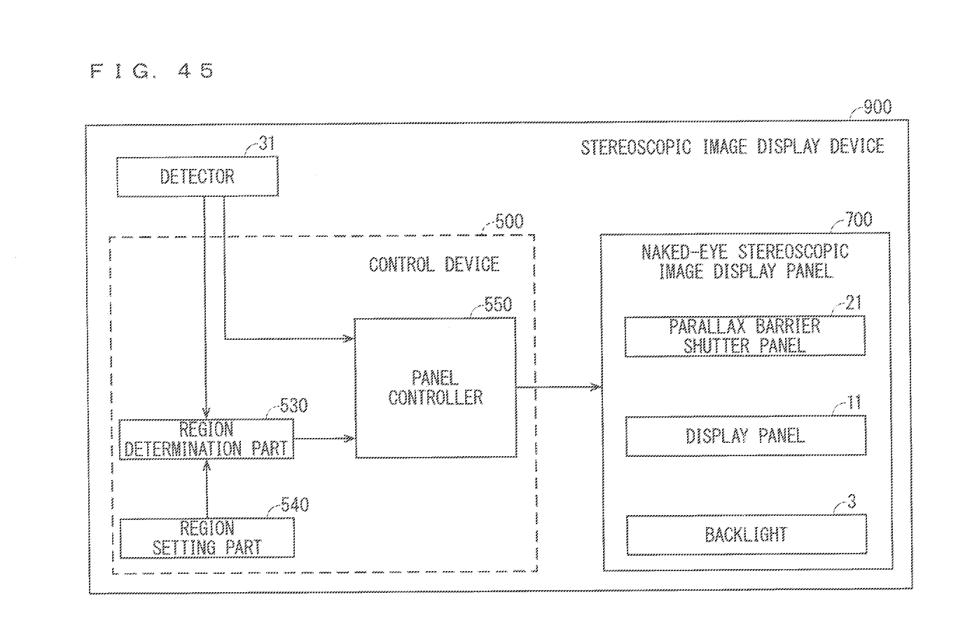

FIG. 45 is a block diagram schematically illustrating a configuration of a stereoscopic image display device 900 according to the present embodiment. The stereoscopic image display device 900 includes a naked-eye stereoscopic image display panel 700, a control device 500, and a detector 31. The naked-eye stereoscopic image display panel 700 may be the same as that described in Example 1 or 2 of the aforementioned second prerequisite technique, and includes a display panel 11, a parallax barrier shutter panel 21, and a backlight 3. The detector 31 is configured to detect the position of an observer as in the aforementioned first and second prerequisite techniques, and one example thereof is a camera device. The control device 500 includes a panel controller 550, a region setting part 540, and a region determination part 530. The control device 500 can be configured by at least one IC.

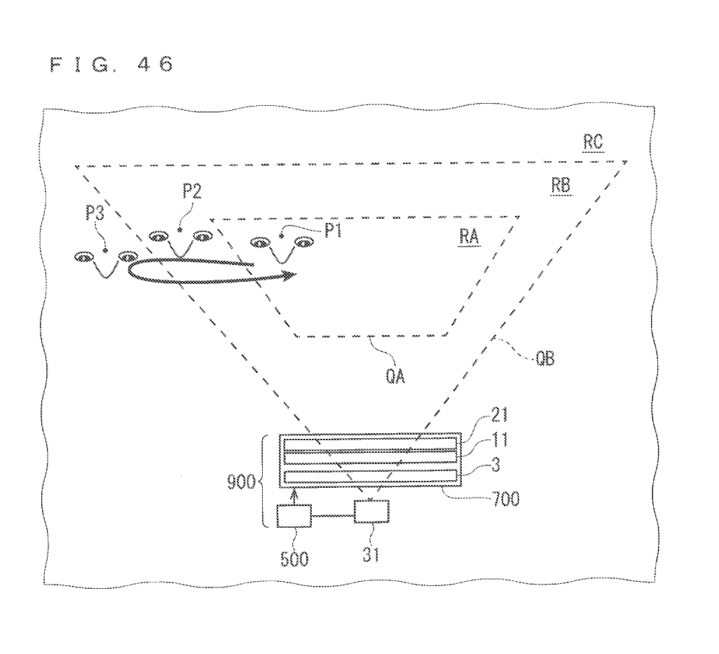

FIG. 46 is a diagram for describing a designed stereoscopic region QA and an observer-detectable region QB that are set by the region setting part 540 in FIG. 45.

The stereoscopic image display device 900 is configured to display a stereoscopic image toward an observer who is located within the designed stereoscopic region QA. The designed stereoscopic region QA is located in front of the display surface of the stereoscopic image display device 900. When the observer is within the designed stereoscopic region QA, the stereoscopic image display device 900 performs operations for presenting a 3D image to the observer. The designed stereoscopic region QA may be defined in advance so as to correspond to a region in which a 3D image can be displayed with high quality. Also, when the observer is within the observer-detectable region QB, the stereoscopic image display device 900 detects the position of the observer and controls an image that is presented to the observer in accordance with the position of the observer. The observer-detectable region QB includes the designed stereoscopic region QA and is larger than the designed stereoscopic region QA. Typically, the observer-detectable region QB, as shown, is broader than the designed stereoscopic region QA in all directions including the lateral direction, the up-down direction, and the back-and-forth direction. The observer-detectable region QB may be defined in advance so as to correspond to a region in which the detector 31 can detect the position of the observer.

In the following description, the designed stereoscopic region QA is also referred to as a stereoscopic display region RA. Also, a region that is outside the designed stereoscopic region QA but within the observer-detectable region QB is referred to as an intermediate region RB. Also, a region outside the observer-detectable region QB is referred to as an undetectable region RC.

As also described in the first and second prerequisite techniques, the display panel 11 includes a plurality of sub-pixel pairs 41 (see FIG. 1) aligned at a predetermined pitch in the lateral direction. Each of the sub-pixel pairs 41 includes two sub-pixels 411 that respectively display images for left and right eyes.

The parallax barrier shutter panel 21 is, for example, the same as that (FIG. 21) according to the second prerequisite technique, but the wiring structure thereof is not limited to the one illustrated in FIG. 21. Any wiring structure may be employed as long as the parallax barrier shutter panel 21 can perform operations involving generation of the barrier mode shift boundaries 270 (see, for example, FIG. 29). As described previously, the parallax barrier shutter panel 21 is overlaid on the display panel 11 and includes a plurality of sub-openings 210 (see, for example, FIG. 29). The sub-openings 210 are aligned in the lateral direction and can be electrically switched between the light transmission state and the light shielding state. The sub-openings 210 are arranged in the lateral direction at a pitch obtained by dividing the reference parallax barrier pitch P (FIG. 1) by N, where N is an even number greater than or equal to four, i.e., at the sub-opening pitch ΔSW, the reference parallax barrier pitch P being determined by the predetermined designed observation distance D (FIG. 1) and the pitch Po (FIG. 1) of the sub-pixel pairs 41. The sub-opening pitch ΔSW is less than or equal to the difference between the width of the sub-pixels 411 in the display panel 11 and the width of the integrated openings 300 in the parallax barrier shutter panel 21.

The panel controller 550 switches each of the sub-openings 210 in the parallax barrier shutter panel 21 between the light transmission state and the light shielding state in accordance with the position of the observer. This changes the pattern of the integrated openings 300 (see, for example, FIG. 29) each configured by those of the sub-openings 210 that are in the light transmission state. The operation of changing the pattern of the integrated openings 300, performed during a period in which a normal 3D image is displayed, is similar to that according to the aforementioned second prerequisite technique, and this operation is controlled by the panel controller 550. Thus, the panel controller 550 has, as one of its functions, the same function as that of the controller according to the second prerequisite technique. The details of the other functions of the panel controller 550 will be described later.

The region setting part 540 is configured to set the designed stereoscopic region QA and the observer-detectable region QB. Typically, the region setting part 540 is a storage for storing the designed stereoscopic region QA and the observer-detectable region QB that are defined in advance.

The region determination part 530 determines whether the position of the observer detected by the detector 31 is included in the designed stereoscopic region QA. The region determination part 530 also determines whether the position of the observer detected by the detector 31 is included in the observer-detectable region QB. In this way, the region determination part 530 can determine within which of the stereoscopic display region RA, the intermediate region RB, or the undetectable region RC the observer is located.

Operations of Naked-Eye Stereoscopic Image Display Panel 700

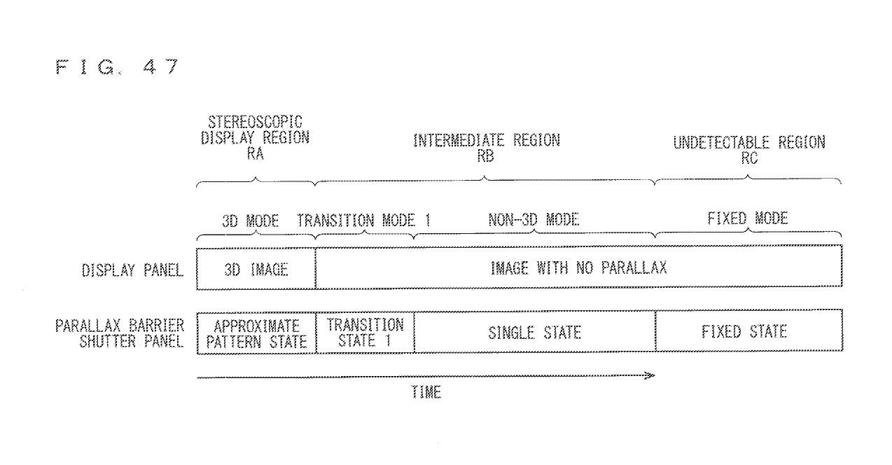

FIG. 47 is a diagram for describing operations performed by the stereoscopic image display device 900 when the observer moves from a position P1 via a position P2 to a position P3 in FIG. 46. The positions P1, P2, and P3 are respectively within the stereoscopic display region RA, the intermediate region RB, and the undetectable region RC.

When the observer is at the position P1 within the stereoscopic display region RA, operations are performed in a 3D mode that is a mode for presenting stereoscopic images with parallax to the observer, in the 3D mode, the display panel 11 displays an ordinary 3D image, and the parallax barrier shutter panel 21 takes an approximate pattern state. The approximate pattern state is, as described in the second prerequisite technique, a state in which theoretical opening/pixel boundary displacement (see the solid or broken line in FIG. 28) determined in accordance with the position of the observer is implemented approximately (see the circle or triangular marks in FIG. 28).

When the observer has moved from the stereoscopic display region RA to the position P2 within the intermediate region RB, operations are first performed in a transition mode 1 and then performed in a non-3D mode. In either mode, the display panel 11 displays an image with no parallax. The image with no parallax may, for example, be an image in which right and left eye images are regarded as the same, or may be an image whose resolution is increased by using each sub-pixel 411 for both eyes, instead of dividing the plurality of sub-pixels 411 (FIG. 1) into two parts, one for the right eye and the other for the left eye, for use. The parallax barrier shutter panel 21 transitions via a transition state I in the transition mode 1 to a single state in the non-3D mode. As will be described later, in the transition mode 1, an operation of causing the barrier mode shift boundaries 270 to disappear is performed, and in the non-3D mode, control is performed in a state where no barrier mode shift boundary 270 is present.

When the observer has moved from the intermediate region RB to the position P3 within the undetectable region RC, operations are performed in a fixed mode. In the fixed mode, the display panel 11 displays an image with no parallax. Also, the parallax barrier shutter panel 21 performs operations in a fixed state in which no barrier mode shift boundary 270 is present. As this fixed state in which no barrier mode shift boundary 270 is present, it is possible to use the state that has been set immediately before the observer moved from the intermediate region RB to the position P3 within the undetectable region RC.

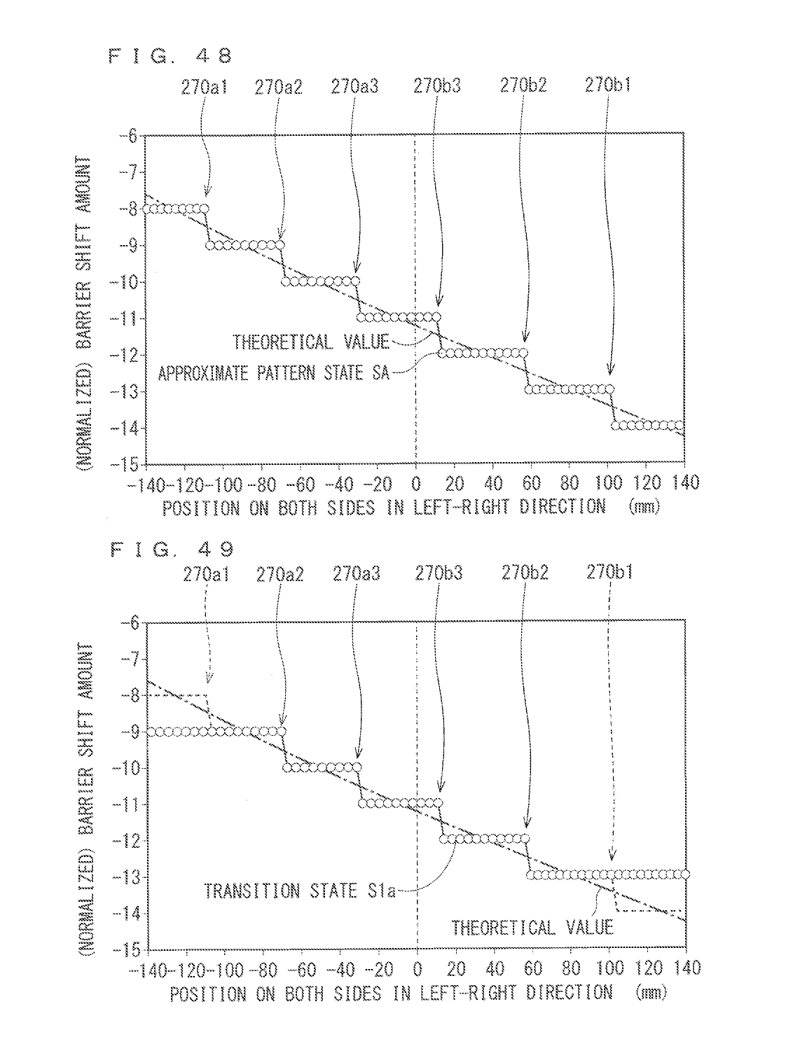

FIG. 48 is a graph for describing an example operation of the parallax barrier shutter panel 21 in the 3D mode (FIG. 27). The horizontal axis indicates the position in the left-right direction on the screen of the naked-eye stereoscopic image display panel 700 (parallax barrier shutter panel 21). The vertical axis indicates the amount of barrier shift. The “amount of barrier shift” as used herein refers to a value obtained by normalizing a difference between theoretical deviation for the case where the observer is at a designed recognizable distance in the front direction at the center of the screen and theoretical deviation for the case where the observer is at an arbitrary recognizable distance in the front direction at an arbitrary position in the left-right direction of the screen. The normalizing is done by using a sub-barrier pitch of the parallax barrier shutter panel. The graph also shows a theoretical value similar to that in FIG. 28.

When the observer is at the position P1 within the stereoscopic display region RA, an approximate pattern state SA that minimizes a deviation from the theoretical value of the opening/pixel boundary displacement is set as in the case in FIG. 28 (second prerequisite technique). For this approximation, a plurality of bather mode shift boundaries 270a1 to 270a3 and 270b1 to 270b3 are formed in the drawing.

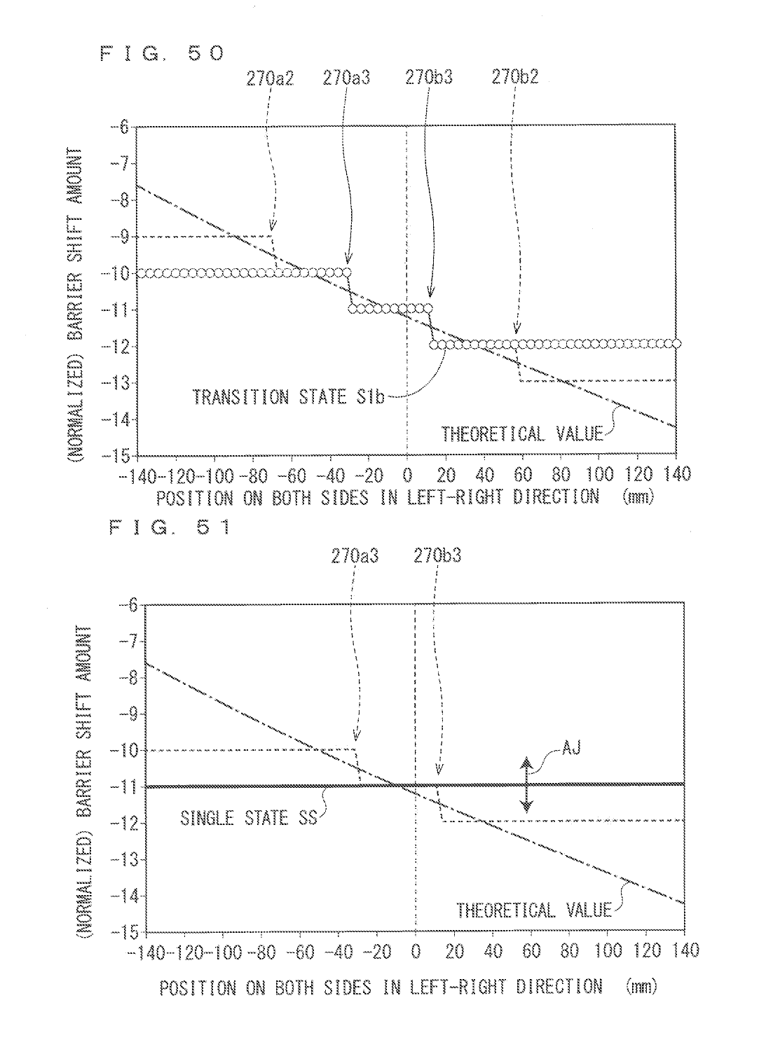

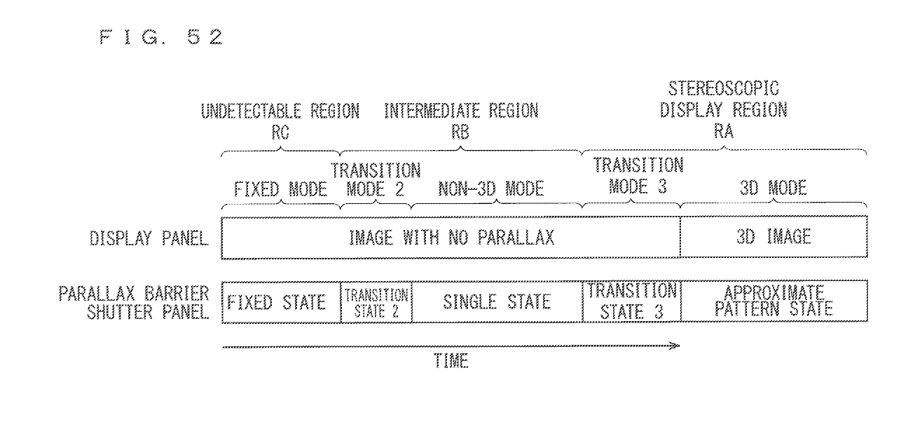

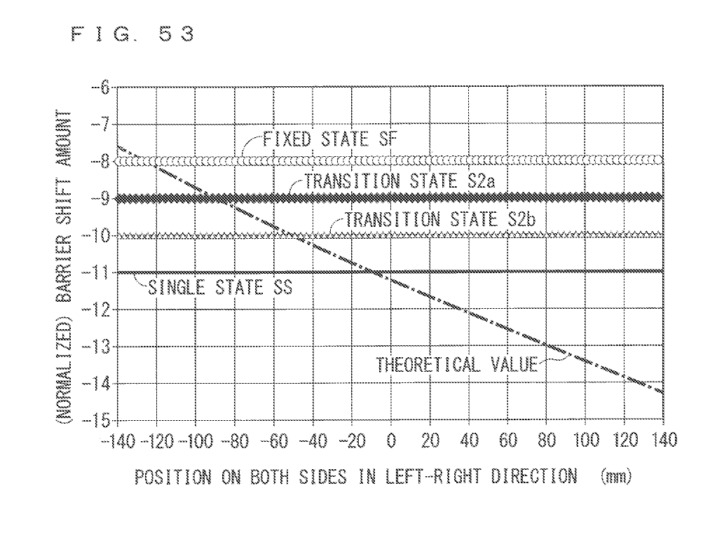

FIGS. 49 and 50 are graphs for describing first and second operations performed in the transition mode 1 (FIG. 47) by the parallax barrier shutter panel 21, which is started when the position of the observer has moved to the position P2 outside the stereoscopic display region RA. FIG. 51 is a graph for describing an operation performed in the non-3D mode (FIG. 47) by the parallax barrier shutter panel 21.

First, the state of the integrated openings 300 transitions from the approximate pattern state SA (FIG. 48) to a transition state S1a (FIG. 49) by causing the barrier mode shift boundaries 270a1 and 270b1 at the outermost ends to disappear. Next, the state of the integrated openings 300 transitions from the transition state S1a (FIG. 49) to a transition state S1b (FIG. 50) by causing the barrier mode shift boundaries 270a2 and 270b2 at the outermost ends at this time to disappear. Then, the state of the integrated openings 300 transitions from the transition state S1b (FIG. 50) to a single state SS (FIG. 51) by causing the barrier mode shift boundaries 270a3 and 270b3 left last in the vicinity of the center to disappear. Accordingly, operations transition from the transition mode 1 to the non-3D mode.

In this way, the operation of adjusting the amount of barrier shift of the integrated opening 300 by an amount equivalent to one sub-opening is performed in order from the left to right ends of the screen of the parallax bather shutter panel 21 so that the difference with the amount of barrier shift in the center of the screen becomes zero. Accordingly, the barrier mode shift boundaries 270 sequentially disappear from the left to right ends of the screen, and even in the vicinity of the locations where the barrier mode shift boundaries 270 were present, the integrated openings 300 are each formed of N/2 sub-openings 210, and the integrated light shielding parts 400 are each formed of N/2 sub-openings 210. That is, when the observer stays at the position P2 for a certain period of time, the amount of barrier shift (i.e., −11) in the central part of the screen in the approximate pattern state SA (FIG. 48) is set on the entire surface of the parallax barrier shutter panel 21. Accordingly, the state transitions to the single state SS (FIG. 51). In the single state, the integrated openings 300 are each formed of N/2 sub-openings 210, and the integrated light shielding parts 400 are each formed of N/2 sub-openings 210, and no barrier mode shift boundary 270 is present.

In the early stage after the observer has moved from the position P1 to the position P2, i.e., in the stage of the transition mode 1 (FIG. 47), the barrier mode shift boundaries 270 remain on the screen of the parallax barrier shutter panel 21 as illustrated in FIGS. 49 and 50. However, the observer is less likely to visually recognize a change in luminance in the vicinity of the barrier mode shin boundaries 270 because of the aforementioned advantageous effect of the second prerequisite technique. That is, the observer is less likely to visually recognize luminance flicker. These operations are desirably performed at a pitch of one sub-opening at a time interval greater than or equal to the response time (typically 3 milliseconds to 20 milliseconds) of the parallax barrier shutter panel 21. This suppresses fluctuations in luminance caused by a difference in liquid crystal response speed between turn-on and turn-off of the parallax barrier shutter panel 21.

When the observer stays at the position P2 for at least a certain period of time, the transition state 1 ends and the non-3D mode starts. In this non-3D mode, since no barrier mode shift boundary 270 is present, there is no risk that the observer may perceive flicker caused by a local change in luminance, which is visually recognized as emission lines or dark lines at the barrier mode shift boundaries 270. Also, since the display panel 11 displays an image with no parallax, double images are not produced by 3D crosstalk.

When the observer has moved within the intermediate region RB, the amount of barrier shift in the single state SS is adjusted in response as indicated by the arrow AJ (FIG. 51). This minimizes the difference between the amount of barrier shift and its theoretical value in the center of the screen.

When the observer has moved from the position P2 to the position P3 within the undetectable region RC, the amount of barrier shift is maintained at the next previous value that has been set in accordance with the position of the observer within the intermediate region RB. That is, operations are performed in the fixed mode, and the amount of barrier shift is fixed. Accordingly, even if the position of the observer is at the position P3 outside the observer-detectable region QB, there is no risk that the observer may perceive flicker caused by a local change in luminance, which is visually recognized as emission lines or dark lines at the barrier mode shift boundaries 270. Also, since the display panel 11 displays an image with no parallax, double images are not produced by 3D crosstalk.

FIG. 52 is a diagram for describing operations performed by the stereoscopic image display device 900 when the observer moves from the position P3 via the position P2 to the position P1 in FIG. 46. FIG. 53 is a graph for describing operations performed in modes starting from the fixed mode via a transition mode 2 to the non-3D mode by the parallax barrier shutter panel 21.

When the observer is at the position P3 within the undetectable region RC, operations are performed in the fixed mode as described above. Accordingly, the amount of barrier shift is maintained in a fixed state SF.

When the observer has moved from the undetectable region RC to the position P2 within the intermediate region RB, operations are first performed in the transition mode 2 and then performed in the non-3D mode. In either mode, the display panel 11 displays an image with no parallax. The parallax barrier shutter panel 21 transitions sequentially through transition states 2a and 2b in the transition mode 2 to the single state SS in the non-3D mode in either of the transition states 2a and 2b, since no barrier mode shift boundary 270 is present, there is no risk that the observer may perceive flicker caused by a local change in luminance, which is visually recognized as emission lines or dark lines at the barrier mode shift boundaries 270. Ultimately, the amount of barrier shift enters the single state SS that corresponds to the position P2. Specifically, the difference between the amount of barrier shift in the center of the screen and its theoretical value is minimized.

Next, when the observer has moved from the intermediate region RB to the position P1 within the stereoscopic display region RA, operations are first performed in a transition mode 3 and then performed in the 3D mode. In the transition mode 3, the display panel 11 displays an image with no parallax. In the transition mode 3, the parallax barrier shutter panel 21 performs an operation opposite in time to the operation performed in the aforementioned transition mode 1. That is, adjustment is performed from the single state SS (FIG. 51) via the transition state S1b (FIG. 50) and the transition state S1a (FIG. 49) in sequence to the approximate pattern state SA (FIG. 48). As in the case of the transition mode 1, this operation is desirably performed at a pitch of one sub-opening at a time interval greater than or equal to the response time (typically 3 milliseconds to 20 milliseconds) of the parallax barrier shutter panel 21. This reduces the risk that the observer may perceive flicker caused by a change in luminance.

In the present embodiment, there is no particular need to change the luminance of the backlight 3 during the aforementioned mode transmission. Thus, the luminance may be maintained constant even during the mode transition. While the description provided above has discussed the details of a case in which the parallax barrier shutter panel 21, the display panel 11, and the backlight 3 in the naked-eye stereoscopic image display panel 700 (FIG. 46) are overlaid in the same order as in Example 1 of the second prerequisite technique, the arrangement according to Example 2 of the second prerequisite technique may be applied instead. That is, the parallax barrier shutter panel 21 may be disposed on the side of the display panel 11 facing the backlight 3, instead of on the observer side of the display panel 11.

Configuration of Panel Controller 550

The panel controller 550 (FIG. 45) is configured as described below in order to cause the naked-eye stereoscopic image display panel 700 (FIG. 45) to perform the aforementioned operations.

When the region determination part 530 (FIG. 45) has determined that the position of the observer is included in the designed stereoscopic region QA (i.e., stereoscopic display region RA in FIG. 46), i.e., in the case of the 3D mode in FIG. 47, the panel controller 550 applies a plurality of cyclic patterns (“approximate pattern state” in FIG. 47 or 52) each having one cycle and connected by a plurality of barrier mode shift boundaries 270 among which a phase shift exists, to the integrated openings 300 in accordance with the position of the observer. For example, in FIG. 29, a plurality of cyclic patterns each having a cycle equivalent to eight pitches of the sub-openings 210 and connected by the barrier mode shift boundaries 270 among which a phase shift by an amount equivalent to one pitch of the sub-openings 210 exists is applied to the integrated openings 300.

When the region determination part 530 (FIG. 45) has determined that the position of the observer is no longer included in the designed stereoscopic region QA (i.e., stereoscopic display region RA in FIG. 46), i.e., in the case of the “transition mode 1” in FIG. 47, the panel controller 550 adjusts the pattern of the integrated openings 300 so as to cause the barrier mode shift boundaries 270 to disappear while maintaining one cycle (“transition state 1” in FIG. 47). For this adjustment, for example, the voltage pattern is changed from the voltage pattern No. 9 (FIG. 29) to the voltage pattern No. 1 (FIG. 23) in the vicinity of the barrier mode shift boundaries 270 that are caused to disappear. Accordingly, the pattern of the integrated openings 300 within the common barrier mode areas 260a is shifted in the right direction in FIG. 29 by an amount equivalent to one pitch of the sub-openings 210 so as to cause the barrier mode shift boundary 270 (FIG. 29) to disappear while maintaining the cycle equivalent to eight pitches of the sub-openings 210.

Through the above-described adjustment, the panel controller 550 adjusts the pattern of the integrated openings 300 so that the number of sub-openings 210 in the light transmission state and the number of sub-openings 210 in light shielding state become equal. For example, adjustment is made from the state in which the number of sub-openings 210 in the light shielding state is larger as in the voltage pattern No. 9 (FIG. 29) to the state in which the number of sub-openings in the light transmission state and the number of sub-openings in the light shielding state are the same as in the voltage pattern No. 1 (FIG. 23).

Referring to FIGS. 48 to 51, through the above-described adjustment, the panel controller 550 adjusts the pattern of the integrated openings 300 so as to maintain the phase of cyclic patterns located in the center in the lateral direction the drawing, position where the position on both sides in lateral position is 0 mm) among the plurality of cyclic patterns. Also, through this adjustment, the panel controller 550 adjusts the pattern of the integrated openings 300 so that the plurality of barrier mode shift boundaries 270 in the plurality of cyclic patterns disappear in order from those located at the ends in the lateral direction to those located in the center.

In the case of the above-described “transition mode 1” (FIG. 47), the panel controller 550 causes the display panel 11 to display an image with no parallax.

When the region determination part 530 (FIG. 45) has determined that the position of the observer becomes included in the designed stereoscopic region QA (i.e., stereoscopic display region RA in FIG. 46), i.e., in the case of the “transition mode 3” in FIG. 52, the panel controller 550 generates a plurality of barrier mode shift boundaries 270 in order from the center to the ends in the lateral direction.

When the region determination part 530 (FIG. 45) has determined that the position of the observer is included in the observer-detectable region QB (FIG. 46) but not included in the designed stereoscopic region QA (FIG. 46), i.e., when it has been determined that the position of the observer is included in the intermediate region RB (FIG. 46), the panel controller 550 shifts the pattern of the integrated openings 300 in its entirety in the parallax barrier shutter panel 21 in accordance with the position of the observer detected by the detector 31 (FIG. 45) (see the arrow AJ in FIG. 51).

When the region determination part 530 (FIG. 45) has determined that the position of the observer is no longer included in the observer-detectable region QB (FIG. 46), i.e., when it has been determined that the position of the observer is included in the undetectable region RC (FIG. 46), the panel controller 550 maintains the pattern of the integrated openings 300 unchanged (“fixed state” in FIG. 47 or 52).

### Summary of Advantageous Effects

According to the present embodiment, in the parallax barrier shutter panel 21, the integrated opening 300 (see, for example, FIG. 29) are configured by those of the sub-openings 210 that are in the light transmission state. When the position of the observer is included in the designed stereoscopic region QA (FIG. 46), a plurality of cyclic patterns each having one cycle and connected by a plurality of barrier mode shift boundaries 270 (see, for example, FIG. 29) among which a phase shift exists is applied to the integrated openings 300 in accordance with the position of the observer. When the position of the observer is no longer included in the designed stereoscopic region QA, the pattern of the integrated openings 300 is adjusted so as to cause the above-described barrier mode shift boundaries 270 to disappear while maintaining the above-described one cycle. Accordingly, even if the observer has moved to outside the designed stereoscopic region QA, it is possible to reduce the possibility that the observer may visually recognize emission lines or dark lines caused by control of the parallax barrier shutter panel 21.

When the region determination part 530 has determined that the position of the observer is no longer included in the designed stereoscopic region QA, the panel controller 550 causes the display panel 11 to display an image with no parallax. This prevents the occurrence of 3D crosstalk outside the designed stereoscopic region QA.

When the region determination part 530 has determined that the position of the observer is no longer included in the designed stereoscopic region QA, the panel controller 550 adjusts the pattern of the integrated openings 300 so that the number of sub-openings 210 in the light transmission state and the number of sub-openings 210 in the light shielding state become the same. This further reduces the risk that the observer may visually recognize emission lines or dark lines caused by control of the parallax barrier shutter panel 21.

When the region determination part 530 has determined that the position of the observer is no longer included in the designed stereoscopic region QA, the panel controller 550 adjusts the pattern of the integrated openings 300 so as to maintain the phase of a cyclic pattern located in the center in the lateral direction among the plurality of cyclic patterns. This further reduces the risk that the observer may visually recognize emission lines or dark lines caused by control of the parallax barrier shutter panel 21.

When the region determination part 530 has determined that the position of the observer is no longer included in the designed stereoscopic region QA, the panel controller 550 adjusts the pattern of the integrated openings 300 such that the plurality of barrier mode shift boundaries 270 in the plurality of cyclic patterns disappear in order from those located at the ends in the lateral direction to those located in the center. This further reduces the risk that the observer may visually recognize emission lines or dark lines caused by control of the parallax barrier shutter panel 21.

When the region determination part 530 has determined that the position of the observer becomes included in the designed stereoscopic region QA, the panel controller 550 generates a plurality of barrier mode shift boundaries 270 in order from the center to the ends in the lateral direction. This reduces the possibility that the observer may visually recognize emission lines or dark lines caused by control of the parallax barrier shutter panel 21.

The region determination part 530 determines whether the position of the observer detected by the detector 31 is included in the observer-detectable region QB. This allows the stereoscopic image display device 900 to perform different operations depending on whether the position of the observer is inside or outside the observer-detectable region QB.

When the region determination part 530 has determined that the position of the observer is included in the observer-detectable region QB but not included in the designed stereoscopic region QA, the panel controller 550 shifts the pattern of the integrated openings 300 in its entirety in the parallax, barrier shutter panel 21 in accordance with the position of the observer detected by the detector 31. This further reduces the risk that the observer may visually recognize emission lines or dark lines caused by control of the parallax barrier shutter panel 21.

When the region determination part 530 has determined that the position of the observer is no longer included in the observer-detectable region QB, the panel controller 550 maintains the pattern of the integrated openings 300 unchanged. Thus, even outside the observer-detectable region QB, the observer is less likely to visually recognize emission lines or dark lines caused by control of the parallax barrier shutter panel 21.

### Embodiment 2

Overview

According to Embodiment 1 described above, when the region determination part 530 has determined that the position of the observer is no longer included in the designed stereoscopic region QA (stereoscopic display region RA), i.e., in the case of the transition mode 1 in FIG. 47, the panel controller 550 adjusts the pattern of the integrated openings 300 so as to cause the barrier mode shift boundaries 270 to disappear while maintaining one cycle. In the present embodiment, this operation is replaced by an operation of reducing the transmittance of a plurality of sub-openings 210 in the light transmission state in the parallax barrier shutter panel 21 and increasing the transmittance of a plurality of sub-openings 210 in the light shielding state in the parallax barrier shutter panel 21. Thereafter, when the position of the observer is no longer included in the observer-detectable region QB (i.e., when the position of the observer is no longer included in the intermediate region RB), the panel controller 550 performs an operation of increasing the transmittance of the sub-openings 210 in the parallax barrier shutter panel 21 and reducing the luminance of the light surface of the naked-eye stereoscopic image display panel 700 in the stereoscopic image display device 900.

The parallax barrier shutter panel 21 includes a transmittance adjustment part (not shown) for enabling the aforementioned transmittance adjustment. The transmittance adjustment part includes, for example, a source driver IC. The source driver IC is capable of applying a gradation voltage to electrode wiring that constitute light shielding parts and light transmission parts and accordingly changing the transmittance in multiple stages.

The configuration other than that described above is approximately the same as those according to Embodiment 1 and variations thereof described above, and therefore detailed descriptions have been omitted with appropriate reference to the drawings described in Embodiment 1. Hereinafter, the configuration different from that of Embodiment 1 will be primarily described in detail.

Operations of Naked-Eye Stereoscopic Image Display Panel 700

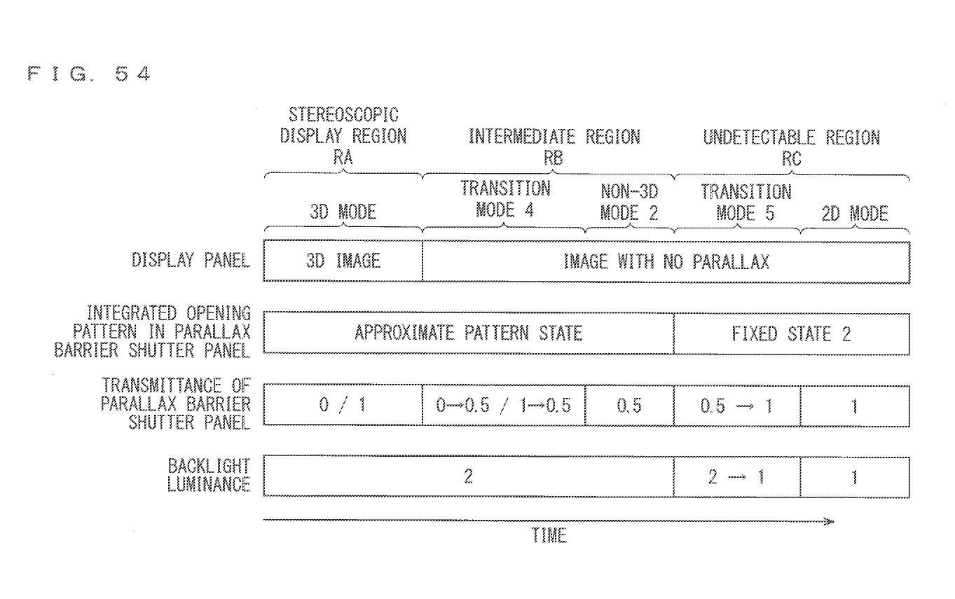

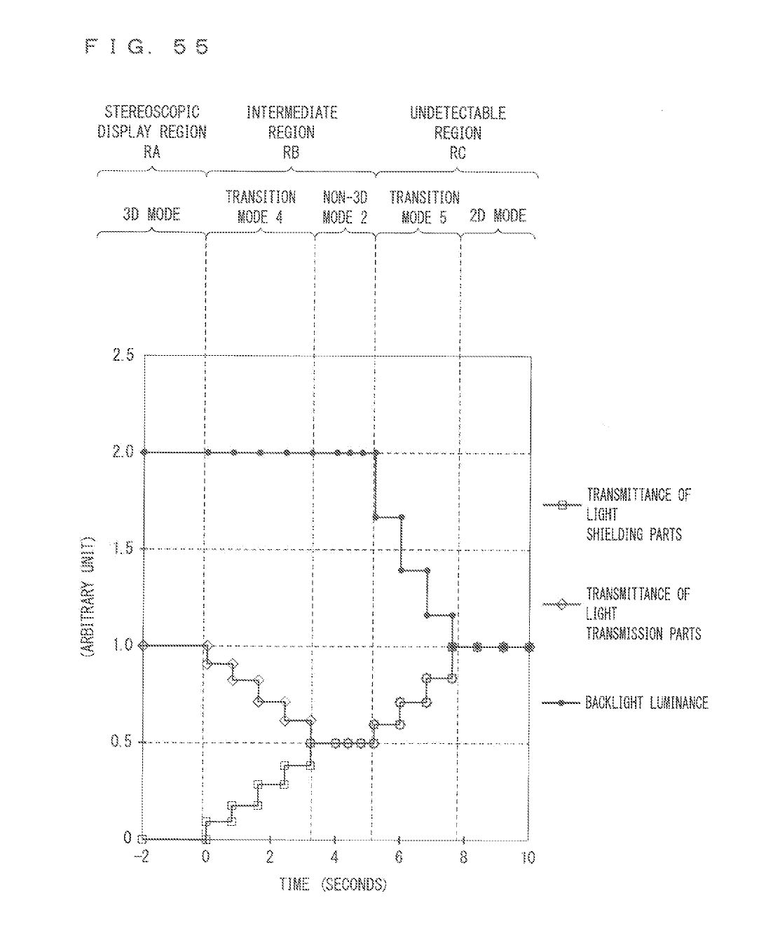

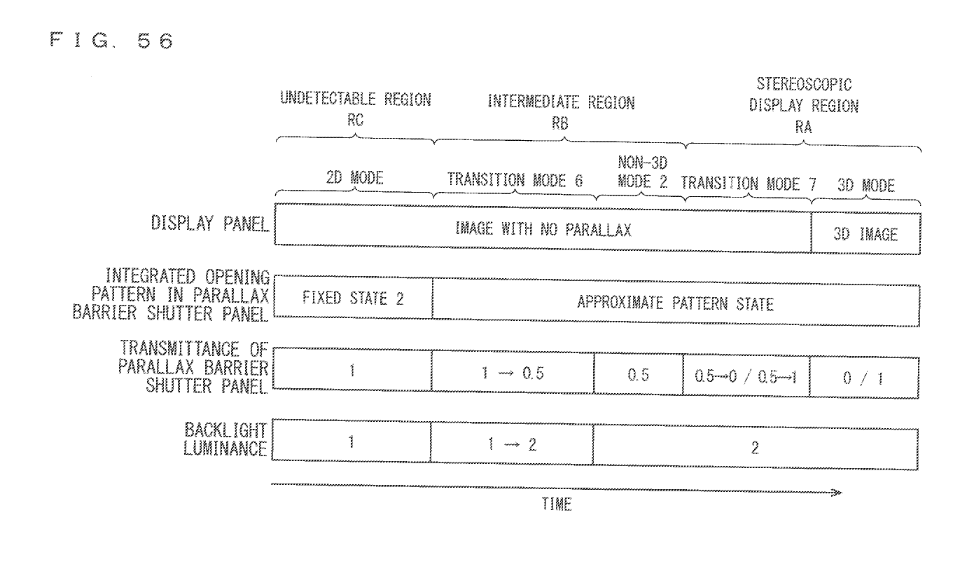

FIG. 54 is a diagram for describing an operation mode of the stereoscopic image display device 900 according to the present embodiment the case where the observer moves from the position P1 via the position P2 to the position P3 in FIG. 46, FIG. 55 is a graph corresponding to FIG. 54. In FIG. 55, the vertical axis indicates the transmittance of the light shielding parts of the sub-openings 210, the transmittance of the light transmission parts of the sub-openings 210, and the luminance of the backlight 3, which are standardized by the values in the 2D mode.

When the observer is at the position P1 within the stereoscopic display region RA, operations are first performed in the 3D mode as in Embodiment 1. When the observer has moved from the stereoscopic display region RA to the position P2 within the intermediate region RB, operations are first performed in a transmission mode 4 and then performed in a non-3D triode 2. In either mode, the display panel 11 displays an image with no parallax. Also, in either mode, the parallax barrier shutter panel 21 takes the approximate pattern state. However, in the transition mode 4, the transmittance of those of the sub-openings 210 that are in the light transmission state (hereinafter, also referred to as “light transmission parts”) in the parallax barrier shutter panel 21 is reduced, and the transmittance of those of the sub-openings 210 that are in the light shielding state (hereinafter, also referred to as “light shielding parts”) in the parallax barrier shutter panel 21 is increased. Specifically, the transmittance in the light transmission state and the transmittance in the light shielding state are made the same. Thus, unlike in Embodiment 1, the transmittance of the “light shielding parts” is temporarily made approximately equal to the transmittance of the “light transmission parts” in the present embodiment. In that case, although the control device 500 performs the operation of controlling the arrangement of the “light transmission parts” and the “light shielding parts” in order to adjust the pattern of the integrated openings 300, the pattern is not effectively applied to the plurality of sub-openings 210 in the parallax barrier shutter panel 21 because the “light transmission parts” and the “light shielding parts” have the same transmittance. In the non-3D mode 2, the transmittance adjusted as described above is maintained.

When the observer has moved from the intermediate region RB to the position P3 within the undetectable region RC, operations are performed in the two-dimensional (2D) mode via a transition mode 5. In the transition mode 5 and the 2D mode, the display panel 11 displays an image with no parallax. Also, the pattern of the integrated openings 300 in the parallax barrier shutter panel 21 is in a “fixed state 2.” The fixed state 2 is a state in which the pattern is fixed to the approximate pattern state that has been set immediately before the observer moved from the intermediate region RB to the position P3 within the undetectable region RC. However, as described previously, the approximate pattern has effectively disappeared at that time.

When the observer is at the position P1 within the stereoscopic display region RA, operations are performed in the 3D mode as in Embodiment 1. At this time, the transmittance of the light shielding parts among the sub-openings 210 in the parallax barrier shutter panel 21 is substantially 0, and the transmittance of the light transmission parts is 1.

In the transition mode 4 (FIG. 54) that is started when the position of the observer has moved to the position P2 outside the stereoscopic display region RA, the transmittance of the light shielding parts in the parallax barrier shutter panel 21 is gradually increased up to 0.5. In other words, the transmittance of the light shielding parts is gradually increased up to a half of the transmittance of the light transmission parts in the 3D mode. Simultaneously, the transmittance of the light transmission parts in the parallax barrier shutter panel 21 is gradually reduced down to 0.5. In other words, the transmittance of the light transmission parts is gradually reduced down to the half of the transmittance of the light transmission parts in the 3D mode. With this change in the transmittances of the light shielding parts and the light transmission parts, the average transmittance of the light transmission parts and the light shielding parts is maintained at 0.5 on the entire surface of the parallax barrier shutter panel 21. Then, the non-3D mode 2 is started in which the transmittance adjusted in this way is maintained. If the luminance of the display in the non-3D mode is assumed to be 1, the luminance of the display in the transition mode 4 and the non-3D mode 2 is maintained at 1 because the increase in the transmittance of the light shielding parts and the decrease in the transmittance of the light transmission parts are cancelled out with each other. In the non-3D mode 2, the parallax barrier shutter panel 21 performs the operation of forming an approximate pattern, but the approximate pattern has effectively disappeared because the transmittances of the light shielding parts and the light transmission parts are equally 0.5. Accordingly, no barrier mode shift boundary 270 is effectively present on the surface of the parallax barrier shutter panel 21.

On the other hand, in the early stage after the observer has moved from the position P1 to the position P2, i.e., in the stage of the transition mode 4, the barrier mode shift boundaries 270 effectively remain on the surface of the parallax barrier shutter panel 21. However, the observer is less likely to visually recognize a change in luminance in the vicinity of the barrier mode shift boundaries 27 because of the aforementioned advantageous effect of the second prerequisite technique. That is, the observer is less likely to visually recognize luminance flicker.

The adjustment of the transmittances of the light shielding parts and the light transmission parts in the transition mode 4 is desirably performed over a period of time greater than or equal to 0.03 to 0.2 seconds, which prevents this adjustment from being perceived by human eyes. Also, this adjustment is desirably performed in multiple stages at a time interval greater than or equal to the response time (typically 3 milliseconds to 20 milliseconds) of the parallax barrier shutter panel 21. This suppresses the occurrence of fluctuations in the average transmittance of the light shielding parts and the light transmission parts, caused by a difference in liquid crystal response time between at the time of increase in the transmittance of the parallax barrier shutter panel 21 arid at the time of decrease in the transmittance of the parallel barrier shutter panel 21.

When the observer stays at the position P2 for at least a certain period of time, the transition mode 4 ends and the non-3D mode 2 starts. In the non-3D mode 2, since no barrier mode shift boundary 270 is effectively present, there is no risk that the observer may perceive flicker caused by a local change in luminance, which is visually recognized as emission lines or dark lines at the barrier mode shift boundaries 270. Also, since the display panel 11 displays an image with no parallax, double images are not produced by 3D crosstalk.

In the non-3D mode 2, if the transmittances of the light shielding parts and the light transmission parts are an equal value, the approximate pattern of the parallax barrier shutter panel 21 effectively disappears, and accordingly no barrier mode shift boundary 270 is present on the display surface. However, the adjustment of the transmittances of the light shielding parts and the light transmission parts can cause a change in the luminance of the display unless the luminance of the backlight 3, i.e., the luminance of the light source, is adjusted in accordance with the transmittance adjustment. In order to maintain the luminance of the display constant while eliminating the control of the luminance of the light source, the transmittances of the light shielding, parts and the light transmission parts is set to 0.5. Moreover, if the average transmittance of the light shielding parts and the light transmission parts is maintained at 0.5 in the transition mode 4, it is possible, even in the transition mode 4, to maintain the luminance of the display constant while eliminating the control of the luminance of the light source. In other words, the occurrence of a change in the luminance of the display (flicker) can be suppressed.

When the observer has moved from the position P2 to the position P3 within the undetectable region RC, operation are performed in the 2D mode via the transition mode 5. In the transition mode 5, the amount of barrier shift is fixed to the next previous value that has been set in accordance with the position of the observer within the intermediate region RB. This state of the parallax barrier shutter panel 21 is also referred to as the “fixed state 2.” In the fixed state 2, since no barrier pattern is effectively present, even if the observer is at the position P3 outside the observer-detectable region QB, there is no risk that the observer may perceive flicker caused by a local change in luminance, which is visually recognized as emission lines or dark lines at the barrier mode shift boundaries 270. Also, since the display panel 11 displays an image with no parallax, double images are not produced by 3D crosstalk.

Moreover, in the transition mode 5, the transmittances of the light shielding parts and the light transmission parts are gradually increased in stages from 0.5 to ultimately 1 while being maintained equal to each other. That is, the parallax barrier shutter panel 21 is ultimately brought into a state in which light is transmitted to a maximum extent. Also, in synchronization with this transmittance adjustment, the luminance of the backlight (luminance of the light source) is reduced from 2 to 1. If the luminance of the display in the non-3D mode 2 is assumed to be 1, the luminance of the display in the transition mode 5 and the 2D mode is maintained at 1 because the increase in transmittance and the decrease in the luminance of the light source are cancelled out with each other. After this operation, the operation of maintaining the above-described transmittance and luminance in the 2D mode is started. Since the luminance of the backlight in the 2D mode is a half of the luminance of the backlight in the 3D mode, power consumption of the backlight 3 is suppressed significantly.

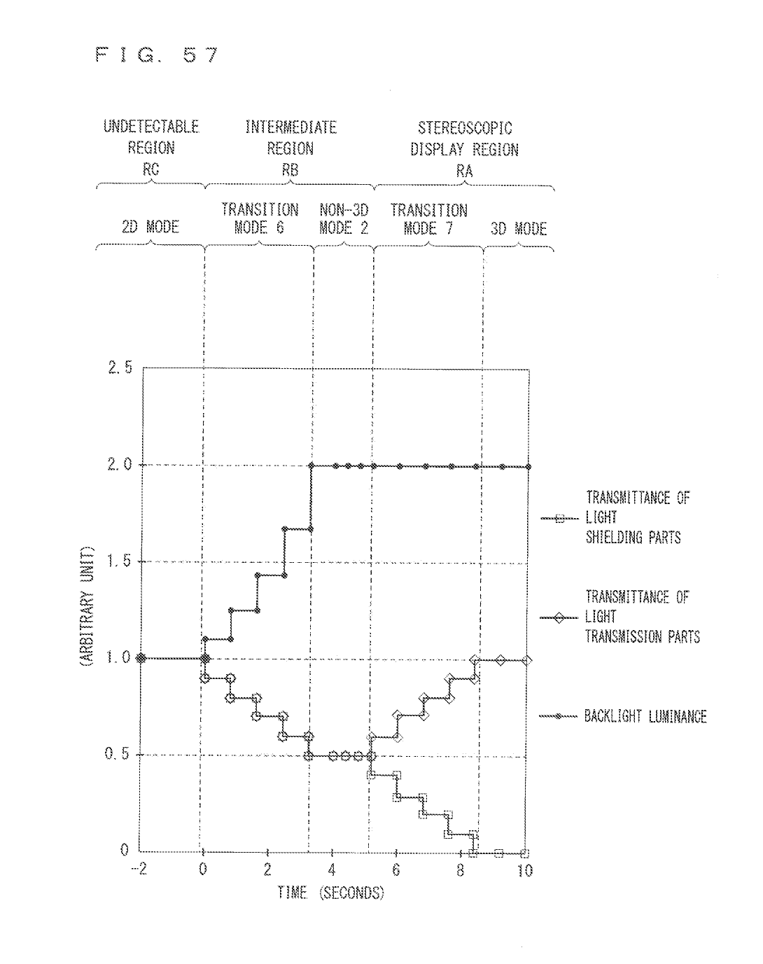

FIG. 56 is a diagram for describing an operation mode of the stereoscopic image display device 900 according to the present embodiment in the case where the observer moves from the position P3 via the position P2 to the position P1 in FIG. 46. FIG. 57 is a graph corresponding to FIG. 56. In FIG. 57, the vertical axis indicates the transmittance of the light shielding parts of the sub-openings 210, the transmittance of the light transmission parts of the sub-openings 210, and the luminance of the backlight 3, which are standardized by the values in the 2D mode.

When the observer is at the position P3 within the undetectable region RC, operations are performed in the 2D mode as described previously. Thus, the amount of barrier shift is maintained in an arbitrary fixed state 2. However, as described previously, no approximate pattern is effectively present because the transmittances of the light shielding parts and the light transmission parts are equally 1.

When the observer have moved from the undetectable region RC to the position P2 within the intermediate region RB, operations are first performed in a transition mode 6 and then performed in the non-3D mode 2. In either mode, the display panel 11 displays an image with no parallax. The parallax barrier shutter panel 21 starts the operation of generating an approximate pattern state. However, no approximate pattern is effectively present because the transmittances of the light shielding parts and the light transmission parts are equal. Accordingly, there is no risk that the observer may perceive flicker caused by a local change in luminance, which is visually recognized as emission lines or dark lines at the barrier mode shift boundaries 270. Also, since the display panel 11 displays an image with no parallax, double images are not produced by 3D crosstalk.

In the transition mode 6, an operation opposite in time to the operation performed in the aforementioned transition mode 5 is performed. That is, the transmittances of the light shielding parts and the light transmission parts are gradually reduced in stages from 1 to ultimately 0.5 while being maintained equal to each other. Also, in synchronization with this transmittance adjustment, the luminance of the backlight is increased from 1 to 2 if the luminance of the display in the 2D mode is assumed to be 1, the luminance of the display in the transition mode 6 and the non-3D mode is maintained at 1 because the decrease in transmittance and the increase in the luminance of the light source are cancelled out with each other. After this operation, an operation of maintaining the above-described transmittance and luminance in the non-3D mode 2 is started.

Next, when the observer has moved from the intermediate region RB to the position P1 within the stereoscopic display region. RA, operations are first performed in a transition mode 7 and then performed in the 3D mode. In the transition mode 7, the display panel 11 displays an image with no parallax. In the transition mode 7, the parallax barrier shutter panel 21 performs an operation opposite in time to the operation performed in the aforementioned transition mode 4. That is, the transmittance of the light shielding parts in the parallax barrier shutter panel 21 is gradually reduced to zero. Simultaneously, the transmittance of the light transmission parts in the parallax barrier shutter panel 21 is gradually increased to 1. With this change in the transmittances of the light shielding parts and the light transmission parts, the average transmittance of the light transmission parts and the light shielding parts is maintained at 0.5 on the entire surface of the parallax barrier shutter panel 21. If the luminance of the display in the non-3D mode 2 is assumed to be 1, the luminance of the display in the transition mode 7 and the 3D mode is maintained at 1 because the decrease in the transmittance of the light shielding parts and the increase in the transmittance of the light transmission parts are cancelled out with each other.

As in the case of the transition mode 4, the adjustment of the transmittances of the light shielding parts and the light transmission parts in the transition mode 7 is desirably performed over a period of time greater than or equal to 0.03 to 0.2 seconds, which prevents this adjustment from being perceived by human eyes. Also, this adjustment is desirably performed in multiple stages at a time interval greater than or equal to the response time (typically 3 milliseconds to 20 milliseconds) of the parallax barrier shutter panel 21. This suppresses the occurrence of fluctuations in the average transmittance of the light shielding parts and the light transmission parts, caused by a difference in liquid crystal response speed between at the time of increase in transmission and at the time of decrease in transmission in the parallax barrier shutter panel

Configuration of Panel Controller 550

The panel controller 550 (FIG. 45) is configured as described below in order to cause the naked-eye stereoscopic image display panel 700 (FIG. 45) to perform the aforementioned operations.

When the region determination part 530 has determined that the position of the observer is no longer included in the designed stereoscopic region QA (FIG. 46), the panel controller 550 causes the display panel 11 to display an image with no parallax, reduces the transmittance of the sub-openings 210 in the light transmission state in the parallax barrier shutter panel 21, and increases the transmittance of the sub-openings 210 in the light shielding state in the parallax barrier shutter panel 21. That is, the panel controller 550 is configured to perform operations in the transition mode 4. Also, the panel controller 550 is configured to perform operations in the non-3D mode 2 after the operations in the transition mode 4 are completed.

When the region determination part 530 has determined that the position of the observer is no longer included in the observer-detectable region QB (FIG. 46), the panel controller 550 increases the transmittance of the sub-openings 210 in the parallax barrier shutter panel 21 and reduces the luminance of the light source of the naked-eye stereoscopic image display panel 700 in the stereoscopic image display device 900. That is, the panel controller 550 is configured to perform operations in the transition mode 5. Also, the panel controller 550 is configured to perform operations in the 2D mode after the operations in the transition mode 5 are completed.

When the region determination part 530 (FIG. 45) has determined that the position of the observer becomes included in the observer-detectable region QB (FIG. 46), the panel controller 550 performs operations opposite to the operations described above, i.e., reduces the transmittance of the sub-openings 210 in the parallax barrier shutter panel 21 and increases the luminance of the backlight 3. That is, the panel controller 550 is configured to perform operations in the transition mode 6. The panel controller 550 is also configured to perform operations in the non-3D mode 2 after the operations in the transition mode 6 are completed.

When the region determination part 530 (FIG. 45) has determined that the position of the observer becomes included in the designed stereoscopic region QA, the panel controller 550 increases the transmittance of the sub-openings 210 in the light transmission state in the parallax barrier shutter panel 21 and reduces the transmittance of the sub-openings 210 in the light shielding state in the parallax barrier shutter panel 21. That is, the panel controller 550 is configured to perform operations in the transition mode 7. After this transmittance adjustment, the panel controller 550 causes the display panel 11 to display a 3D image. That is, the panel controller 550 is configured to perform operations in the 3D mode.

In the present embodiment, the luminance of the backlight 3 is adjusted as described above as the luminance of the light source. However, the display panel may also be a self-luminous panel such an organic EL panel or a plasma display panel, and in that case, the luminance of the display panel is adjusted, instead of the luminance of the backlight.

### Summary of Advantageous Effects

According to the present embodiment, in the parallax barrier shutter panel 21, the integrated openings 300 (see, for example, FIG. 29) are configured by those of the sub-openings 210 that are in the light transmission state. When the position of the observer is included in the designed stereoscopic region QA (FIG. 46), a plurality of cyclic patterns each having one cycle and connected by a plurality of barrier mode shift boundaries 270 (see, for example, FIG. 9) among which a phase shift exists is applied to the integrated openings 300 in accordance with the position of the observer. When the position of the observer is no longer included in the designed stereoscopic region QA, the display panel 11 displays an image with no parallax, the transmittance of the sub-openings 210 in the light transmission state in the parallax barrier shutter panel 21 is reduced, and the transmittance of the sub-openings 210 in the light shielding state in the parallax barrier shutter panel 21 is increased. Accordingly, even if the observer has moved to outside the designed stereoscopic region QA, the observer is less likely to visually recognize emission lines or dark lines caused by control of the parallax barrier shutter panel 21. Specifically, when the position of the observer is no longer included in the designed stereoscopic region QA, the transmittances of the light shielding parts and the light transmission parts are adjusted so as to be equal to each other. Accordingly, even if the observer has moved to outside the designed stereoscopic region QA, the observer is less likely to visually recognize emission lines or dark lines and luminance flicker caused by control of the parallax barrier shutter panel 21.

When the position of the observer is no longer included in the observer-detectable region QB, the transmittance of the sub-openings 210 in the parallax barrier shutter panel 21 is increased, and the luminance of the light source of the naked-eye stereoscopic image display panel 700 is reduced. This suppresses power consumption of the naked-eye stereoscopic image display panel 700 while suppressing a change in the luminance of the display of the naked-eye stereoscopic image display panel 700.

When the region determination part 530 has determined that the position of the observer is no longer included in the designed stereoscopic region QA, the panel controller 550 causes the display panel 11 to display an image with no parallax. This prevents the occurrence of 3D crosstalk outside the designed stereoscopic region QA.

When the region determination part 530 has determined that the position of the observer is no longer included in the designed stereoscopic region QA, the panel controller 550 brings the transmittance of the sub-openings 210 in the light shielding state closer to the transmittance of the sub-openings 210 in the light transmission state so that the transmittances ultimately become an equal value. This further reduces the risk that the observer may visually recognize emission lines or dark lines and luminance flicker caused by control of the parallax barrier shutter panel 21. Specifically, the transmittance of the light shielding parts is increased and the transmittance of the light transmission part is reduced so that the transmittances ultimately become equal, while maintaining the average transmittance of the transmittances of the sub-openings 210 in the light transmission state and the sub-openings 210 in the light shielding state at a fixed value. This further reduces the risk that the observer may visually recognize emission lines or dark lines caused by control of the parallax barrier shutter panel 21. Note that this operation can also be used in the case of switching from a stereoscopic display state to a 2D image display state, irrespective of the position of the observer, and this reduces the possibility that the observer may visually recognize emission lines or dark lines caused by control of the parallax barrier shutter panel 21.

The region determination part 530 determines whether the position of the observer detected by the detector 31 is included in the observer-detectable region QB. This allows the stereoscopic image display device 900 to perform different operations depending on whether the position of the observer is inside or outside the observer-detectable region QB.

Note that the present invention can freely combine or modify or omit the above-described embodiments and the first and second prerequisite techniques within the scope of the present invention.

What is claimed is:

1. A stereoscopic image display device for displaying a stereoscopic image toward an observer who is located within a designed stereoscopic region, comprising:
a display panel including a plurality of sub-pixel pairs aligned in a lateral direction and each having two sub-pixels that respectively display images for left and right eyes;
a parallax barrier shutter panel overlaid on the display panel and having a plurality of sub-openings aligned in the lateral direction and electrically switchable between a light transmission state and a light shielding state;
a detector that detects a position of the observer;
a region determination part that determines whether the position of the observer detected by the detector is included in the designed stereoscopic region;
a panel controller that switches each of the plurality of sub-openings in the parallax barrier shutter panel between the light transmission state and the light shielding state in accordance with the position of the observer to change a pattern of an integrated opening configured by sub-openings in the light transmission state among the plurality of sub-openings; and
a region setting part that sets the designed stereoscopic region,
the panel controller being configured to:
in a case where the region determination part has determined that the position of the observer is included in the designed stereoscopic region, apply a plurality of cyclic patterns to the integrated opening in accordance with the position of the observer, the plurality of cyclic patterns each having one cycle and connected by a plurality of boundaries among which a phase shift exists, and
in a case where the region determination part has determined that the position of the observer is no longer included in the designed stereoscopic region, adjust the pattern of the integrated opening to cause the boundaries to disappear while maintaining the one cycle.

2. The stereoscopic image display device according to claim 1, wherein
in a case where the region determination part has determined that the position of the observer is no longer included in the designed stereoscopic region, the panel controller causes the display panel to display an image with no parallax.

3. The stereoscopic image display device according to claim 1, wherein
in a case where the region determination part has determined that the position of the observer is no longer included in the designed stereoscopic region, the panel controller adjusts the pattern of the integrated opening to make the number of sub-openings in the light transmission state and the number of sub-openings in the light shielding state among the plurality of sub-openings equal to each other.

4. The stereoscopic image display device according to claim 1, wherein
in a case where the region determination part has determined that the position of the observer is no longer included in the designed stereoscopic region, the panel controller adjusts the pattern of the integrated opening to maintain a phase of a cyclic pattern that is located in a center in the lateral direction among the plurality of cyclic patterns.

5. The stereoscopic image display device according to claim 1, wherein
in a case where the region determination part has determined that the position of the observer is no longer included in the designed stereoscopic region, the panel controller adjusts the position of the integrated opening to cause the plurality of boundaries in the plurality of cyclic patterns to disappear in order from boundaries located at ends to a boundary located in a center in the lateral direction at a time interval greater than or equal to a response time of the parallax barrier shutter panel.

6. The stereoscopic image display device according to claim 1, wherein
in a case where the region determination part has determined that the position of the observer becomes included in the designed stereoscopic region, the panel controller generates the plurality of boundaries in order from a center toward ends in the lateral direction at a time interval greater than or equal to a response time of the parallax barrier shutter panel.

7. The stereoscopic image display device according to claim 1, wherein
the region setting part sets an observer-detectable region that includes the designed stereoscopic region, and
the region determination part determines whether the position of the observer detected by the detector is included in the observer-detectable region.

8. The stereoscopic image display device according to claim 7, wherein
in a case where the region determination part has determined that the position of the observer is included in the observer-detectable region but not included in the designed stereoscopic region, the panel controller shifts the pattern of the integrated opening in its entirety in the parallax barrier shutter panel in accordance with the position of the observer detected by the detector.

9. The stereoscopic image display device according to claim 7, wherein
in a case where the region determination part has determined that the position of the observer is no longer included in the observer-detectable region, the panel controller maintains the pattern of the integrated opening unchanged.

10. A stereoscopic image display device for displaying a stereoscopic image toward an observer who is located within a designed stereoscopic region, comprising:
a display panel including a plurality of sub-pixel pairs aligned in a lateral direction and each having two sub-pixels that respectively display images for left and right eyes;
a parallax barrier shutter panel overlaid on the display panel and having a plurality of sub-openings aligned in the lateral direction and electrically switchable between a light transmission state and a light shielding state;
a detector that detects a position of the observer;
a region determination part that determines whether the position of the observer detected by the detector is included in the designed stereoscopic region;
a panel controller that switches each of the plurality of sub-openings in the parallax barrier shutter panel between the light transmission state and the light shielding state in accordance with the position of the observer to change a pattern of an integrated opening configured by sub-openings in the light transmission state among the plurality of sub-openings; and
a region setting part that sets the designed stereoscopic region,
the panel controller being configured to:
in a case where the region determination part has determined that the position of the observer is included in the designed stereoscopic region, apply a plurality of cyclic patterns to the integrated opening in accordance with the position of the observer, the plurality of cyclic patterns each having one cycle and connected by a plurality of boundaries among which a phase shift exists; and
in a case where the region determination part has determined that the position of the observer is no longer included in the designed stereoscopic region, cause the display panel to display an image with no parallax, reduce a transmittance of sub-openings in the light transmission state among the plurality of sub-openings in the parallax barrier shutter panel, and increase a transmittance of sub-openings in the light shielding state among the plurality of sub-openings in the parallax barrier shutter panel.

11. The stereoscopic image display device according to claim 10, wherein
the region setting part sets an observer-detectable region that includes the designed stereoscopic region, and
in a case where the region determination part has determined that the position of the observer is no longer included in the observer-detectable region, the panel controller increases the transmittance of the plurality of sub-openings in the parallax barrier shutter panel and reduces luminance of a light source of the stereoscopic image display device.
